(19) United States
(12) Patent Application Publication
(10) Pub. No.: US 2023/0237582 A1
(43) Pub. Date: Jul. 27, 2023

(54) OUTCOME PREDICTION SYSTEMS AND USER INTERFACES FOR CUSTOMIZABLE USER PLANS

(71) Applicant: Empower Annuity Insurance Company of America, Greenwood Village, CO (US)

(72) Inventors: Daryl Probetts, Highlands Ranch, CO (US); Jeremy Hersch, Greenwood Village, CO (US); Sean Hough, Thornton, CO (US); Paul O'Connell, Wilmington, MA (US); Brian Cosmano, Greenwood Village, CO (US)

(73) Assignee: Empower Annuity Insurance Company of America, Greenwood Village, CO (US)

(21) Appl. No.: 18/124,994

(22) Filed: Mar. 22, 2023

Related U.S. Application Data
(63) Continuation-in-part of application No. 16/863,174, filed on Apr. 30, 2020.
Application No. 16/863,174 is a continuation-in-part of application No. 16/418,302, filed on May 21, 2019.
Application No. 16/418,302 is a continuation-in-part of application No. 16/418,679, filed on May 21, 2019, now Pat. No. 11,645,709.
(60) Provisional application No. 62/674,407, filed on May 21, 2018.
(60) Provisional application No. 62/674,407, filed on May 21, 2018.

(51) Int. Cl. G06Q 40/06; G06F 3/0482

(52) U.S. Cl. CPC G06Q 40/06; G06F 3/0482

(57) ABSTRACT

A graphical user interface (GUI) includes a visual representation of projections over time for a user. The GUI calls a planning engine through an application programming interface (API) where calling the planning engine causes the planning engine to retrieve user profile data of the user, generate a predicted outcome for the user based on the user profile data, and return the predicted outcome to the GUI. In response to receiving the predicted outcome from the planning engine, the GUI updates updating the visual representation based on the predicted outcome. Certain implementations may include multiple planning engines, each with respective APIs, and/or reconfigurable planning engines.

### CROSS REFERENCE TO RELATED APPLICATIONS

This application is a continuation-in-part of, and claims the benefit of, U.S. patent application Ser. No. 16/863,174, filed Apr. 30, 2020, and titled “PLANNING ENGINE FOR A FINANCIAL PLANNING SYSTEM,” which is a continuation-in-part of, and claims the benefit of, U.S. patent application Ser. No. 16/418,302, filed May 21, 2019, and titled “INTEGRATED GRAPHICAL USER INTERFACE FOR SEPARATE SERVICE LEVELS OF A FINANCIAL PLANNING SYSTEM”. U.S. patent application Ser. No. 16/418,302 claims the benefit of U.S. Provisional Patent Application No. 62/674,407, filed May 21, 2018, and titled “PLANNING ENGINE FOR DYNAMIC ACCOUNT OPTIMIZATION”.

This application is a continuation-in-part of, and claims the benefit of, U.S. patent application Ser. No. 16/418,679, filed May 21, 2019, and titled “GRAPHICAL USER INTERFACE FOR PARTICIPANTS AND SERVICE REPRESENTATIVES IN A FINANCIAL PLANNING SYSTEM,” which also claims the benefit of U.S. Provisional Patent Application No. 62/674,407, filed May 21, 2018.

The entire contents the foregoing applications is incorporated herein by reference for all purposes.

### BACKGROUND

Achieving personal goals requires developing a robust and reliable plan and often requires accurately maintaining data relating to the plan, regular assessment of progress along the plan, and occasional reevaluation and redesign of the plan to ensure tracking toward the ultimate goal. While many individuals are capable of performing such activities for relatively straightforward personal goals, the time, effort, and expertise to evaluate and optimize plans for more sophisticated and complex undertakings often requires assistance in the form of coaches or advisors and the use of an assortment of tracking and evaluation tools.

By way of example, individuals are increasingly responsible for managing their own personal retirement accounts, which may be supplemented by employer contributions. Individual accountholders may be ill-equipped to optimize retirement accounts, as the lengthy term of the account increases sensitivity to asset allocation, contribution strategies, withdraw strategies, and changes in supplemental retirement benefits. For example, market conditions and/or a projected retirement date may require specific adjustments to the asset allocation of the account. Additionally, contribution and withdrawal policies may change. For example, taxes may be adjusted or assessed differently from year to year. As a result, many participants in financial plans, such as employer-provided 401(k) plans, would benefit from enrollment in a financial planning system that provides enhanced service, such as improved recommendations and visualization tools. However, at least some known financial planning systems, in attempting to provide a more sophisticated set of tools for the user, present a dramatically different and/or more complex user interface as compared to the basic 401(k) plan management interface to which many users are accustomed. As a result, many ordinary participants may be dissuaded from enrolling in, or continuing to stay enrolled in, such enhanced services.

Similar challenges arise in other fields, such as the health and wellness field and education. Managing personal health, for example, can be a complex undertaking with many interwoven aspects. To the extent an individual has a health-related goal (e.g., weight loss, fitness improvement, strength development, etc.), meaningfully managing a plan for achieving the goal can include tracking and analyzing dietary habits, exercise and physical activity, and sleep, among other things. Beyond tracking such information, many individuals lack the necessary expertise to develop and revise a plan for achieving health-related goals and to modify an existing plan that may be suboptimal or ineffective. While many individuals rely on various software applications and tracking tools, such tools are often too narrow (e.g., focusing on only one aspect of health), too general (e.g., not taking into account a specific individuals needs or preferences), or too sophisticated for untrained individuals or non-experts to meaningfully use. As a result, and like the case of the financial planning system noted above, individuals can be dissuaded from starting or adhering to a broader health plan.

Moreover, while some known conventional planning systems provide recommendations to users, such recommendations can be problematic. For example, some conventional systems generate large number of recommendations that overwhelm the ordinary user, make recommendations that are too complex for the ordinary user to grasp, and/or suggest recommendations that result in changes that appear extreme to the ordinary user and that the user is therefore less likely to adopt. As a result, users of such known systems may be unable or unwilling to take steps to improve progress along their respective plan and toward their intended goal.

In addition, many participants in a financial plan desire to obtain assistance from services representatives, such as in a phone call or on-line chat, rather than using such enhanced services directly. However, the user interface for service representative often varies from the user interface visible to participants, increasing a difficulty for the representative to explain precisely how suggested changes would appear to the participant. On the other hand, if the services representative is limited to seeing solely the user interface that is/would be provided to the participant, the services representative may not have ready access to additional information needed to answer questions or fully explain options to the participant.

### SUMMARY

In one aspect of the present disclosure, a computer-implemented method is provided that includes presenting a graphical user interface (GUI) having a visual representation of projections over time for a user. The method further includes calling a planning engine through an application programming interface (API). Calling the planning engine causes the planning engine to retrieve user profile data of the user, generate a predicted outcome for the user based on the user profile data, and return the predicted outcome to the GUI. The method further includes receiving the predicted outcome from the planning engine and updating the visual representation based on the predicted outcome.

In another aspect of this disclosure, a computer system is provided. The computer system includes one or more processors and memory storing thereon instructions. When executed by the one or more processors, the instructions cause the one or more processors to execute a process including presenting a GUI having a visual representation of projections over time for a user. The process further includes calling a planning engine through an API where calling the planning engine causes the planning engine to retrieve user profile data of the user, generate a predicted outcome for the user based on the user profile data, and return the predicted outcome to the GUI. The process also includes receiving the predicted outcome from the planning engine and updating the visual representation based on the predicted outcome.

In another aspect of the present disclosure, at least one non-transitory computer-readable storage media includes computer-executable instructions that, when executed by at least one processor, cause the at least one processor to execute a process including presenting a GUI having a visual representation of projections over time for a user. The process further includes calling a planning engine through an API where calling the planning engine causes the planning engine to retrieve user profile data of the user, generate a predicted outcome for the user based on the user profile data, and return the predicted outcome to the GUI. The process also includes receiving the predicted outcome from the planning engine and updating the visual representation based on the predicted outcome.

### BRIEF DESCRIPTION OF THE DRAWINGS

FIGS. 1-58 depict various aspects of example implementations of the methods and systems of this disclosure.

FIG. 1 is a simplified block diagram of an example planning system.

FIG. 2A is a component diagram illustrating components of a planning system according to the present disclosure and directed to financial/retirement planning.

FIG. 2B is a block diagram illustrating a variety of initialization parameters to be included in an initialization set for a planning engine used in finance-related planning systems according to this disclosure.

FIG. 2C is a data flow diagram illustrating generation of a matrix of projected return values for a portfolio.

FIG. 3 depicts an interface outline for an illustrative graphical user interface (GUI) according to the present disclosure.

FIG. 4 depicts an example introductory page for the illustrative GUI of FIG. 3 and, in particular, for a user enrolled in a basic service level.

FIG. 5 depicts an example home page for the illustrative GUI for a user enrolled in an enhanced service.

FIG. 6 depicts a goals configuration display of the with a first member tab selected and which allows a user to change (e.g., edit) values for certain data fields in a database that are used as inputs by a planning engine to generate financial projections.

FIG. 7 depicts the goals configuration display of FIG. 6 with a second member tab selected.

FIG. 8A depicts an informational page of the illustrative GUI which provides a user with a tabular comparison of available services.

FIG. 8B depicts an informational sub-page of the illustrative GUI which provides a user with more information about a financial advisory system driven by a planning engine.

FIG. 8C depicts another informational page of the illustrative GUI which provides a user with another comparison of available services.

FIG. 9 depicts a registration page of the illustrative GUI which allows a user to register for an advisory system and to input relevant personal and financial information.

FIG. 10 depicts an enrollment confirmation page of the illustrative GUI.

FIG. 11A depicts a dashboard of the illustrative GUI for enhanced-level participants.

FIG. 11B depicts a dashboard of the illustrative GUI for service representatives or other advisors to participants.

FIG. 12 depicts an about me page (or “user profile page”) of the illustrative GUI.

FIG. 13 depicts a spouse status page of the illustrative GUI.

FIG. 14A depicts the spouse status page with a spouse detail region.

FIG. 14B depicts the spouse status page with a spouse detail region and a tool tip displayed.

FIG. 15 depicts a dependent status page of the illustrative GUI.

FIG. 16 depicts the dependent status page with a dependent detail region.

FIG. 17 depicts an asset status page of the illustrative GUI.

FIG. 18 depicts a supplemental income page of the illustrative GUI.

FIG. 19 depicts a supplemental income detail page of the illustrative GUI.

FIG. 20 depicts a supplemental income summary page of the illustrative GUI.

FIG. 21 depicts a savings goals page of the illustrative GUI.

FIG. 22 depicts a savings goals summary page of the illustrative GUI.

FIG. 23 depicts an investments page of the illustrative GUI.

FIG. 24 depicts an asset class composition within the investments page of FIG. 23.

FIG. 25 depicts a fund composition within the investments page of FIG. 23.

FIG. 26 depicts a constraints page for updating preferred constraints used by a planning engine for determining financial projections.

FIG. 27 depicts a strategy selection page including strategy options and strategy selection indicators within the constraints page of FIG. 26.

FIG. 28 depicts a strategy change summary page of the illustrative GUI.

FIG. 29 depicts an update version of the investments page of FIGS. 23-25.

FIG. 30A depicts a retirement summary page of the illustrative GUI.

FIG. 30B depicts another example retirement summary page of the illustrative GUI.

FIG. 31 depicts a current plan tab of the retirement summary page of FIG. 30A

FIG. 32 depicts a plan model tab selected on retirement summary page of FIG. 30A.

FIG. 33 depicts a revisiting goals page of the illustrative GUI which facilitates user definition of a model retirement goal for comparison purposes.

FIG. 34 depicts an updated version of the plan model tab of FIG. 32.

FIG. 35 depicts a savings rate page of the illustrative GUI.

FIG. 36 depicts the savings rate page of FIG. 35 with a slider moved to a new location to increases a contribution rate.

FIG. 37 depicts a savings type page of the illustrative GUI.

FIG. 38 depicts the savings type page of FIG. 37 enlarged to include a manual selector region.

FIG. 39 depicts a contribution review page of the illustrative GUI.

FIG. 40 depicts a contribution confirmation page of the illustrative GUI.

FIG. 41 depicts a savings goal page of the illustrative GUI.

FIG. 42 depicts an alternative savings rate page of the illustrative GUI.

FIG. 43 depicts an investment advice page of the illustrative GUI.

FIG. 44 depicts a change review page of the illustrative GUI.

FIG. 45 depicts a confirmation page of the illustrative GUI.

FIG. 46 depicts a social security page of the illustrative GUI.

FIG. 47 depicts a social security benefits page of the illustrative GUI.

FIG. 48 depicts an institution selection page of the illustrative GUI.

FIG. 49 depicts an account link page of the illustrative GUI.

FIG. 50 depicts a retirement asset page of the illustrative GUI.

FIGS. 51A and 51B depict asset configuration pages of the illustrative GUI.

FIGS. 52A and 52B depict account configuration pages of the illustrative GUI.

FIGS. 53A and 53B depict account configuration pages of the illustrative GUI.

FIG. 54 is an assets page of the illustrative GUI.

FIG. 55 is a savings goals page of the illustrative GUI.

FIG. 56 is an add retirement asset page of the illustrative GUI.

FIG. 57 is an opportunities page of the illustrative GUI.

FIG. 58 is a participant information page of the illustrative GUI.

### DETAILED DESCRIPTION

This disclosure generally relates to systems and methods for developing and managing individualized plans, such as, but not limited to financial (e.g., retirement) plans, health and wellness plans, and proficiency/skill development plans. In general, the systems described herein access user profile data and other data relevant to a user plan from one or more sources and generate predicted outcomes based on the collected data. Implementations of the present disclosure can also provide predicted outcomes based on modified data, e.g., to evaluate outcomes that may result from changes to a user plan, thereby informing user decisions.

For example, systems according to this disclosure can receive values (e.g., input by the user and/or retrieved from one or more external sources) and use those values to generate projections (e.g., using one or more predictive engines). In certain implementations, the projections can be generated in real-time or in near real time. Additionally, the management system can receive modified values (e.g., input by the user) and can use the modified values to generate modified projections (e.g., using one or more predictive engines). Like the other projections, the modified projections can be generated in real time or in near real time and the system can dynamically update the modified projections.

Systems of this disclosure include or otherwise provide a graphical user interface (GUI) to the user and/or to advisors of the user. Among other things, the GUI displays projections for a user plan of the user based on current data, enables the user to explore their current plan in detail, and allows the user to make changes to his or her plan. In certain implementations, the GUI also presents dynamically generated opportunities and recommendations to the user for implementation in the user's plan. The GUI also supports modelling of changes to a user's plan by providing projected outcomes based on proposed modifications and functionality for implementing proposed modifications.

Aspects of this disclosure are suitable for implementation in a variety of contexts and applications. For example, while this disclosure is primarily focused on implementations related to financial planning (e.g., retirement planning), the various concepts disclosed herein can be readily adapted for other areas include, but are not limited to health management (e.g., health, fitness, nutrition) and skill development. More generally, the concepts taught in this disclosure are applicable to and can be adapted to any endeavor involving long-term planning and that may benefit from projection of user plan outcomes, dynamically generated recommendations for improving user plans, and ongoing monitoring and revision of user plans. This disclosure also describes various features and functionalities for GUIs and, particularly, features and functionalities useful in GUIs for planning-related applications.

As a first example, implementations of this disclosure may be used to manage plans for achieving health goals (e.g., goals related to general health, fitness, and nutrition). In one specific example, systems according to this disclosure may facilitate a user plan for weight loss. In such implementations, the system may receive user health data and project health information about the user. Health data may be directly input by the user or collected from other sources including user computing devices (e.g., smart phones or wearable computing devices), other health-related applications, and external databases storing health data of the user. Among other things, the user health data can include, for example, information about the user (e.g., height, weight), physiological or biometric data of the user (e.g., heart rate, blood pressure, blood oxygen saturation), diet information (e.g., a food log), habits of the user (e.g., number of calories consumed per day, number of hours spent exercising per week, number of alcoholic drinks consumer per week), or a combination thereof. Based on the received health information, the system can project health information about the user (e.g., projected weight at one or more future times). The system may also receive modified health data and provide information on how such modifications may alter the provided projections. For example, in certain implementations the user may modify the number of calories consumed per day, the number of hours spent exercising per week, and/or the number of alcoholic drinks consumer per week. The system may then generate modified projected health information about the user (e.g., projected weight at one or more future times) in response to the modified health data.

As another example, systems according to this disclosure can be used to manage plans for goals related to proficiency, education, skills, or other development of a user. For example, the user can be an individual who wants to learn a new language. The system may receive user data related to a user's current level of proficiency, personal information about the user, plans for studying, and other similar information. Similar to the health data in the previous example, the proficiency data may be input by the user or collected from external sources. In certain implementations, collecting proficiency data may include providing one or more questionnaires or tests to verify the proficiency of the user. Based on the user's data, the system may then project how the user will progress in their proficiency over time based on current user data. The system may also be configured to receive modifications to the user data and to provide updated projections based on the modified data.

In still another example application, the systems and methods of this disclosure may facilitate plans for achieving account-related goals, e.g., a balance or future income for financial accounts. For example, in the context of financial planning for retirement, systems according to this disclosure may collect financial data for a user, external financial data (e.g., market data and projections), and other similar data aggregated from multiple sources. The system may then provide one or more projections (e.g., retirement income projections) based on the collected data.

Regardless of the specific application, implementations of systems according to this disclosure may present projections and related data to users through one or more user interfaces. In certain implementations, such data may be presented to only the user; however, this disclosure contemplates that data associated with a given user may also be presented to other individuals through corresponding user interfaces. For example, when systems according to this disclosure are implemented in a health-related application, user data may be made available to nutritionists, physical therapists, trainers, doctors, or other health-related professionals. Similarly, when used in the context of proficiency and development, user data may be made available to trainers, teachers, professors, or similar individuals responsible for training and educating the user. As a final example, when implemented in the context of financial planning, user data may be made available to a financial planner, account manager, or similar financial professional associated with the user.

In certain implementations, the system provides alerts or reporting functionality related to a user's progress regarding the user's plan and/or goal. For example, the system may generate and communicate alerts when a user deviates from a goal or progression trajectory. As another example, the system may generate and communicate alerts that include recommendations or opportunities for the user to improve his or her current progress or future projections.

Implementations of this disclosure include a GUI computer system for providing a graphical user interface (GUI). The GUI computer system is in communication with at least one planning engine (also referred to herein as a “predictive engine”) configured to provide projections and to facilitate planning by a user.

In a financial planning context, for example, the planning engine may include multiple optimization modules for planning significant personal economic events (e.g., investment, savings, retirement). The GUI computer system, in turn, could be configured to capture and centrally store user profile data, including the financial data used by the optimization modules, such as the composition of investment accounts (e.g., employer-provided 401(k) plans). The planning engine could be further configured to retrieve additional financial data from multiple external data sources, such as asset return projections.

The planning engines may also be configured to provide similar functionality in non-financial contexts. For example, in the context of a health-related application, the planning engine may include multiple optimization modules for planning a user's nutrition and exercise. In the context of a proficiency-related application, the planning engine may include multiple optimization modules for planning a user's lesson plan, study and practice routine, etc. Depending on context, the planning engine can be configured to retrieve suitable data from any applicable external sources, including by way of one or more suitable APIs or directly from the user (e.g., via a web application).

Regardless of the specific application, the GUI computer system may be configured to provide a web interface to capture financial data from the user. For example, the GUI computer system may provide a HTTP API or an interactive web application through which the user can enter data. Additionally, the GUI computer system may be configured to cause the GUI to be displayed by an application installed on a mobile device of a user.

In financial applications, the planning engine may be configured to generate account projections in response to captured financial data. In some embodiments, the planning engine generates account projections (e.g., in near-real-time) based on updated financial data retrieved from the external data sources (e.g., third-party banking institutions, investment institutions) and/or from the user interface. For example, a deferral optimization module generates an updated account projection based on changes in employer contribution formulas, maximum contribution formulas, effective tax rates, current contribution rates, account allocation, project return data, and the like.

More generally, the planning engine generates a projection based on captured data and, in certain implementations, generate such projections in substantially real time. For example, in response to receiving updated health information for a user, the planning engine may dynamically update a projected weight loss trajectory of a user in substantially real-time. As in the financial context, the projections provided by the planning engine may rely on one or more formulas or variables relevant to the projection being generated.

Referring again to financial planning applications, the planning engine may be further configured to, during the generation of account projections, generate a portfolio data object for each of a plurality of future years. The portfolio data object is configured to calculate an expected portfolio return across a plurality of asset classes, using an expected asset class return weighted by an assigned asset class weight, and a portfolio standard deviation across the plurality of asset classes, using an asset class standard deviation and an asset class covariance weighted by the assigned asset class weights. After generating the portfolio data object, the planning engine may pass the portfolio data object to a Monte Carlo return object. The Monte Carlo return object executes a number of simulations to project a return on the account data over the plurality of future years and outputs a matrix of projected returns over the plurality of future years. While traditional planning engines require the Monte Carlo algorithm to operate separately on the expected return and standard deviation for each asset class in the portfolio, the return calculation module of the planning engine described herein requires the Monte Carlo return algorithm to operate only once on the portfolio for each year because the expected portfolio return and portfolio standard deviation are pre-derived from the asset class values by the portfolio data object. Thus, the number of randomized simulations is reduced to one per year, greatly reducing the computational resource intensity required while performing the Monte Carlo simulations.

The Monte Carlo return object may be configured to, during the execution of simulations for projecting a return on the account data, utilize a graphics processing unit (GPU) for executing the simulations. By using a GPU instead of a traditional central processing unit (CPU), the simulations are completed faster and more efficiently because the GPU is better configured to handle performing operations on vector arrays, such as a vector of portfolio data objects contained in a glidepath data object, when the vector arrays need the same sequence of operations performed on them to produce, for instance, the matrix of simulated returns included in the Monte Carlo return object.

More generally, systems according to this disclosure may be configured to provide outcomes using multiple projections and suitable simulations for each of multiple timer periods. For example, while the foregoing example provided year-by-year outcomes for a user's financial returns, other implementations may include outcomes on a shorter time scale (e.g., monthly or weekly) and/or for a different (e.g., weight in the context of a health-related application, proficiency in the context of a leaning-related application). Regardless of the measured outcome and time period, however, the general process may be substantially similar. For example, one or more planning engines generate a first set of objects representing an outcome for each of multiple time periods. Each such object may then be provided as an input to a simulation process (e.g., a Monte Carlo simulation) that accounts for potential variability in the outcomes (e.g., as measured by a probabilistic model or statistic, such as standard deviation). The output of the simulation process may then be presented to a user via the GUI.

As noted above, in certain implementations and given the nature of calculations involved executing simulations, a GPU or similar special-purpose processor may be implemented to perform the necessary calculations more efficiently than if only a general purpose CPU were to be implemented. Accordingly, implementations of this disclosure may include functionality directed to selectively using and directing data to a general purpose CPU for a first set of functions and a special purpose processor, such as a GPU, for a second set of functions. For example, the first set of functions may include a first set of relatively basic calculations, communication with computing devices, generation of visual elements for display, etc., while the second set of functions may be specifically directed to executing one or more simulation processes.

In some embodiments, a single instance of the planning engine is configured to be capable of accessing, during run-time, a plurality of different sets of initialization parameters, and to selectively apply any one of the initialization sets for generating a projection in response to commands received during run-time. For example, in a financial planning context, the initialization parameters may include assumptions about factors such as mortality rates or salary growth rates to be used in making account projections. A first set of initialization parameters may be associated with United States data and assumptions, and a second set may be associated with Canada data and assumptions, for example. Additionally, or alternatively, a third and fourth set may each be based on United States data and assumptions, but the third set may further be associated with a first financial firm's assumptions about future performance for certain asset types, and the fourth set may be further associated with a second financial firm's (different) assumptions about those asset types.

More generally, an instance of a planning engine according to this disclosure may be dynamically reconfigurable by modifying the set of initialization parameters applied to the planning engine. As noted above, the different sets of initialization parameters may be based on different sets of assumptions. So, for example, a first set of initialization parameters may correspond to conservative assumptions while a second set of initialization parameters may correspond to more speculative assumptions. Other examples include those related to localization (e.g., as in the United States versus Canada example provided above).

Conventionally, generating a projection with a different set of parameters on a conventional systems requires a user to shut down and restart a computing device or software associated with the planning engine or otherwise initiate a new instance of the planning engine with a different configuration file. Advantageously, in embodiments of the current disclosure, a single instance of the planning engine may be used to calculate projections that apply multiple different sets of parameters, without requiring a shut down and restart and to dynamically change between sets of initialization parameters.

In certain implementations, the GUI computer system may provide different functionality based on a service level of a user. For example, the GUI computer system may be associated with a program or service that has a first or basic level and a second or enhanced level. In one specific instance, the first level may be a free or low-cost option while the second level may be a paid/more expensive option providing enhanced features and functionality.

In the context of financial planning, the GUI computer system may provide basic or introductory-level services for an existing retirement account. In one implementation, the retirement account is associated with a 401(k) or similar plan provided by an employer, and the GUI computer system provides a default user interface to employees to allow each employee to monitor performance and/or update basic data regarding the account. In addition, the GUI computer system provides an option to register for enhanced services, such as a financial advisor program that integrates other accounts and benefits of the user into a unified retirement income analysis and planning system.

For users registered or associated with an enhanced service level, the GUI computer system may maintain and build upon the GUI associated with introductory-level services, adding additional functionality and features in order to provide a familiar and streamlined user experience to users who register for the enhanced services. Among other things, such consistency between different versions of the GUI reduces barriers to user enrollment for the enhanced service level.

Differing service levels may also be associated with different planning engines. For example, when a user is enrolled with a first service level, the GUI computer system may rely on a first planning engine configured to receive calls from the GUI. In contrast, when the user is enrolled with an enhanced service level, the GUI computer system may rely on a s a second planning engine configured to receive calls from the GUI and provide projections for the enhanced service level. In certain implementations, the first planning engine may provide a more limited analysis than the second planning engine. For example, the first planning engine may be configured to operate on a more reduced set of inputs, to perform fewer iterations of certain calculations, to provide more limited outputs, or to otherwise provide a more simplistic projection as compared to the second planning engine. In certain implementations, the first planning engine and the second planning engine may be executed on different computing devices with different performance characteristics. So, for example, the second planning engine may be executed on a more powerful computing system capable of performing more sophisticated and/or more computationally intensive projections in less time than a computing system on which the first planning engine is executed. Alternatively, the first planning engine and the second planning engine may be operated on substantially similar computing systems but with calls to the computing system executing the second planning engine being handled more efficiently due to fewer calls being made to the second planning engine. Alternatively, a single planning engine may interface with the GUI for both service levels. In such implementations, an application programming interface (API) or other interface between the planning engine and the GUI computer system may permit calls to the planning engine to specify a service level. In response to the specified service level, the planning engine operates in one of multiple modes or configurations, each of the mode or configurations corresponding to a different service level.

In some embodiments, the GUI is further configured for use by a services representative of the enhanced services provider. The term “services representative” should be understood to encompass a broad range of advisory personnel that may interact, on behalf of the enhanced services provider, with participants (i.e., holders of financial accounts) in the system. For example, participants in a plan associated with the system may call or initiate an on-line chat with the services representative. In some cases, a participant at the basic services level may wish to obtain one-time recommendations at the enhanced level from the services representative. In other cases, a participant at the basic services level may wish to obtain additional information or assistance from the services representative in enrolling for the enhanced services. In still other cases, a participant already at the enhanced services level may wish to obtain help or clarification from the services representative about some aspect of the participant's own experience with the GUI. In the example embodiment, the GUI provides to the services representative the same underlying pages and the same current status and projections available to enhanced level participants, so that the services representative can assure the participant about the precise effects of any recommendations. In addition, at least one page of the GUI as displayed in response to a services representative log-in includes additional information about the participant's account that enables the services representative to answer typical questions or more fully explain options to the participant.

In some implementations, the GUI computer system is configured to generate alerts based on the updated projections. In some implementations, where the GUI computer system is configured to compare projections with stored goals (e.g., stored financial, health, proficiency/development goals), the GUI computer system may be configured to alert users when a projection does not satisfy a stored goal. Additionally, the GUI computer system may be configured to call the planning engine to generate an updated plan (e.g., an updated account configuration (contribution amount, asset allocation, etc.) for financial planning implementations, an updated diet and/or exercise plan for health-related implementations, an updated learning/study schedule for proficiency-related implementations) in response to the updated projection.

As such, the GUI computer system allows the user to receive benefits in managing various plans (e.g., financial plans, health plans, education/development plans) by, for example, dynamically projecting outcomes, evaluating current plan parameters and targets, evaluating potential changes to plan parameters and targets, alerting users when the user deviates from a plan trajectory, and the like. For example, in financial planning-based implementations, the GUI computer system allows the user to receive benefits in managing various plans (e.g., financial plans, health plans, education/development plans) by, for example, estimating investment income, evaluating the effect of planned contributions, evaluating the effect of benefit plans, adjusting account asset compositions, projecting required replacement income, and determining a withdrawal schedule. Collection, analysis, and targeted presentation of such user and market data allows the user to better determine whether they are on target to meet their retirement goals or manage their wealth during retirement.

The following discussion describes an example implementation of the present disclosure focusing primarily on financial planning. While the primary example of this disclosure pertains to financial planning, implementations of this disclosure are not specifically limited to financial planning applications. More generally, implementations of this disclosure are directed to systems and methods for dynamically generated and evaluating predicted outcomes for a user. As previously discussed, financial planning (e.g., retirement planning) is a particularly relevant area for aspects of the present disclosure; however, the concepts and teachings of this disclosure can be readily adapted to other contexts and applications including, but not limited to health and education. Accordingly, while the primary example of this disclosure includes metrics, calculations, data, etc. relevant to financial planning, such metrics, calculations, data, etc. may be readily replaced, supplemented, or modified to fit other applications and contexts.

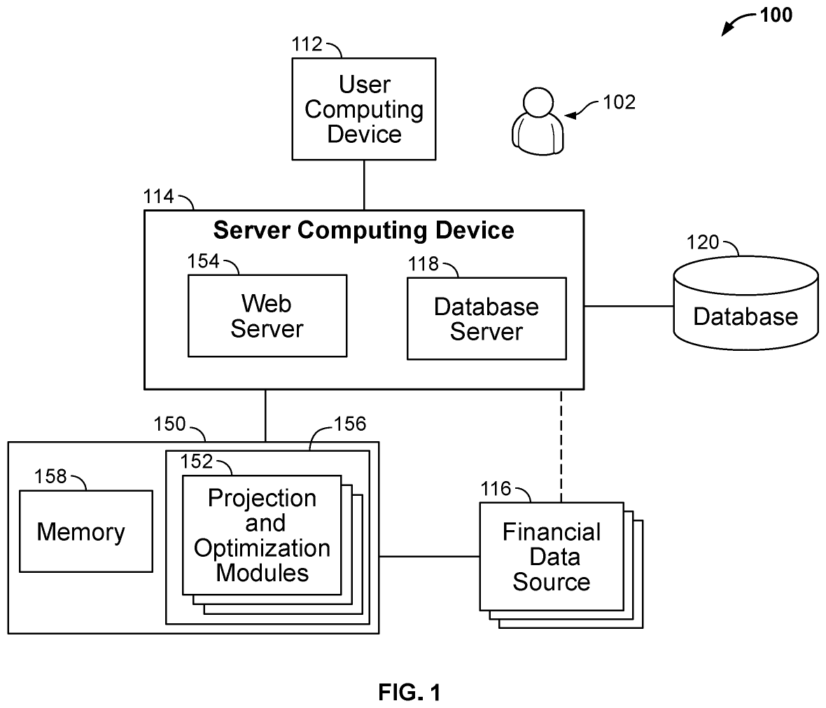

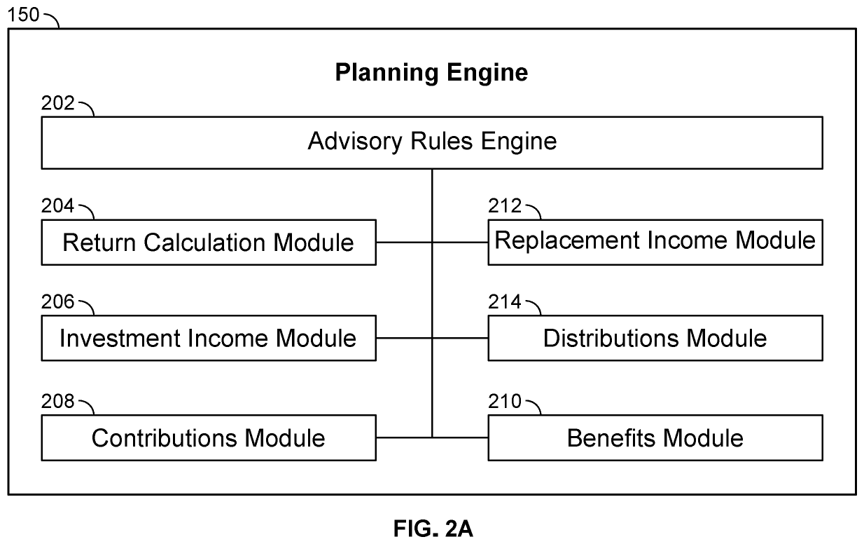

With the foregoing in mind, FIG. 1 is a simplified block diagram of an example system 100 in accordance with the present disclosure. Given the primary example in this disclosure of a system for financial planning, system 100 is also referred to as financial planning (FP) system.

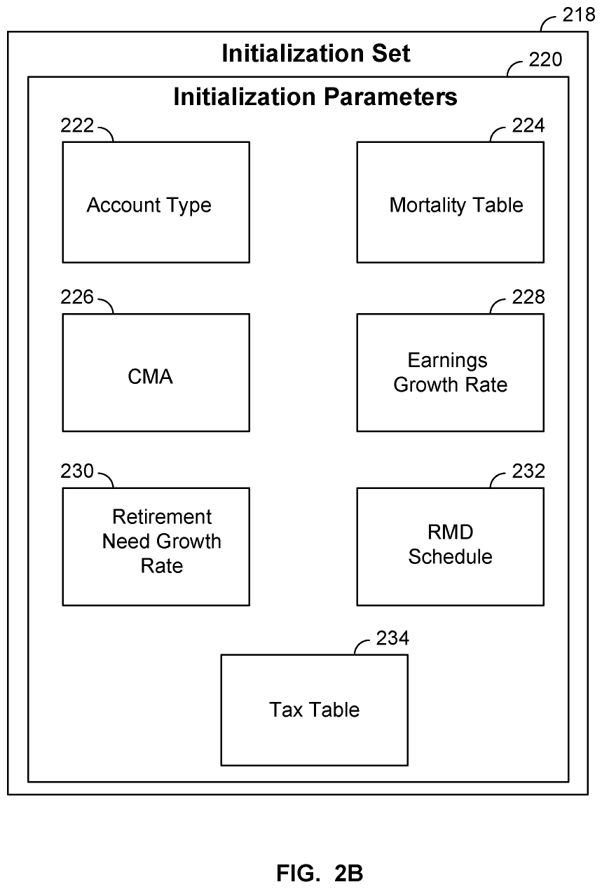

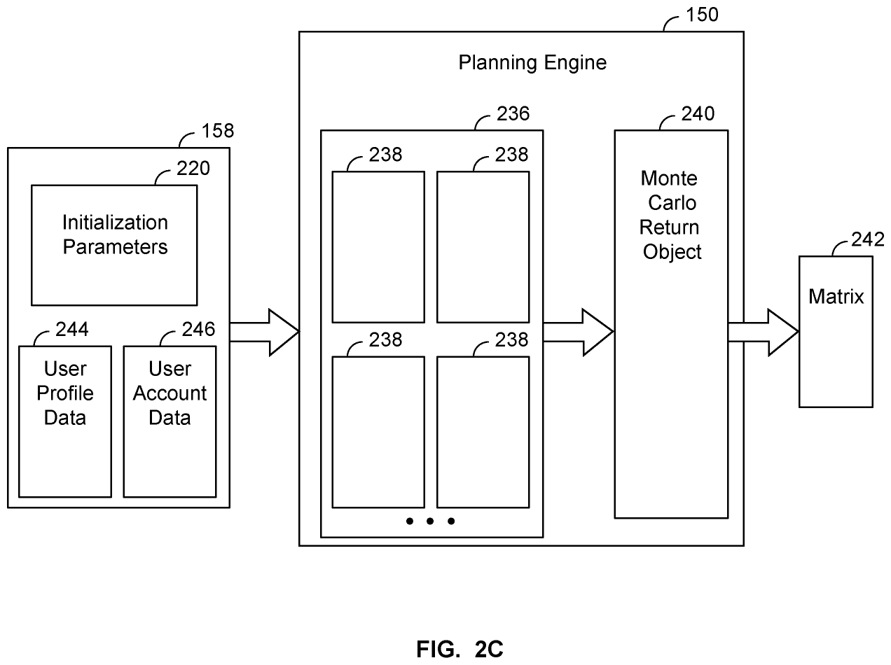

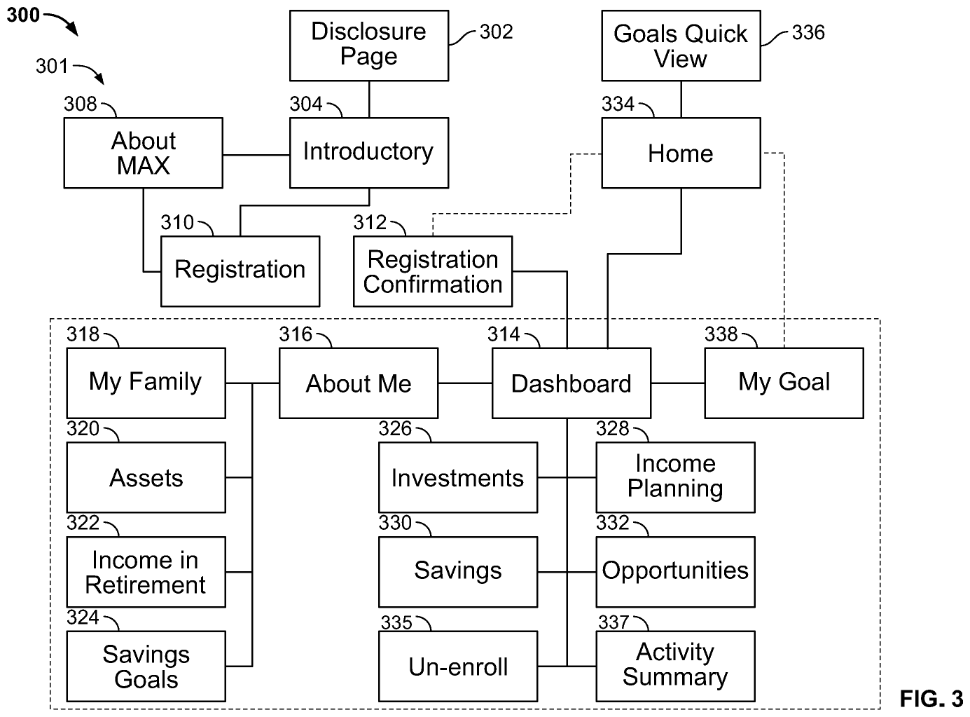

System 100 may be used for generating account projections based on financial data captured from multiple sources and alerting accountholders in response to changes in the account projection. In an example embodiment, system 100 includes a server computing device 114, which is also referred to herein as GUI computer system 114 and configured to interface with at least one planning engine 150. Planning engine 150 includes projection and optimization modules 152, which are configured to perform various analytical tasks with regard to analyzing a retirement portfolio of a user 102. The optimization modules are described in greater detail below with respect to FIG. 2A. In the example embodiment, planning engine 150 includes at least one processor 156 programmed to execute projection and optimization modules 152. For example, the at least one processor is coupled to a memory 158 that stores computer-readable instructions for executing the functions discussed herein. The term processor, as referred to herein, may refer to central processing units, microprocessors, microcontrollers, reduced instruction set circuits (RISC), application specific integrated circuits (ASIC), logic circuits, and any other circuit or processor capable of executing the functions described herein. Memory 158 may include any combination of RAM memory, ROM memory, EPROM memory, EEPROM memory, and non-volatile RAM (NVRAM) memory. The above memory types are for example only and are thus not limiting as to the types of memory usable for storage of a computer program and data used and/or generated by executing modules.

In the example embodiment, system 100 also includes at least one user computing device 112. In some embodiments, user computing device 112 includes computing devices configured to implement a web browser or a software application, which enables user computing device 112 to communicate with GUI computer system 114 (e.g., using the Internet.) User computing device 112 and GUI computer system 114 may be communicatively coupled through various networks or network interfaces including, but not limited to, at least one of a network, such as the Internet, a local area network (LAN), a wide area network (WAN), an integrated services digital network (ISDN), a dial-up-connection, a digital subscriber line (DSL), a cellular phone connection, and a cable modem. Alternatively, user computing device 112/or and GUI computer system 114 include any device capable of accessing the Internet such as, for example, a desktop computer, a laptop computer, a personal digital assistant (PDA), a cellular phone, a smartphone, a tablet, a phablet, or other web-based connectable equipment. User computing device 112 may be computing devices associated with at least one user 102 and may be communicatively coupled to GUI computer system 114.

In one embodiment, GUI computer system 114 includes a database server 118 that is communicatively coupled to a database 120. Database 120 stores user profile data associated with a plurality of users, account data associated with users, financial projections generated by the optimization modules, and other data that may be required for planning engine 150 to function as described herein. GUI computer system 114 is configured to centrally store account data, asset data, user profile data, and asset class data in database 120. GUI computer system 114 uses database server 118 to interface with database 120.

According to the example embodiment, database 120 is disposed remotely from GUI computer system 114. In other embodiments, database 120 is centralized, and may be a part of GUI computer system 114. In the example embodiment, an administrator or a financial planner (not shown) associated with system 100 or user 102 is able to access database 120 through a user computing device, such as user computing device 112, by logging onto GUI computer system 114. In the example embodiment, GUI computer system 114 may be associated with a financial services provider or financial account recordkeeper (not shown).

GUI computer system 114 is configured to capture and centrally store financial data associated with a financial portfolio of the user 102. In some embodiments, GUI computer system 114 provides an interactive web application to user computing device 112, through which the user 102 can enter data or otherwise interact with GUI computer system 114. Additionally, GUI computer system 114 may provide an API (e.g., a HTTP API), through which financial data may be received from one or more financial data sources 116. Financial data received from financial data sources 116 may include, for example, interest rates, projected growth rates for various funds or asset classes, the compositions of funds managed by third parties, and/or employer contribution data. GUI computer system 114 may use database server 118 to store received financial data in database 120. For example, database server 118 may parse financial data received from user computing device 112, planning engine 150, and/or financial data sources 116 before storing the financial data in database 120.

In the example embodiment, web server 154 generates and transmits web pages to user computing device 112 to implement the GUI. The generated web pages may be configured to capture data from user 102 and transmit it back to server computing device 114. For example, user 102 may fill form fields on a webpage. Additionally, web server 154 may generate visualizations and/or representations of data (e.g., account balance projections) for display on user computing device 112 (e.g., on a retirement planning dashboard).

Although FIG. 1 pertains to account management and planning related to personally finances, in other implementations of this disclosure, the GUI computer system 114 can be adapted for use for other applications and contexts. More generally, the GUI computer system 114 obtains one or more current values for parameters of a user profile associated with a user, e.g., by user input (e.g., through a web interface or application adapted to capture data from the user) and/or by retrieving current values from one or more data sources. Such data sources may include external databases but may also include other computing devices, such as wearable devices, smartphones, or other devices of the user. Depending on the particular implementation of the system, the current values obtained by the GUI computer system 114 can include, for example, personal information about the user, physiological or biometric data collected from the user, subject proficiency data (e.g., subject-specific test scores), habits of the user (e.g., dietary, sleep, exercise, or other habits), financial data of the user, and the like. In some embodiments, user profile data may include information about the user such as, for example, birth date, gender, salary, state of residence, current employee savings rate, plan match, profit sharing, retirement age, pension information, social security information (e.g., estimated social security amount, start age), balance information and current fund holdings, and loan information.

FIG. 2A is a component diagram illustrating components of the at least one planning engine 150 shown in FIG. 1. In the example embodiment, planning engine 150 generates an extended term financial projection based on user profile data (e.g., financial goals, age, projected retirement date) and account data (e.g., asset data, contribution data, benefit data, income data) to help user 102 plan for retirement. For some users, user profile data and/or account data may be associated with a single person, while for other users, user profile data and/or account data may be associated with more than one person (i.e., a household). In the specific illustrated implementation, planning engine 150 includes advisory rules engine 202, return calculation module 204, investment income module 206, contributions module 208, benefits module 210, replacement income module 212, and distributions module 214. Modules 204, 206, 208, 210, 212, and 214 may be examples of projection and optimization modules 152 (shown in FIG. 1).

Advisory rules engine 202 is configured to execute and schedule optimization modules based on user profile data and account data retrieved from GUI computer system 114. Advisory rules engine 202 manages operation of: (i) return calculation module 204 (e.g. to project account balances over time based on asset data), (ii) contributions module 208 (e.g. to adjust account balances generated by return calculation module 204 based on planned asset contribution data), (iii) benefits module 210 (e.g. to project the value of benefit plans), (iv) investment income module 206 (e.g. to project investment income based on account balances generated by return calculation module 204), (v) replacement income module 212 (e.g. to determine a replacement income amount based on user profile data), and (vi) distributions module 214 (e.g. to generate distribution schedules based on the investment income data generated by investment income module 206).

Return calculation module 204 is configured to receive account data including asset identifiers from GUI computer system 114, to calculate an expected return and standard deviation for each asset, and to derive an overall expected return and account standard deviation using the results for each of the assets. For example, an account may include assets of multiple types, such as securities, electronically traded funds, managed funds, bonds, and the like. Return calculation modules 204 applies any suitable algorithm to calculate the expected return and standard deviation for each type of asset.

In some embodiments, for each asset identifier, return calculation module 204 is configured to determine if the asset is managed or non-managed. In response to each asset identifier determined to be non-managed, return calculation module 204 determines the composition of the asset. In the example embodiment, return calculation module 204 determines asset class composition percentages. For example, return calculation module 204 may determine an asset is composed of 40% technology stock, and 60% municipal bonds. Return calculation module 204 retrieves expected return, standard deviation, and covariance data for each asset class. For example, technology stocks may have an expected return of 10% with a standard deviation of 0.4.

In response to each asset identifier determined to be managed, a glidepath module may be called. Alternatively, return calculation module 204 calculates expected returns in any suitable fashion. For example, return calculation module 204 generates projected account balance data based on expected return, standard deviation, and covariance data retrieved for each asset. More specifically, return calculation module 204 generates an account expected return based on aggregating the expected return of each asset. Additionally, return calculation module 204 generates an account standard deviation based on aggregating the retrieved standard deviation data for each asset.

Return calculation module 204 outputs a matrix of account expected returns, including the account expected return, and account expected returns modified by the aggregated standard deviation data. For example, account balances at multiples of the standard deviation may be output. In some embodiments, return calculation module 204 is configured to return the expected return matrix to GUI computer system 114, to be stored in database 120 using the account identifier.

Additionally, return calculation module 204 is configured to generate a projected account balance using the expected return matrix. Return calculation module 204 receives a baseline account balance, such as a previous year account balance or current account balance. The previous year account balance may be zero. Return calculation module 204 iteratively applies the expected return matrix to the baseline account balance to generate an account balance projection. In the example embodiment, return calculation module 204 determines projected annual balances. For example, annual account balances may be projected for a term of 50 years. In some embodiments, the account balance projection term may be received from GUI computer system 114, where database 120 stores a financial goal (e.g., retirement date, savings goal). For example, return calculation module 204 may project annual account balances until a projected retirement date based on the expected return matrix.

An example embodiment of return calculation module 204 is illustrated in FIGS. 2B and 2C. In the example embodiment, planning engine 150 is configured to load into memory 158, and/or have access to during operation, at least one initialization set 218 of initialization parameters 220 (also known as configuration variables). Each initialization set 218 represents a separate use case for planning engine 150. A use case may refer to a particular legal (e.g., national) jurisdiction. More specifically, parameters for different jurisdictions may vary based on different laws pertaining to certain types of financial accounts, and/or different data and assumptions about factors such as mortality rates or salary growth rates. For example, a first initialization set may be associated with United States data and assumptions, and a second initialization set may be associated with Canada data and assumptions. Additionally, or alternatively, a use case may refer to a particular set of market and demographic assumptions within a given jurisdiction. For another example, a third and a fourth initialization set may each be based on United States data and assumptions, but the third initialization set may further be associated with a first financial firm's assumptions about future performance for certain asset types, and the fourth initialization set may be further associated with a second financial firm's (different) assumptions about those asset types.

In some embodiments, each initialization set 218 is loaded from a separate data file. Alternatively, a plurality of initialization sets 218 are loaded from separate data structures in a single data file. For example, initialization parameters 220 include at least one account type 222, at least one mortality table 224, a set of capital market assumptions (CMA) 226, at least one earnings growth rate 228, at least one retirement need growth rate 230, at least one required minimum distribution (RMD) schedule 232, and at least one tax table 234.

In the example embodiment, a single instance of planning engine 150 is configured to be capable of accessing during run-time a plurality of initialization sets 218, and to selectively apply any one of initialization sets 218 for generating a financial projection in response to commands received during run-time. For example, planning engine 150 may select an appropriate initialization set 218 based on the user profile data and the account data associated with each user 102. By contrast, conventional planning engines are capable of accessing only a single set of configuration parameters during run-time. In other words, to run a projection with a different set of parameters 220 on a conventional planning engine, a user would be forced to shut down and restart, or otherwise initiate a new instance of, the planning engine with a different configuration file. Advantageously, in embodiments of the current disclosure, a single instance of planning engine 150 may be used for projections applying multiple different initialization sets 218 of parameters 220 without requiring a shut down and restart.

For example, planning engine 150 analyzes user profile and account data passed from database 120 corresponding to a first user 102 and selects the corresponding initialization set 218 to use for a first projection, and then analyzes the data passed from database 120 for a second user 102 and selects a different appropriate initialization set 218 to use for a second projection, without requiring a shut down and restart of planning engine 150. Because each single instance of planning engine 150 is capable of handling multiple use cases without re-loading or re-booting to access the appropriate initialization parameters, planning engine 150 reduces down-time and increases processing efficiency relative to conventional systems. For example, planning engine 150 eliminates a need to pre-sort requests originating from different jurisdictions and/or different financial firms for routing to instances of the planning engine dedicated to that jurisdiction and/or financial firm.

Account type 222 may include a variety of parameters, at least some of which may be associated with a specific legal jurisdiction. For example, parameters of account type 222 include an employee contribution limit, which is the maximum dollar amount that can be contributed into the account by the owner of the account; an employer contribution limit, which is the maximum dollar amount that can be contributed in to the account by the employer; a combined limit, which is the maximum annual dollar amount that can be contributed to the account; a tax treatment growth indicator, which indicates whether the gains in the account are subject to an annual tax (e.g. capital gains); and a tax treatment withdrawal indicator, which indicates which withdrawals from the account are subject to tax.

Account type 222 also may include parameters such as: a tax treatment contribution indicator, which indicates whether the contributions to the account are subject to tax; a contribution subject to employment tax indicator, which indicates if the contributions to the account are subject to special employment taxes; an early withdrawal penalty age, which indicates an owner age, after which withdrawals taken out of the account will no longer be subject to an early withdrawal penalty; an early withdrawal penalty, which indicates a penalty for taking out an early withdrawal; and a loan limit, which indicates the maximum amount allowed to be withdrawn from the account type as a loan.

Account type 222 may further include parameters such as: a pretax support indicator, which indicates if the account supports pretax assets; a Roth support indicator, which indicates if the account supports Roth assets; an after-tax support indicator, indicating if the account supports after-tax assets; a taxable support indicator, indicating if the account supports taxable assets; and a required minimum distribution (RMD) indicator, indicating if the account is subject to one or more RMDs.

In some embodiments, each set of capital market assumptions (CMA) 226 includes a list of asset classes, an expected return for each asset class, a standard deviation of the expected return, a covariance of the expected return with other asset classes, and an equity indicator for equity asset classes. The covariance for each asset class may be provided in a covariance matrix across asset classes. Alternatively, each set of CMA 226 includes any suitable information, and/or is provided in any suitable format, which enables return calculation module 204 to project returns. In the example embodiment, the list of asset classes being passed to planning engine 150 for a projection must match the asset class names in the set of CMA 226. Otherwise, planning engine 150 stops processing and generates an error message. As noted above, different sets of CMA 226, each including different asset classes and/or values, may be provided for different initialization sets 218. For example, different financial institutions may use different assumptions to arrive at expected returns, standard deviations, and covariance values.

In the example embodiment, return calculation module 204 generates portfolio data objects 238. Each portfolio data object 238 represents a matrix of asset classes and corresponding weights (e.g., percentage of portfolio occupied by the respective asset class) in a given year. In other words, each portfolio data object 238 represents the asset allocation in a given year for a given user 102 account. Each portfolio data object 238 includes a function to calculate its own expected return, for example by the following formula:

E(r)=Σᵢ₌₁^{N}Rᵢ*Wᵢ

wherein E(r) is the expected portfolio return; Rᵢ, which is extracted from CMA 226, is asset class return for the ith asset class; W is asset class weight in the portfolio for the ith asset class, which may be passed to planning engine 150 from GUI computer system 114 to project returns based on a planned investment strategy of user 102, or iteratively selected by planning engine 150 in the course of determining an optimal strategy for user 102; and N is the number of asset classes defined in CMA 226. Similarly, portfolio data object 238 includes a function to calculate its own standard deviation, for example by the following formula:

∂=√(Σᵢ₌₁ⁿΣⱼ₌ᵢ₊₁ⁿwᵢ²*∂ᵢ²*wⱼ²*∂ⱼ²+2wᵢwⱼCov_{i,j})

wherein ∂ is the portfolio standard deviation, Cov_{i,j}, which is extracted from CMA 226, is covariance of asset classes i and j, and wᵢ is the asset class weight in the portfolio for the ith asset class. In some embodiments, portfolio data object 238 also contains integrity checks in order to further ensure that asset class return and standard deviation calculations are accurate. For example, portfolio data object 238 may check that no asset class weight is less than zero, that the sum of all portfolio weights is one-hundred percent, and/or that all asset classes are supported (e.g., all asset classes match the information in the selected initialization set of initialization parameters 220).

In the example embodiment, return calculation module 204 also generates glidepath data object 236 as a vector of portfolio data objects 238. In other words, glidepath data object 236 represents a series of yearly allocations among asset classes for a given account. Glidepath data object 236 is provided by return calculation module 204 as an input to a Monte Carlo return object 240. More specifically, Monte Carlo return object 240 generates multiple different projected returns on the investment account of user 102, based on the user profile data and account data of user 102, over a number of years included in glidepath data object 236, wherein each projection applies random variations in the portfolio return for each year based the standard deviations and covariances derived from CMA 226 The output of Monte Carlo return object 240 is a matrix 242 having a first dimension equal to the number of years of the simulation and a second dimension equal to a number of simulation runs. Each value in the matrix 242 is the projected return on the portfolio for a corresponding year and simulation run. Any suitable Monte Carlo algorithm is used to obtain the values in the matrix 242 from the portfolio expected return and portfolio standard deviation. The use of glidepath data object 236 eliminates a need to call Monte Carlo return object 240 separately with portfolio data object 238 for each year of the simulation, reducing the use of computational resources by planning engine 150. Alternatively, portfolio data is used to generate Monte Carlo returns in any suitable fashion that enables planning engine 150 to function as described herein.

Because each portfolio data object 238 calculates its own expected return and standard deviation, the use of portfolio data objects 238 improves an efficiency of obtaining Monte Carlo projections for the corresponding account. More specifically, conventional planning engines require the Monte Carlo algorithm to operate separately on the expected return and standard deviation for each asset class in the portfolio in order to generate a projection run. In contrast, return calculation module 204 of the example embodiment requires the Monte Carlo algorithm to operate only once on the portfolio, using the portfolio expected return and portfolio standard deviation pre-derived from the asset class values. The number of randomized simulation runs for each portfolio data object 238 is thus reduced by a factor of the number of asset classes to one, greatly reducing the computational resource intensity associated with Monte Carlo simulations.

In the example embodiment, with reference also to FIG. 1, the at least one processor 156 of planning engine 150 includes at least one general-purpose central processing unit (CPU), as well as at least one graphics processing unit (GPU) having a dedicated VRAM memory. Return calculation module 204 is configured to process Monte Carlo simulations executed by Monte Carlo return object 240 on the GPU. In particular, due to large datasets involved in running numerous Monte Carlo simulations, a typical CPU would draw heavily on general memory while generating matrix 242, limiting bandwidth of the CPU and the general memory. The dedicated VRAM memory of the GPU, on the other hand, is equipped to handle the large datasets associated with the Monte Carlo simulations with a reduced or eliminated need for general memory. Thus, the general memory and/or CPU can be used for other tasks. Additionally, while a CPU typically performs operations on one piece of data at a time, a GPU allows many simple mathematical operations to be executed in parallel. Therefore, in some embodiments, the GPU is better configured for performing operations on vector arrays, such as the vector of portfolio data objects 238 contained in glidepath data object 236, when the vector arrays need the same sequence of operations performed on them to produce, for instance, the simulated returns matrix 242 included in Monte Carlo return object 240. In other alternative embodiments any suitable module is executed on the GPU. Alternatively, the at least one processor 156 does not include a GPU and/or return calculation module 204 is configured to execute Monte Carlo simulations on any suitable processor, including a processor separate from, but communicatively coupled to, planning engine 150.

In the example embodiment, Monte Carlo return object 240 also accepts a flag indicating if a variable random number seed should be used. By setting the flag to use a fixed random number seed, multiple calls to planning engine 150 having the same input parameters will result in the same output matrix 242 from Monte Carlo return object 240.

Accordingly, the technical effects and advantages achieved by planning engine 150 include at least one of: (a) reducing system down-time relative to conventional systems; (b) increasing processing efficiency relative to conventional systems; and (c) calculating simulated returns faster than conventional systems.

Returning to FIG. 2A, in the example embodiment, investment income module 206 determines a spending rate based on projected account balances generated by return calculation module 204. The spending rate may define monthly investment income during retirement. For example, investment income module 206 may determine an account valued at $130,000 will generate $3,200 in estimated monthly retirement income. Investment income module 206 searches through spending rates to find a desired spending rate. In other words, investment income module 206 may calculate the effect of various spending rates and select a spending rate such that the account balance is not exhausted during a time period such as a period of retirement or disability. Additionally, investment income module 206 may generate adjusted spending rates using the expected return matrix (e.g., standard deviation data) generated by return calculation module 204. Investment income module 206 may generate multiple spending rates associated with above and below average performance, as defined by the standard deviation data.

In some embodiments, investment income module 206 determines a projected life expectancy of user 102. For example, investment income module 206 may determine an expected retirement term. In combination with user profile data (e.g., demographic data, retirement data), investment income module 206 may project the number of years in which retirement investment income may be needed. In some examples, investment income module 206 may utilize mortality weighting to estimate life expectancy of user 102. In other examples, investment income module 206 may estimate life expectancies based on demographic data such as health states, age, and sex of users. As another example, investment income module 206 may determine an expected disability term (e.g., a number of years where investment income is needed to offset disability support expenses).

In the example embodiment of FIG. 2B, investment income module 206 applies mortality weighting using a mortality table 224 from the applicable initialization set 218. Mortality table 224 may contain mortality factors (e.g., Gompertz-Makeham factors). The data in mortality table 224 may contain information regarding an age-dependent component and an age-independent component for a plurality of given age, gender, and health states. Alternatively, mortality information is provided in any suitable format. For example, probability of death at each age may be calculated by the following equation:

Mortality=exp(exp((age−gm)/gb)*(1−exp(year/gb)))

wherein gm represents the age-dependent component, gb represents the age-independent component, and “year” represents the number of years beyond the current year at which the age will be reached. As noted above, gm and gb may be different values in each initialization set 218. Moreover, in certain embodiments, mortality table 224 contains factors for fewer than every year of age (e.g., mortality table 224 may list factors at age 25, 30, 35, . . . ), and for non-specified years the gm and gb factors are estimated by investment income module 206 using liner interpolation.

In the example embodiment, investment income module 206 uses mortality table 224 to create a mortality data object that includes the mortality (i.e., probability of death) values calculated for each future year arranged in a mortality weighting vector, as well as a calculation of life expectancy. For example, life expectancy may be calculated from the elements “mortality weight(i)” of the mortality weighting vector by the following equation:

Life expectancy=Σ_{i=age}¹¹⁵mortality weight(i)

Alternatively, investment income module 206 creates and stores derived mortality and life expectancy values in any suitable fashion.

Returning to FIG. 2A, in the example embodiment, contributions module 208 is configured to adjust account balances generated by return calculation module 204 based on planned asset contribution data. For example, a portion of salary income of user 102 may be contributed to the account until retirement (e.g., on a monthly basis), which may also be supplemented by an employer (e.g., as a percentage matching contribution up to a predetermined limit). As another example, a specific dollar amount may be contributed on an annual basis (e.g., by user 102 or by user 102's employer).

For salary contributions, contributions module 208 adjusts the projected account balances generated by return calculation module 204. More specifically, each annual account balance projection is increased by the corresponding projected salary contribution. Further, subsequent years salary contributions may be adjusted based on projected salary growth. For example, contributions module 208 may identify an initial account balance of $100,000 and an initial salary of $50,000 and may determine that a 5% contribution in the first year results in a year-end account balance of $102,500. In the subsequent year, contributions module 208 projects may project that the salary of user 102 will grow to $55,000, and, as such, the subsequent year's contribution will be $2,750.

To project salary growth, contributions module 208 receives salary and employment data (e.g., job title, profession, career field, employer identifier) from GUI computer system 114 and estimates a salary growth rate based on the employment data. For example, contributions module 208 may determine a salary growth rate of 5% for an accountant, and a salary growth rate of 4% for an engineer.

Contributions module 208 may further calculate an employer contribution. Certain employers may match employee contributions or may provide a predetermined amount, such as a fixed amount or a fixed percentage of user 102's salary. Contributions may be matched at varying rates and may be limited by the employer. Contributions module 208 may receive employer contribution data (e.g., a match rate and a match limit) and adjust salary contributions based on the employer contribution data. Salary contributions may be adjusted by both projected salary growth and employer matching. For example, an employer may match 50% of an employee's contributions, up to a limit of $10,000 or 10% of the employee's salary, whichever is lower. For a salary of $50,000, and an employee contribution rate of 5%, the employer may match $1,250. As another example, with a salary of $200,000 and an employee contribution of 10%, the employer may match $10,000. As such, the employer may represent an example financial data source.

Additionally, contributions module 208 is configured to determine the post-tax amount of contributions, where applicable. Contributions module 208 may identify an effective tax rate (e.g., based on the salary data) and project a net contribution. For example, $2,500 may be contributed to a taxable account. Contributions module 208 determines the effective tax rate for the user is 15% and adjusts the account balance by $2,125.

Contributions module 208 is further configured to compare calculated contributions to account-specific limits. Certain accounts may have pre-tax or post-tax contribution restrictions. For example, post-tax retirement accounts may be limited to $18,000 of contributions per year. GUI computer system 114 determines when contributions are projected to exceed the limit and may cap the contribution amount based on the limit. In some embodiments, GUI computer system 114 alerts user 102, via GUI 301, that a contribution limit has been or will be reached. In other embodiments, GUI computer system 114 reallocates the contributions between restricted accounts (e.g., post-tax retirement account) and other accounts (e.g., health savings account, taxed account).

Contributions module 208 may also adjust projected account balances based on dollar amount contributions. For example, user 102 may contribute exactly $5,000 annually (e.g., in lieu of or in addition to any salary-based contributions). Contributions module 208 may account for direct contributions in addition to projected salary contributions.

In the example embodiment of FIG. 2B, contributions module 208 uses salary growth rate 228, also referred to as earnings growth rate 228, from the applicable initialization set 218. In the example embodiment, earnings growth rate 228 is provided as one or more salary curves reflecting salary growth as a function of age and/or job type, taking into account the effects of inflation, to be selectively applied based on demographic data of user 102. Future year salary values may then be calculated using the following formula:

Salary(i)=Salary(i−1)*(1+salary growth factor(age))

wherein i is the year of the forecast. Alternatively, earnings growth rate 228 is provided in any suitable fashion that enables contributions module 208 to function as described herein.

Contributions module 208 then uses earnings growth rate 228 to calculate future contributions to an account. For example, if a percentage of salary is to be applied to an account each year, the dollar contribution for a particular year may be calculated by the following equation:

Cᵢ=Salaryᵢ*C₀

wherein Cᵢ=dollar contribution in year i, Salary is salary in year i, and C₀ is percentage contribution in year 0. Alternatively, a contribution dollar amount may be applied to an account each year instead of a percentage. Contributions module 208 may monitor the calculated contribution amounts to ensure that all contributions are capped at appropriate governmental and plan contribution limits.

Returning to FIG. 2A, in the example embodiment, replacement income module 212 is configured to receive a replacement income amount based on user profile data (e.g., income data, income projection data). Replacement income module 212 is configured to estimate expenses in retirement, also known as retirement need. In the example embodiment, retirement need is calculated as a percentage of the projected salary at the time of retirement. In some embodiments, retirement need growth is projected based on inflation. For example, after the initial retirement need is calculated, the amount may grow by a projected inflation rate for each year of retirement. In other embodiments, retirement need growth is projected based on an age-dependent growth factor determined by replacement income module 212. For example, expenses may grow more rapidly based on age due to healthcare costs.

In certain embodiments, replacement income module 212 may adjust retirement need based on the life expectancy of the user, and a spouse of the user. The retirement need may decrease after the life expectancy of one household member. For example, the retirement need in years after the life expectancy of a household member may be decreased by a retirement need discount factor. More specifically, replacement income module 212 may retrieve age and life expectancy data from GUI computer system 114 and determine the number of years with a reduced household.

In the example embodiment of FIG. 2B, replacement income module 212 estimates replacement income using retirement need growth rate 230 from the applicable initialization set 218. Retirement need growth rate 230 includes projected growth rates for cash flow needs in retirement. In the example embodiment, retirement need growth rate 230 is provided in a curve, similar to earnings growth rate 228. Future year retirement need values may then be calculated, for example by replacement income module 212, using the following formula:

Retirem't Need(i)=Retirem't Need(i−1)*(1+Retirem't Need growth factor(age))*survivor discount factor

wherein i is the year of the forecast. In some embodiments, retirement need growth rate 230 further includes a survivor discount factor that is applied after a head of household reaches life expectancy (i.e., the survivor discount factor is 1 for all years through life expectancy, and then a constant discount factor beginning the year after life expectancy is reached). Alternatively, retirement need growth rate 230 is provided in any suitable fashion that enables planning engine 150 to function as described herein.

Returning to FIG. 2A, in the example embodiment, distributions module 214 is configured to determine when there is a net income need and make distributions from specific accounts based on tax and/or penalty factors. Distributions module 214 calculates net income need by subtracting retirement need from the combination of investment income and benefits (e.g., social security).

User 102 may have multiple accounts (e.g., Taxable Accounts, Post-Tax Accounts, Pre-Tax Accounts), and withdrawals from these accounts may have specific tax implications. Distributions module 214 is configured to determine an account ordering for distributions. For each account, distributions module 214 is configured to determine if a withdrawal penalty applies (e.g., an early withdrawal penalty) and/or a tax penalty. In some embodiments, distributions module 214 may evaluate specialized accounts, such as health savings accounts. Accounts without an early withdrawal and/or tax penalty may be ordered before other accounts. For example, an account including post-tax contributions may be ordered before an account where taxes are calculated on distributions. For accounts of comparable tax/penalty status, older accounts may be ranked before younger accounts.

Distributions are calculated in response to net income need from accounts, starting from the account with the lowest tax/penalty ranking, until the net income need is met. For example, given a net income need of $500 after considering social security, the $500 may be withdrawn from a post-tax account that does not have an early withdrawal penalty.

Further in the present embodiment, planning engine 150 may analyze and provide to the user an account withdrawal strategy, wherein the withdrawal strategy provides user 102 with recommendations as to how much to withdraw from different accounts. For example, if user 102 has a plurality of accounts, planning engine 150 may use a periodically updated hierarchy in order to recommend which account to withdraw from. As an example, the account withdrawal strategy may recommend that a user withdraw from, in order from first to last: taxable accounts, post-tax accounts, pretax accounts, Roth accounts, and then health savings accounts. In further embodiments the account withdrawal strategy may recommend withdrawing from tax accounts with no early withdrawal penalty before withdrawing from accounts with an early withdrawal penalty. In yet further embodiments, planning engine 150 may recommend, in the account withdrawal strategy, that user 102 withdraw from multiple account types.

As one type of specialized account, distributions module 214 is configured to consider accounts having required minimum distributions. In the example embodiment of FIG. 2B, distributions module 214 evaluates required minimum distributions based on a required minimum distribution (RMD) schedule 232 from the applicable initialization set 218. RMD schedule 232 may include parameters such as an amount to be withdrawn and an age at which the amount should be withdrawn. Further, multiple RMD schedules 232 may be supported by a single initialization set of initialization parameters 220. Alternatively, distributions module 214 receives required minimum distribution information in any suitable fashion that enables planning engine 150 to function as described herein.

Further in the example embodiment of FIG. 2B, distributions module 214 is configured to evaluate tax considerations based on tax tables 234 from the applicable initialization set 218. Tax tables 234 may include data regarding federal and state tax rates, as well as earned income tax credit (EITC) levels. Alternatively, distributions module 214 receives tax information in any suitable fashion that enables planning engine 150 to function as described herein.

Returning to FIG. 2A, in the example embodiment, benefits module 210 is configured to consider the value of various benefit plans (e.g., social security payments, pension plans, insurance plans) based on information received from GUI computer system 114. For example, investment income and social security income may be available to user 102 during retirement. Further, user 102 may have specialized pension plans (e.g., defined benefit plans, defined contribution plans) or annuities.

In financial planning-based implementations, GUI computer system 114 may be configured to project social security income. In the example embodiment, social security income is projected by retrieving a social security benefit model from database 120, and user profile data (e.g., salary data, retirement data) from database 120. In some embodiments, GUI computer system 114 may adjust social security based on spousal social security income. More specifically, GUI computer system 114 may retrieve the user profile of a spouse and determine if social security income should be projected based on a spousal benefit, or the combination of individual earnings-based benefits. In other words, benefits module 210 may receive a spouse profile (e.g., salary data, citizenship data, and retirement data) and determine if the 50% spousal benefit should be claimed instead of the earnings-based spousal benefit. Benefits module 210 is similarly configured to account for receiving a 100% spousal benefit upon the death of a spouse.

Benefits module 210 is further configured to project the income generated by pension plans, defined benefit plans, defined contribution plans, insurance policies, and annuities. In some embodiments, benefits module 210 receives user-input benefit data, such as start years, end years, and amounts. Additionally, benefits module 210 may retrieve income data associated with a user-input benefit from one of financial data sources 116. For example, benefits module 210 may query the provider of an employer pension plan to determine a projected pension income. Similarly, benefits module 210 may project the cash flow of insurance policies and annuities. In certain embodiments, benefits module 210 may be further configured to adjust benefit income based on projected inflation. More specifically, benefits module 210 may apply an inflation rate to a benefit value.

Planning engine 150 may also provide recommendations in order to optimize social security based on maximum present value of future social security payments. For example, planning engine 150 may recommend initiating collection of social security benefits before the balance of all accounts goes to zero. In a further example, planning engine 150 may calculate a net present value based on the social security income determinations as described above.

As illustrated in FIG. 2A and as described above, implementations of the present disclosure include one or more predictive engines (e.g., planning engines) that can be used to generate projections for parameters of a user profile. While described in the context of financial planning, implementations of this disclosure may be adapted for other applications. More generally, the projections can be generated based on a first set of parameter values corresponding to the current values for the parameters of the user profile. The predictive engine may also receive one or more modified values for one or more parameters of the user profile. The predictive engine can generate modified projections in response to the modified values.

FIG. 2A illustrates planning engine 150 as including advisory rules engine 202 and various modules. As noted above, advisory rules engine 202 executes and schedules various optimization modules based on user profile data and account data retrieved from GUI computer system 114 to produce projections for a user. In the context of financial planning, the modules executed and scheduled by advisory rules engine 202 included those related to various aspects of financial planning including investment returns, investment income, contributions, replacement income, distributions, and benefits. More generally, the modules of planning engine 150 are each adapted to generate a respective portion of the overall projection generated by planning engine 150. Accordingly, in other, non-financial applications of the present disclosure, modules of planning engine 150 may differ from those illustrated in FIG. 2A. By way of non-limiting example, when implemented in a health and fitness application, planning engine 150 may be adapted to generate a predicted weight of a user over time. In such an application, the modules of planning engine 150 may include modules related to diet, exercise, sleep, genetics, and other similar factors related to health and wellness. Each such module may receive relevant portions of the user profile data and other data collected by GUI computer system 114 and may include relevant models, formulas, etc. that determine a relative contribution of the factor associated with the model to the projected outcome. So, for example, advisory rules engine 202 may coordinate execution of modules related to diet, exercise, and sleep by providing relevant user profile data to each module. Each module may then provide a value indicating whether the relevant user profile data is predictive of a change in the user's weight and to what extent. Advisory rules engine 202 may consolidate the output of each module into an overall predicted outcome, e.g., the user's weight at some point in the future. By modifying the modules included in planning engine 150, the user profile and external data received by planning engine 150, and the operation of advisory rules engine 202, planning engine 150 may be readily tailored to a wide range of applications and to provide various predicted outcomes within each application.

As previously noted, implementations of this disclosure may include one or more planning engines. Each planning engine within a given implementation may be substantially static or may be reconfigurable, e.g., by providing the planning engine with different sets of initialization parameters. In either case, each planning engine within a given implementation may be callable by GUI computer system 114 by a corresponding API.

Different configurations of planning engines may provide various notable technical benefits. For example, if substantially similar calls to the planning engine are expected, an implementation of this disclosure may include multiple duplicate planning engines and a load balancer to distribute calls between the different planning engine instances. In such implementations, the multiple planning engines may be accessible through a common API that initially routes calls to the load balance for subsequent distribution to the different planning engine.

Considering the foregoing, implementations of this disclosure including multiple, duplicate planning engines provide a substantial technical advantage. More specifically, by implementing multiple planning engines, calls to the planning engines can be distributed and processed more efficiently than if all calls were routed to a single planning engine. Doing so reduces latency between planning engine calls and return of corresponding projections, improving the speed at which a user interface presenting the projections can be updated and substantially improving the overall user experience.

Supporting multiple planning engines also improves scalability of implementations of this disclosure. More specifically, as a user base increases, additional planning engines may be added to handle the increased traffic and processing necessary to provide the additional projections.

In another example, an implementation of this disclosure may include multiple planning engines, each of which may have a different configuration. In one example, the system may include a first planning engine configured for processing requests related to a first geographic location (e.g., the United States) and a second planning engine configured for processing requests related to a second geographic location (e.g., Canada). In the context of financial planning, for example, different geographic locations may have different account types, investment opportunities, investment and withdrawal rules, etc. As another example, a first planning engine may be dedicated to processing calls for a first service level while a second planning engine may be dedicated to processing calls for a second, enhanced service level. In some implementations, second planning engine may be configured to perform a more sophisticated projection with additional or more complex inputs and outputs. As another example, the second planning engine may be substantially similar to the first planning engine but reserved for enhanced service level users to ensure faster processing times.

Similar to the foregoing example of multiple, duplicate planning engines, implementations including multiple but varying planning engines can provide improved processing times and scalability given the use of multiple, independently accessible planning engines. Supporting varying planning engines also improves modularity and scalability by enabling the addition of new planning engines as new system requirements arise. Referring back to the localization issue, for example, new planning engines may be added to the system in response expansion of a service into new geographic locations without substantially reworking or modifying other aspects of the system. Similarly, as new service levels or analyses are supported, corresponding planning engines may be added to the system.

In implementations including multiple, disparate planning engines, GUI computer system 114 may be configured to access/call the appropriate planning engine, e.g., through a corresponding API. Alternatively, GUI computer system 114 may make a single call that is then routed to the appropriate planning engine. In certain implementations, routing the call may include accessing user information (e.g., user service level data) and routing the call based on the retrieved user information. Alternatively, the call may contain a parameter or data indicating to which planning engine the call is to be routed.

As previously noted, certain implementations of this disclosure may include a single, reconfigurable planning engine. For example, the planning engine may be reconfigurable using different sets of initialization parameters. In some implementations, the initialization parameters may be provided to the planning engine when the planning engine is called. Alternatively, the planning engine may receive a configuration identifier when called (e.g., as part of an API call) and may retrieve corresponding initialization parameters from a data source. In still other implementations, the planning engine may access or be provided with a set of initialization parameters based on user profile data. For example, when called, the planning engine may retrieve user profile data and determine that a user is in a certain geographic area or is enrolled at a certain service level. The planning engine may then retrieve or be provided with a set of initialization parameters based on the geographic location or service level, respectively.

Implementing a single, reconfigurable planning engine provides certain technical benefits as compared to systems with conventional, static engines. Among other things, a reconfigurable planning engine is highly flexible and capable of generating projections for a wide range of users and scenarios. Also, while there may be some overhead associated with reconfiguring the planning engine, a reconfigurable planning engine generally eliminates the need for executing multiple instances of planning engines, each of which may require a respective computing system. Stated differently, a reconfigurable planning engine can facilitate efficient usage of computing resources, particularly when reconfiguration of the planning engine is infrequent or relatively nominal.

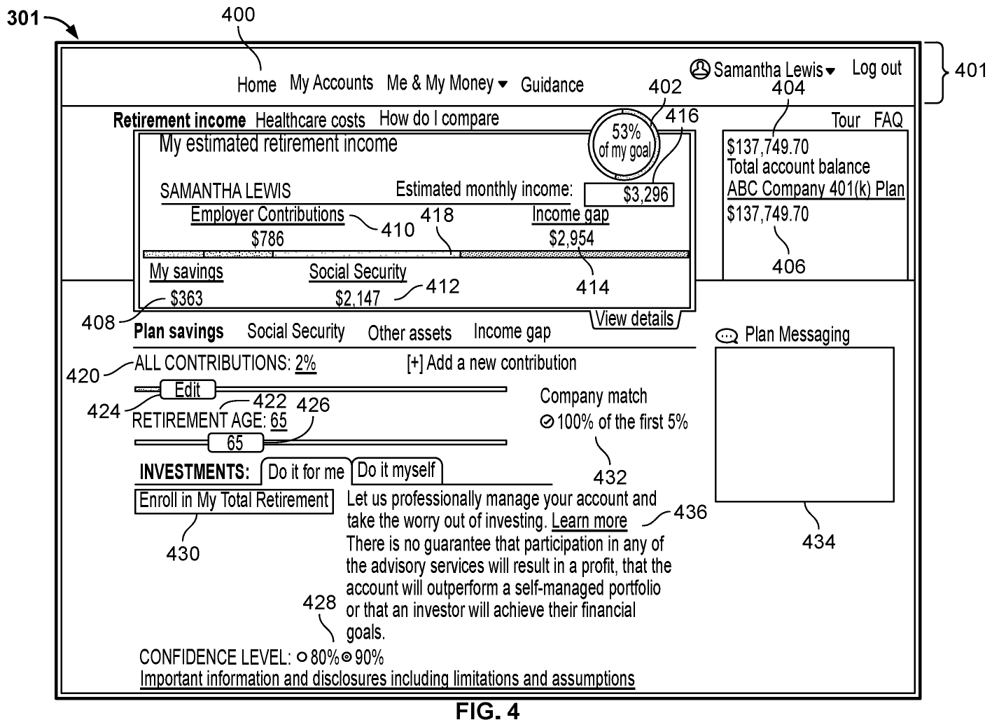

Returning to this disclosure's primary example of a financial planning application, FIG. 3 illustrates an interface outline 300 for a graphical user interface (GUI) 301 implemented by GUI computer system 114 for a financial planning system driven by the at least one planning engine 150. GUI 301, such as a web interface, is configured to interface with planning engine 150 to receive and present financial data to a user. In some embodiments, each planning engine 150 provides an API, through which GUI 301 may send profile data retrieved from database 120 for a user and receive financial data and projections from the respective planning engine 150. In the illustrated example, GUI computer system 114 is configured to generate GUI 301, as a series of a webpages, wherein the webpages contain instructions to capture financial data, store the financial data in database 120, and transmit financial data as needed to planning engine 150. A brief description of each page will be provided with respect to FIG. 3, and additional detail about certain pages will be described with respect to later figures.

In the illustrated example, for at least some of the data entry/edit fields of GUI 301 discussed herein, GUI computer system 114 is configured to validate the information entered by a services representative or participant. For example, the data entry/edit fields are configured to check user entries against minimum/maximum amounts or unaccepted characters. If information entered in the fields fails validation, GUI 301 is configured to display a red visual text to notify the services representative or participant that the information entered has failed validation, and thus the information must be corrected in order to enable GUI computer system 114 to store the information.

In the illustrated example, GUI computer system 114 receives a request from a user computer device, such as user computing device 112. GUI computer system 114 is configured to cause to be displayed disclosure page 302 to the user computing device 112. Disclosure page 302 displays disclaimer information and allows the user to continue to an introductory page 304.

Introductory page 304 is configured as an introductory page that displays basic data about the user's retirement accounts. Introductory page 304 allows the user to select an option to learn more about the levels of service available from the financial planning system associated with GUI computer system 114. Introductory page 304 also allows the user to select an option to enroll for enhanced services in the financial planning program. In one embodiment, the user selects the option to learn more about the financial planning system, and GUI 301 causes to be displayed an “about” page 308. In another embodiment, the user selects the option to enroll in the enhanced services, and GUI computer system 114 causes to be displayed a registration page 310.

About page 308 displays information about the financial planning system and also allows the user to access registration page 310.

Registration page 310 allows the user to register for the enhanced services. Registration page 310 captures demographic and salary data from the user and displays a summary of fees for utilizing the enhanced services. Registration page 310 also allows the user to agree to enroll in the enhanced services, in which case GUI 301 causes a registration confirmation page 312 to be displayed on the user computing device 112.

Registration confirmation page 312 displays a notice to the user confirming the success of registering for the enhanced services, as well as a current list of allocations associated with the user. Registration confirmation page 312 also allows the user to access the retirement dashboard, in which case planning engine 150 causes to be displayed dashboard page 314. Further, after the user agrees to enroll in the enhanced services through registration page 110, a request to return to the home page will cause to be displayed home page 334. Home page 334 displays financial goals and projections associated with the user, based on user profile data and account data received from the user.

Home page 334 is configured to display a homepage associated with the user. The homepage displays financial goals and projections associated with the user, based on user profile data and account data received from the user. Home page 334 maintains an appearance and feel similar to introductory page 304. For example, Home page 334 and introductory page 304 each include financial projections generated by the projection and optimization modules 152 of the at least one planning engine 150 based on a first set of data fields in the user profile data. For example, Home page 334 and introductory page 304 each display a graphic which represents that percentage of a savings goal that a user has achieved. Further, Home page 334 and introductory page 304 each allow the user to select the aforementioned graphic, which causes to be displayed a goals quick view page 336. Goals quick view page 336 displays more detailed information about a user's retirement goals and allows the user to update certain pieces of information. This functionality is available to both users who receive the first, basic level of functionality of GUI 301 and the at least one planning engine 150, and users who have enrolled in the second, enhanced level of functionality of GUI 301 and the at least one planning engine 150.

Home page 334 has some differences from introductory page 304, relating to enhanced services. For example, Home page 334 allows the user to select a link to the “dashboard”, which causes to be displayed Dashboard page 314. As used herein, the term “link” may be used to refer to a hyperlink, a button, or other such virtual component that allows a user to interact with GUI 301 to access (e.g., “link to”) additional or different content. Moreover, in some embodiments, Home page 334 allows the user to add information to database 120 regarding members of the user's household, which functionality is not available from introductory page 304.

Dashboard page 314 allows the user to navigate among a plurality of modules associated with the enhanced services that allow a user to manage different aspects of the user's financial planning. Dashboard page 314 allows the user to select at least one of an about me page 316, an investments page 326, an income planning page 328, a savings page 330, an opportunities page 332, an un-enroll page 335, an activity summary page 337, and a my goal page 338. In response to receiving a selection of a given page, GUI 301 causes to be displayed the corresponding page on the user computing device 112. These pages enable the user to input or edit different aspects of user profile data, corresponding to values in respective database fields of the user profile in database 120, subject to constraints and validations applied by GUI computer system 114.

About me page 316 allows the user to access a my family page 318, an assets page 320, an income in retirement page 322, and a savings goals page 324. A user selection of a given page causes GUI 301 to cause to be displayed the corresponding page to the user computing device 112.

My family page 318 generally captures personal user profile data (e.g., demographic data, spouse and dependents data, and salary data) from the user. In some embodiments, my family page 318 directs the user through a number of data input pages which are configured to request and capture user profile data from the user. When a user completes the data entry requests, my family page 318 automatically directs the user to assets page 320. Assets page 320 captures asset data (e.g., asset identifiers and asset compositions) for outside accounts and other long-term assets from the user and allows the user to access income in retirement page 322.

Income in retirement page 322 allows the user to input data about sources of income the user expects to receive in retirement. Income in retirement page 322 captures data (e.g., income data and benefit data) from the user and allows the user to select which member of the family is associated with the captured data. When a user completes the data entry requests, income in retirement page 322 directs the user to savings goals page 324.

Savings goals page 324 allows the user to input data about the user's savings goals. For example, the user may input data regarding a child's wedding that the user expects to have to pay for during retirement. Savings goals page 324 captures user profile data (e.g., financial needs to be met in retirement, apart from the steady state) from the user and allows the user to select which member of the family is associated with the captured data. When a user completes the data entry requests, savings goals page 324 directs the user back to about me page 316.

Investments page 326 displays an overview of financial projections associated with a user's portfolio, wherein the financial projections are based on user profile data. Investments page 326 also allows the user to select between a plurality of data displays. For example, investments page 326 allows the user to select at least one of an equities/bonds display, an asset class display, and a funds display. Investments page 326 also captures user account preferences (e.g., risk preference data).

Income planning page 328 displays information related to a user's draw from the financial account, and from outside accounts and other benefits, during retirement. For example, income planning page 328 displays a graphical projection of whether the user will achieve financial goals based on user profile data and account data. Income planning page 328 is configured to display an alert if an output from planning engine 150 indicates that the user is projected to fall short of financial goals. Income planning page 328 also allows the user to model alternative plans by entering alternative user profile data, such as modified financial goals and retirement dates.

Savings page 330 allows the user to view different contribution rate amounts and types and select between the contribution rate amounts and types. Savings page 330 displays a recommended contribution rate based on user profile data and account data and captures contribution data based on a user selection of a given contribution rate.

Opportunities page 332 allows the user to respond to recommendations generated by system 100. Un-enroll page 335 allows a registered user to un-register from the enhanced services, for example to revert to basic services. Activity summary page 337 allows the user to review recent transactions.

My goal page 338 allows the user to set retirement goals. My goal page 338 captures user profile data such as financial goal data and desired retirement age. My goal page 338 also displays a household income goal based on the financial goal data for different members of a household.

The example GUI illustrated in FIG. 3 is intended as a non-limiting example and can be readily adapted to other applications. For example, certain elements, such as my family page 318, about me page 316, dashboard page 314, my goal page 338, and other pages of GUI 301 may be included in a wide range of systems (e.g., systems for planning health and wellness goals), albeit modified to match the corresponding application. While other pages, such as assets page 320, retirement page 322, and savings goals page 324, may be relatively specific to financial planning applications, GUIs for other applications may include analogous pages. For example, in the context of a health and fitness application, GUI 301 may include pages for a user's diet, exercise, and sleep.

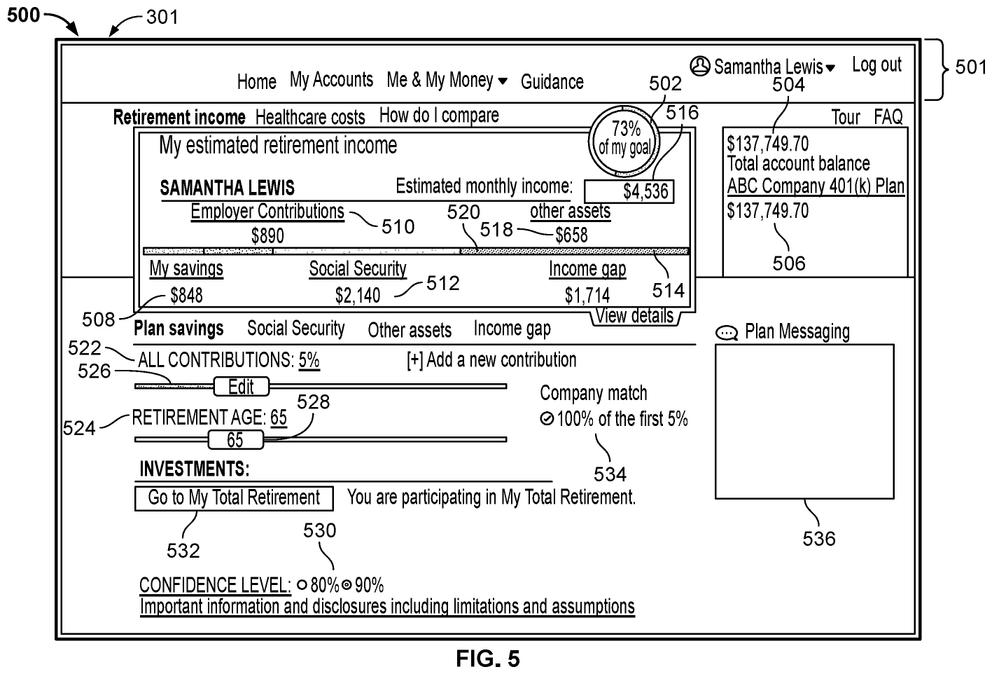

FIGS. 4-58 illustrate various pages, functions, and aspects of an example GUI according to an implementation of this disclosure. The GUI is primarily directed to a financial planning platform/application. As noted throughout this disclosure, financial planning is one potential application for the concepts disclosed herein and is described in detail, but aspects of this disclosure are more generally applicable and can be readily modified to other applications and contexts. More generally, aspects of this disclosure are directed to facilitating platforms for planning user goals, regardless of the specific nature of the goal. So, while the following implementation focuses on financial planning (e.g., retirement planning), the principles, concepts, user interface functionality, etc. described can be adapted for other contexts such as, but not limited to, health and wellness and education/skill development.

With the foregoing in mind, FIG. 4 depicts an example introductory page 400, such as introductory page 304 of GUI 301, which is generated and transmitted by planning engine 150. In the illustrated example, introductory page 400 is shown as displayed for a base-level user. Introductory page 400 provides a top-level menu 401 that appears in a substantially identical format and a substantially identical location for both base-level and enhanced-level users. Introductory page 400 is configured to display basic information associated with the user's account, such as the user's financial goals, progress toward the financial goals, a total account balance, or high-level user preferences. In some embodiments, the user information on introductory page 400 is obtained from the employer, as one of financial data sources 116, based on information provided by the employee when the user was hired as an employee and/or when the user becomes eligible for participation in the 401(k) plan associated with the financial account. For example, the data may be obtained from a recordkeeper of the 401(k) plan. Introductory page 400 also allows the user to change certain user preferences and/or update data in a first set of data fields of the user's profile in database 120, obtain more information about the levels of service available for the financial account, and register for an enhanced service level provided by the financial planning system. GUI computer system 114 is configured to receive a log-in request from the user and based on the log-in request, cause to be displayed introductory page 400 to a user computing device 112.

Introductory page 400 is configured to transmit values from the user profile for the first set of data fields to planning engine 150, and to display financial projections generated by planning engine 150 using the user's values from the first set of data fields. In some embodiments, introductory page 400 is configured to call a single planning engine 150 for basic financial projections, regardless of whether the user is registered for basic services or enhanced services. This facilitates protecting a user who is newly registered for enhanced services from seeing significant numerical changes or formatting changes upon logging in, thereby increasing an initial user satisfaction with the enhanced services and increasing an adoption and retention rate for the enhanced services. For example, in some embodiments, the planning engine 150 includes multiple planning engines each supporting a different level of services for the financial account, and introductory page 400 is configured to call a first planning engine 150 for basic financial projections, regardless of whether the user is registered for basic services or enhanced services. Alternatively, the at least one planning engine 150 is a single planning engine 150.

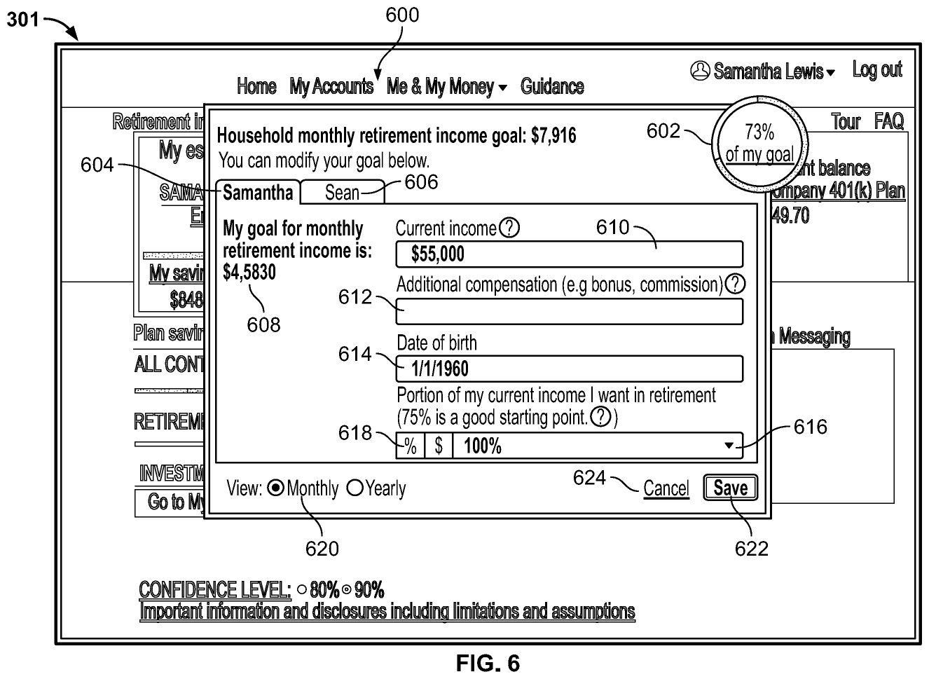

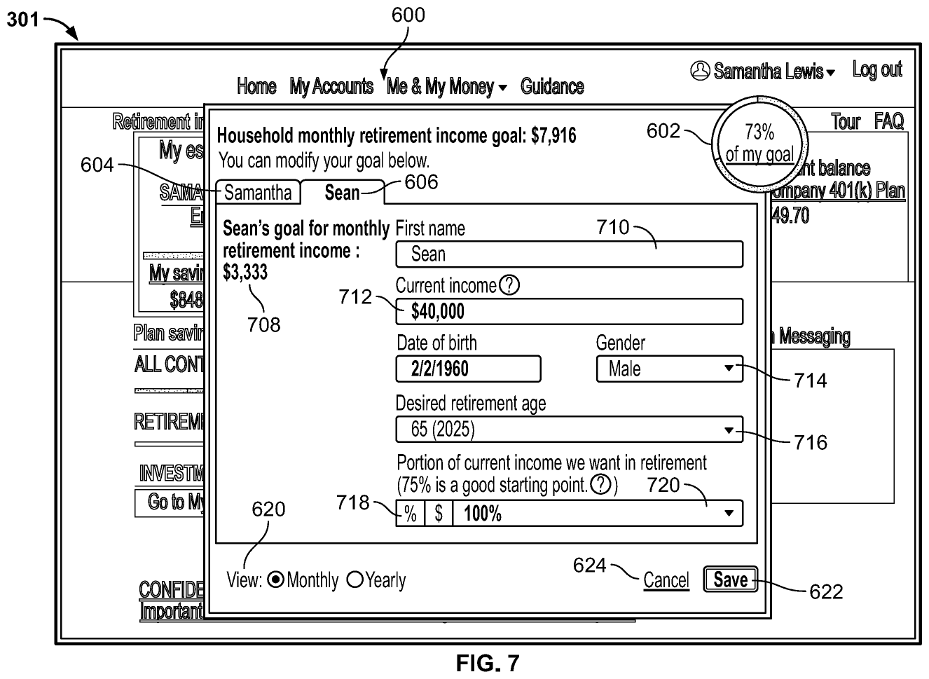

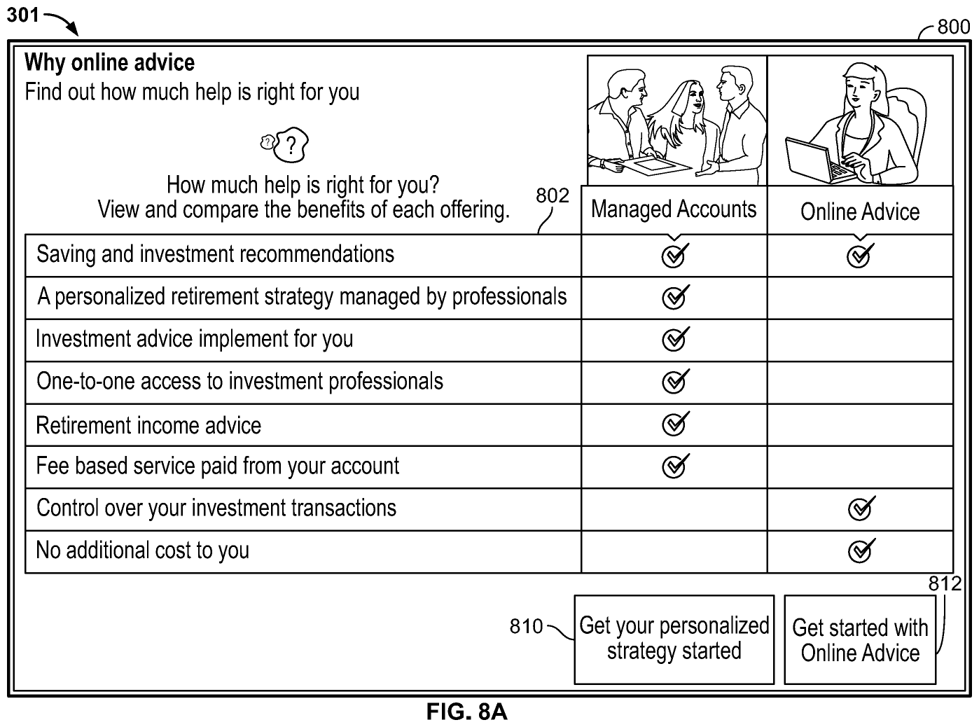

Introductory page 400 is configured to display total account balance 404 and benefits plan 406 for the user's financial account. Introductory page 400 is also configured to display goal summary 402 and estimated income 416 to both base-level and enhanced-level users based on financial projections generated by planning engine 150. Specifically, planning engine 150 generates estimated income 416 based on user profile data and account data and generates goal summary (or “comparison”) 402 based on a comparison of estimated income 416 to a user goal for retirement, as derived from database 120 from user profile data (e.g., an estimated monthly income goal, an estimated retirement goal). The goal summary 402 is configured to appear in substantially identical format and substantially identical location on introductory page 400 for both base-level and enhanced-level users, as shown in FIG. 5. Goal summary 402 is also configured to capture user input requesting access to edit fields in the user profile stored in database 120. Specifically, goal summary 402 is configured to transmit a user request to GUI 301, which causes to be displayed a goals configuration display such as goals configuration display 600 (shown in FIG. 6) and goals configuration display 700 (shown in FIG. 7).

Planning engine 150 is further configured to generate income components 408, 410, and 412 based on user profile data and account data. In the illustrated example, income component 408 represents income generated from a savings account, a component of investment income which is calculated by investment income module 206 (shown in FIG. 2A). Income components 410 and 412 represent employer contributions and social security benefits respectively, both of which are components of a benefits plan value, which is calculated by benefits module 210 (shown in FIG. 2A). In an alternative embodiment, income component 410, which represents employer contributions, is a component of investment income which is calculated by investment income module 206. Planning engine 150 is further configured to determine income gap 414 based on a comparison of estimated income 416 to user-input financial goals (e.g., an estimate monthly income goal). Using projections returned from planning engine 150, GUI 301 is configured to display income tracking bar 418, which is a visual representation of income components 408, 410, and 412 and income gap 414 using different colors on a single bar. Introductory page 400 is also configured to capture a user's preferred confidence level 428 for the projections. In the illustrated example, the user selects from two pre-determined values, and the selected value is transmitted to planning engine 150. Planning engine 150 uses confidence level 428 as an input for generating financial projections such as estimated income 416 and income components 408, 410, and 412.

Introductory page 400 is further configured to capture user profile data and account data through interactive sliders 424 and 426 and store the captured data to database 120. In an alternative embodiment, introductory page 400 is configured to capture data using any suitable graphical control and/or to display any number of interactive sliders. In the illustrated example, interactive sliders 424 and 426 allow the user to input contribution data and retirement age data respectively. In alternative embodiments, interactive sliders 424 and 426 capture other types of user profile data and/or account data. In some embodiments, interactive sliders 424 and 426 are configured to “snap” to certain intermediated pre-determined values which are generated by GUI 301. In some embodiments, introductory page 400 displays recommended values and/or starting points for interactive sliders 424 and 426.

Introductory page 400 is further configured to display current slider values 420 and 422, which are configured to display numeric values related to the data captured by interactive sliders 424 and 426 respectively. In some embodiments, slider values 420 and 422 display the numeric value selected by interactive sliders 424 and 426 respectively. In other embodiments, slider values 420 and 422 display a value generated by planning engine 150 based on at least the input captured from interactive sliders 424 and 426. Introductory page 400 is further configured to display company match tracker 432, which is generated by GUI 301 based on account data such as benefits data and contribution data.

Sliders 424 and 426 are examples of interactive controls within GUI 301 that can be manipulated by the user to modify values and settings for the user maintained in the user's profile data and/or account data. More generally, GUI 301 may include any type of interactive control by which the user can provide input to GUI 301. By way of non-limiting example, other interactive controls that may be displayed by GUI 301 for the user to provide input for manipulating his or her profile data and/or account data include buttons, checkboxes, radio buttons, calendar/date/time pickers, text boxes, toggle switches, drop-down lists, combo boxes, list builders, sliders, scroll bars, spinners, a “hamburger” or triple bar button, and the like. Similar to slider values 420 and 422, GUI 301 may include displays of values manipulable by the interactive controls.

In response to a change made by the user through an interactive control of GUI 301, GUI 301 may transmit an update to a server system (e.g., server computing device 114 of FIG. 1) or similar backend system for updating a database storing the user's profile and/or account data (e.g., database 120 of FIG. 1). Prior to transmitting the update to the backend system, GUI 301 may also prompt the user for confirmation of the change and only transmit the update when the user responds affirmatively.

Communication between GUI 301 and the backend system may be achieved through a corresponding API. So, for example, the user may activate an interactive control to change a value stored in the user's profile or account data (e.g., a contribution rate). In response, the GUI 301 may transmit a change or update message through an API to the backend system. Following receipt of the update, the backend system may execute the update (e.g., by updating the corresponding value stored in database 120). The backend system may subsequently transmit a confirmation or response message for presentation at GUI 301. Messages sent by the backend system may similarly be sent through the API.

Among other things, implementing an API between the backend system and user computing device executing GUI 301 facilitates improved communication and interoperability between different platforms, operating systems, etc. For example, by implementing an API to communicate with the backend system to update user profile and account data, the backend system can be made to readily interface with user computing devices regardless of the type of device, operating system executed on the device, and the type of application used to access GUI 301 (e.g., regardless of whether GUI 301 corresponds to a standalone application or a web-based portal/platform).

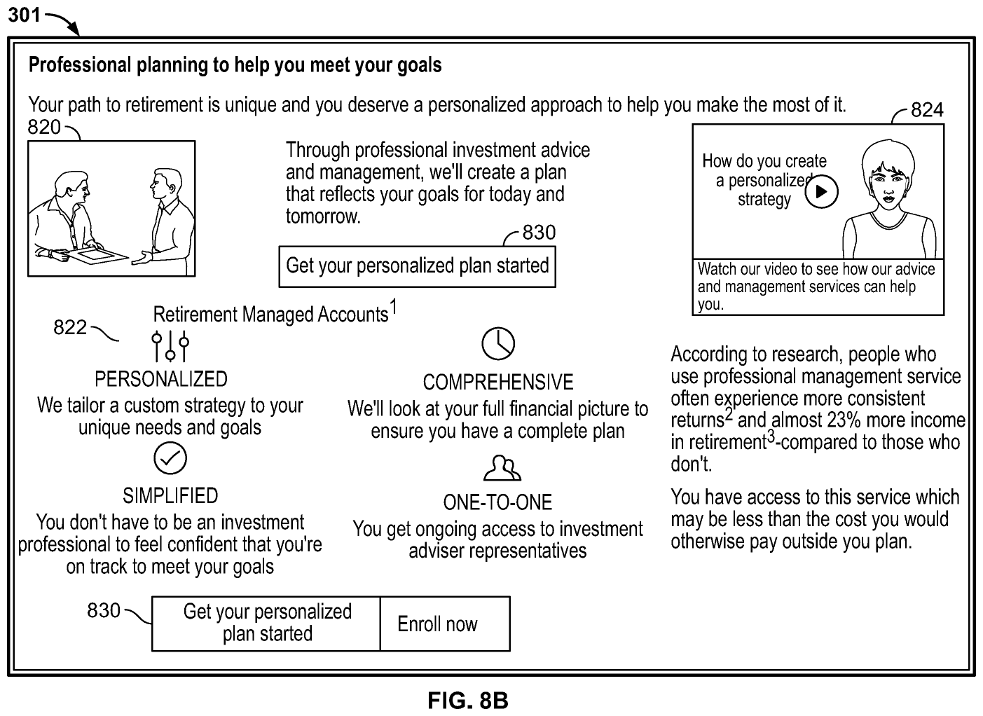

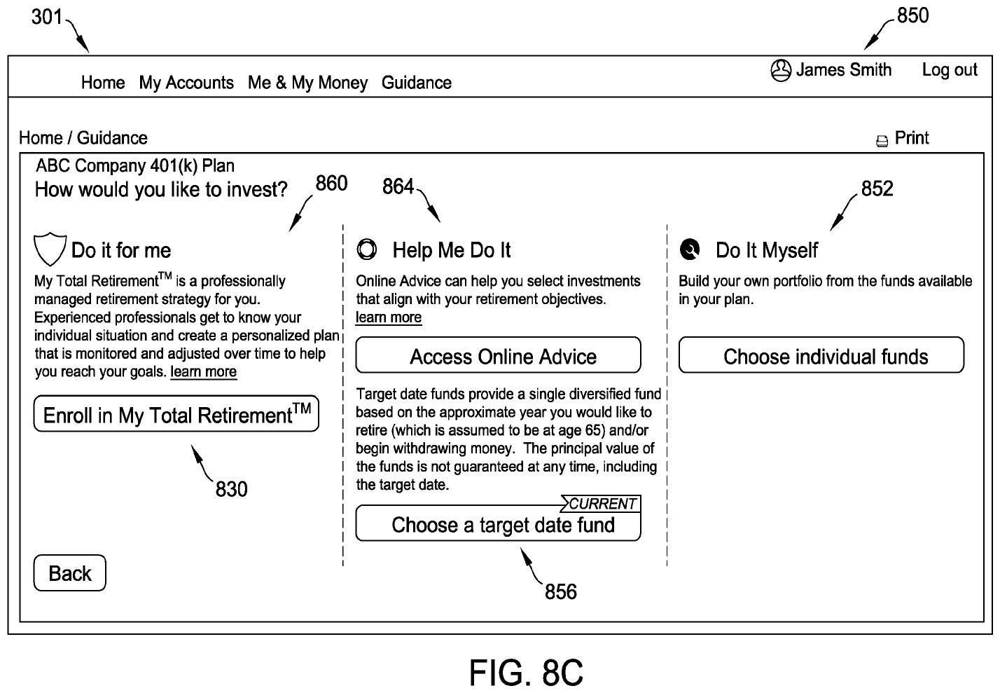

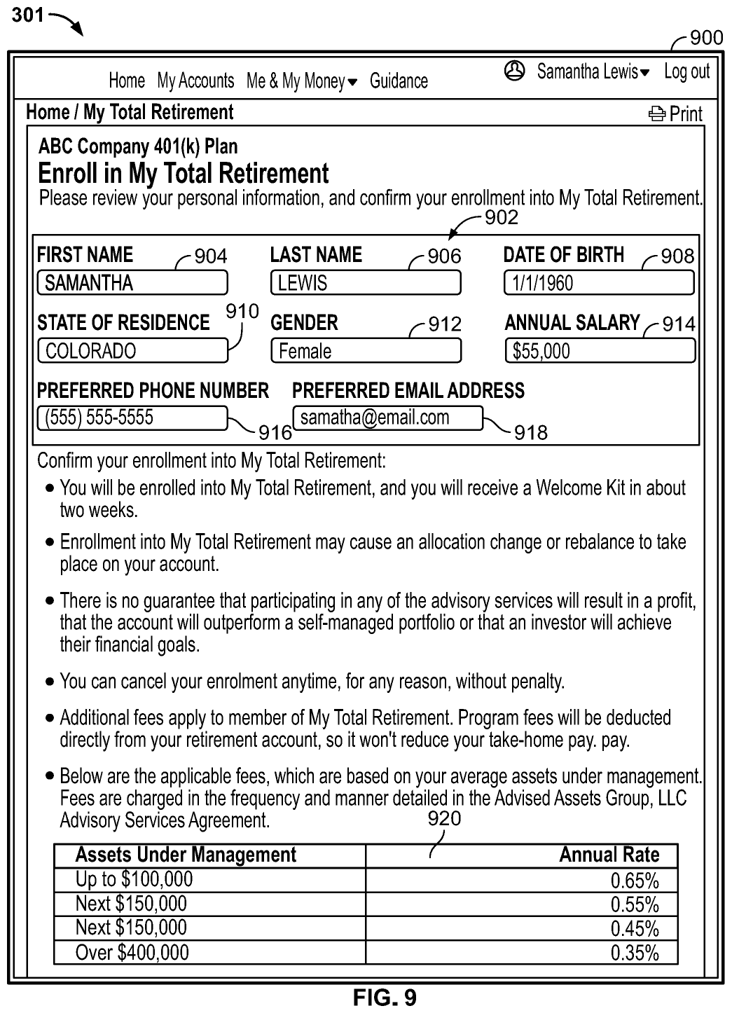

Introductory page 400 is configured to receive user input requesting more information about the financial planning system through a “learn more” link 436. Learn more link 436 causes to be displayed an informational page such as informational page 800 (shown in FIG. 8A) or about page 308 (shown in FIG. 3).

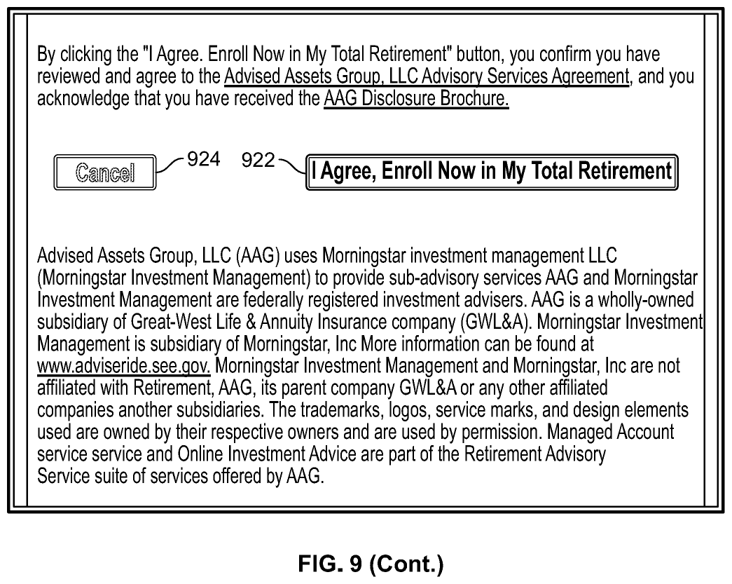

If the user is a base-level user, introductory page 400 is configured to receive user input requesting enrollment in enhanced services by displaying an enrollment request 430 to the base-level user. Enrollment request 430 may be similar to “Do It For Me” link 830 (shown in FIG. 8C). Enrollment request 430, when activated by the base-level user, also causes to be displayed an enrollment page such as registration page 900 (shown in FIG. 9) or registration page 310 (shown in FIG. 3). If the user is already an enhanced-level user, the introductory page is configured to provide a “Go to My Total Retirement” link (or “dashboard request”) 532 (as shown and described with respect to FIG. 5 below). Dashboard request 532 appears in a dashboard-link location substantially identical to the location of enrollment request 430 for base-level users.

FIG. 5 depicts an example homepage 500, such as Home page 334, which is caused to be displayed as the introductory page by GUI 301 for a user enrolled in the enhanced level service (e.g., after becoming an enhanced-level user). In other words, Homepage 500 is introductory page 400 as it appears to a user 102 who is enrolled for enhanced services. Homepage 500 is configured to provide a substantially similar look and experience to the user as introductory page 400. For example, Homepage 500 includes top-level menu 501 identical to top-level menu 401. In other words, the overall layout of homepage 500 is recognizable and/or familiar to user 102, based on introductory page 400 as it appeared to the user prior to enrollment for enhanced services.

Just as in introductory page 400 in FIG. 4, Homepage 500 is configured to display a total account balance 504 and a benefits plan 506 for the user's financial account, as well as goal summary 502 including the identical comparison of estimated income 516 to the user goal for retirement as in goal summary 402. Goal summary 502 is likewise configured to capture user input, such as a user clicking or otherwise selecting goal summary 502, to provide access to configure inputs used by planning engine 150 in generating financial projections by causing to be displayed a goals configuration display such as goals configuration display 600 (shown in FIG. 6) and goals configuration display 700 (shown in FIG. 7).

GUI 301 is again configured to generate income components 508, 510, and 512 based on user profile data and account data, identical to income components 408, 410, 412, and an other-assets component 518 based on other assets entered into database 120 by the user (not shown in FIG. 4). Planning engine 150 is again configured to determine income gap 514 based on a comparison of estimated income 516 to user-input financial goals (e.g., an estimated monthly income goal), and GUI 301 is again configured to cause to be displayed an income tracking bar 520, which is a visual representation of income components 508, 510, 512, and 518 and income gap 514 using different colors on a single bar. Homepage 500 is also configured to capture a user's preferred confidence level 530 for financial prediction. In the illustrated example, the user selects from two pre-determined values, and the selected value is transmitted to planning engine 150. Planning engine 150 uses confidence level 530 as an input for generating financial projections, such as estimated income 516 and income components 508, 510, 512, and 518.

Homepage 500 is likewise configured to capture user profile data and account data through interactive sliders 526 and 528, and to display current slider values 522 and 524 and company match tracker 534, identical to those displays as shown in FIG. 4.

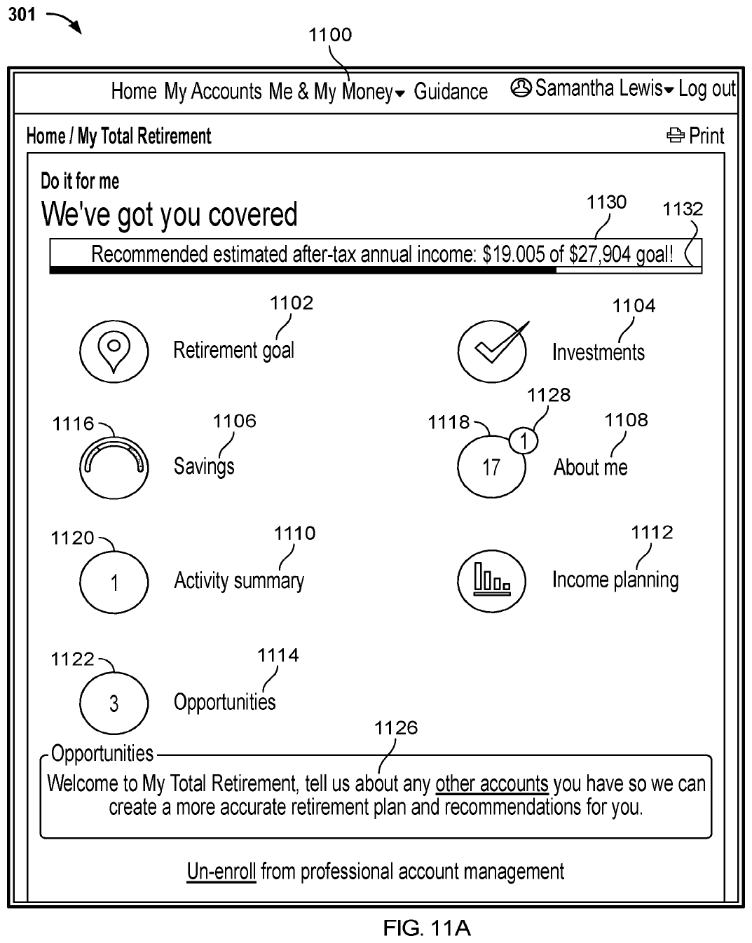

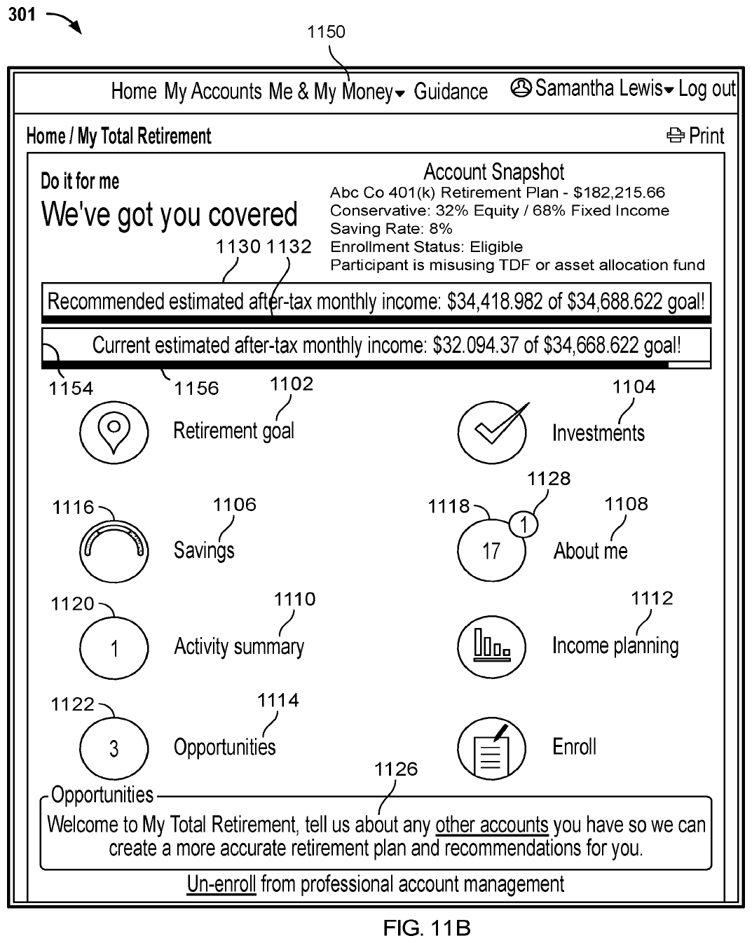

As noted above, in contrast to introductory page 400 as it appears to base-level users, Homepage 500 is configured to receive user input for enhanced-level users, i.e., participants who have enrolled for enhanced services, and are requesting access to a dashboard through dashboard request 532, or representatives of the enhanced services provider, who may request access to the dashboard through a service representative's separate application in order to assist a participant enrolled in basic or enhanced services. The dashboard request causes to be displayed a dashboard, such as dashboard 1100 (shown in FIG. 11A), dashboard 1150 (shown in FIG. 11B), or dashboard services as described below. In the example embodiment, dashboard request 532 is displayed on homepage 500 in a substantially identical location as enrollment request 430 appears on introductory page 400. Thus, the option to register for base-level users through enrollment request 430 is effectively replaced by the dashboard request 532 on a similar page once the user becomes an enhanced-level user. For example, newly registered users have a familiar starting point from which to move forward to the changes and benefits of registration in an otherwise familiar environment within GUI 301. In addition, GUI 301 enables services representatives to obtain information about a basic-level services participant in a phone call or on-line chat with the participant, enter the information into the participant's profile, and make account recommendations to the basic-level user based on the enhanced services functionality of the planning engine 150. For enhanced-level participants, dashboard 1150 enables a services representative to see the same underlying pages, including the same account data and financial projections, that the participant sees when working through dashboard 1100. Moreover, dashboard 1150 provides additional information that the services representative may find useful in answering questions or fully explaining options to the participant.

Although provided in the context of financial/retirement planning, FIGS. 4 and 5 illustrate the concept of a dynamically generated home page based on a service level of a user. More generally, in certain implementations of this disclosure, planning engine 150 may be configured to access or determine a user service level and generate or cause a home page to be displayed based on the user service level. As previously noted, in certain implementations, certain aspects of the GUI may be consistent across service levels. For example, each service level may include the same general layout and at least some data, widgets, components, etc., positioned in the same locations. Other aspects of the GUI may vary across service levels. For example, a GUI presented to an enhanced level user may include additional links, graphical elements, controls, etc., to reflect additional features and services available to the enhanced level user. In contrast, a GUI generated by planning engine 150 for a basic level user may generally include a smaller subset of GUI components or elements but may also include elements, information, controls, etc. for the user to learn more about or sign up for enhanced level services.

In at least certain implementations, the difference between the enhanced and basic level GUIs may include the user of different underlying planning engines. When a user is a basic level user, the GUI may include projections generated using a first planning engine that provides a relatively basic analysis or projection as compared to a second and more sophisticated planning engine that may be called for enhanced level users. For example, the planning engine for the basic level user may rely on fewer variables, may execute fewer simulation iterations, or may generate fewer projection metrics than the planning engine called when the user is an enhanced level user.

Alternatively, a common planning engine may be used for both basic and enhanced level users; however, the planning engine may operate differently based on the service level of the user. For example, the planning engine may determine a service level of a user and modify a set of initialization parameters for the planning engine based on the service level. In other implementations, the planning engine may be controllable based on parameters received when called. For example, an API associated with the planning engine may be called and the call may include a service level of a user as a parameter. The planning engine may then receive the service level and modify its operation based on the service level.

The foregoing principles can be readily adapted for GUIs outside of financial planning applications. In an example health and wellness application, users may be presented with a GUI that includes a summary of the user's current health but different metrics and/or different levels of detail for certain metrics may be presented to users based on their service level. For example, a basic level user may be presented with the user's current weight and calorie intake while an enhanced level user may be further provided with a more detailed dietary breakdown including macronutrients. The GUI for enhanced level users may also include controls for contacting or initiating a communication session with a trainer, nutritionist, or similar representative. In contrast, the GUI for basic level users may omit such controls or may replace such controls with those directed to signing up or registering for enhanced services.

Returning to the example financial planning GUI, FIG. 6 depicts goals configuration display 600 of GUI 301, which allows a user to change (e.g., edit) values for certain data fields in database 120, which are to be used as inputs by planning engine 150 to generate financial projections. Display 600 is caused to be displayed based on a user request received through a goal summary icon, such as goal summary 402 (shown in FIG. 4) and goal summary 502 (shown in FIG. 5). In the example embodiment, display 600 is configured as a pop-up overlay displaying over homepage 500 or introductory page 400 to display inputs used by planning engine 150 in calculating financial projections, such as income goal 608 and goal summaries 402, 502, and 602. Display 600 is further configured to capture user inputs, such as user profile data and account data (e.g., current income, additional compensation, date of birth, portion of current income desired in retirement), and store the data in database 120.

Display 600 is configured to display a goal summary 602, which is substantially similar to goal summaries 402 and 502. In some embodiments, goal summary 602 is configured to update goal summary 602 based on captured user input. Display 600 is further configured to display family member tabs 604 and 606. GUI 301 causes to be displayed family member tabs 604 and 606 that enable editing of corresponding user profile data in database 120, which also can be initiated from dashboard 1100 (shown in FIG. 11A) or dashboard 1150 (shown in FIG. 11B) for an enhanced-level user. Display 600 is configured to allow the user to switch between a display for each family member associated with family member tabs 604 or 606. Specifically, display 600 is configured to toggle between information specific to each family member in the displayed data fields based on receiving user input selecting the corresponding family member tab 604 or 606. In some embodiments, GUI 301 enables the user to toggle between more or fewer than two plurality of family member tabs, wherein the number of family members is based on user profile data.

Display 600 is configured to display income goal 608, which is generated by GUI computer system 114 based on financial goals captured from the user, who is associated with the first family member tab 604. Display 600 is further configured to capture current income data 610, additional compensation data 612, date of birth 614, retirement income amount data 616, income format data 618, and income period data 620 with respect to family member tab 604 (i.e., the user). For example, retirement income amount data 616 is expressed in a format of a percent of pre-retirement income. In the illustrated example, the current income and additional compensation data are summed and multiplied by the retirement income amount. Income goal 608 is calculated based on income period data 620 applied to the sum of current income and compensation, as modified by retirement income amount.

In some embodiments, income format data 618 captured through display 600 causes display 600 to alter the input options for income amount data 616. For example, a user may select “$” for input retirement format data 618, in which case display 600 may allow the user to input income amount data 616 as a dollar amount. In another example, a user may select “%” for income format data 618, in which case display 600 may allow the user to input income retirement amount data 616 as a percentage of current income.

Display 600 is also configured to receive a user request to save any updated inputs through a save request 622. Save request 622 causes planning display 600 to store any data input by a user in database 120. Save request 622 also causes to be displayed an updated underlying page, such as introductory page 400 (shown in FIG. 4) or homepage 500 (shown in FIG. 5). Alternatively, a cancel request 624 discards any changed and reverts to non-updated introductory page 400 or homepage 500.

FIG. 7 depicts goals configuration display 600 having second member tab 606 selected. With second family member tab 606 selected, display 600 is still configured to display goal summary 602 and update goal summary 602 based on captured user input. Display 600 is further configured to display family members tab 604 and 606 to allow the user to toggle between a display for each family member. Moreover, display 600 is configured to display income goal 708 based on financial goals captured from the user with respect to the second family member. Display 600 is further configured to capture current income data 710, additional compensation data 712, date of birth 714, retirement income amount data 716, income format data 718, and income period data 720 with respect to the second family member. In the illustrated example, the current income and additional compensation are summed and modified by the retirement income amount data 716 as described above to calculate income goal 708.

When second family member tab 606 is selected, display 700 is also still configured to receive a user request to save any updated inputs through save request 622 or discard changes via cancel request 624.

FIG. 8A depicts an example informational page 800 of GUI 301 which provides a user with a tabular comparison of services available through the financial planning system. Informational page 800 identifies various services available to enhanced-level users (e.g., under the “Managed Accounts” column) and options for online advice available through an online advice service. Informational page 800 is caused to be displayed upon reception of user input requesting more information, such as learn more link 436 (depicted in FIG. 4). In the illustrated example, informational page 800 is configured to display a comparison table 802, which identifies services available through the financial planning system, basic services available to unregistered users, and services available through both. Informational page 800 is also configured to allow the user to learn more about the enhanced services via a continue link 810, or to register for online advice via an online advice link 812.

FIG. 8B depicts an example informational sub-page 820 of GUI 301 which provides a user with more information about the financial planning system. Informational sub-page 820 is caused to be displayed upon reception of user input requesting more information, such as continue link 810.

In the illustrated example, informational sub-page 820 is configured to display a system overview 822, which describes some aspects of the financial planning system relevant to a potential consumer or user. Informational sub-page 820 is also configured to display a video overview link 824, which is configured to display a video further describing the financial planning system. Informational sub-page 820 is also configured allow the user to proceed to a registration page, such as registration page 310 (shown in FIG. 3) or registration page 900 (shown in FIG. 9) based on receiving user input through a registration link 830. In the example embodiment, registration link 830 appears in multiple locations on informational sub-page 820 to facilitate ease of registration for the enhanced services. Alternatively, informational sub-page 820 includes any suitable number of registration links.

In alternative embodiments, informational sub-page 820 is generated and transmitted by planning engine 150 as part of informational page 800, directly upon reception of user input requesting more information, such as learn more link 436 (depicted in FIG. 4), or in response to any other suitable link or request.

FIG. 8C depicts another example informational page 850 of GUI 301 which provides a user with a comparison of services available through the financial planning system. Informational page 850 is caused to be displayed by user selection of the “guidance” link in top-level menu 401/501 (shown in FIGS. 4 and 5). Informational page 850 provides guidance links that allow for base-level users to directly administer their own financial account through a “Do It Myself” link 852, allowing the user to select funds for their own plan. Informational page 850 also allows users to access online advice through a “Help Me Do It” link 864 or to choose target dated funds through link 856.

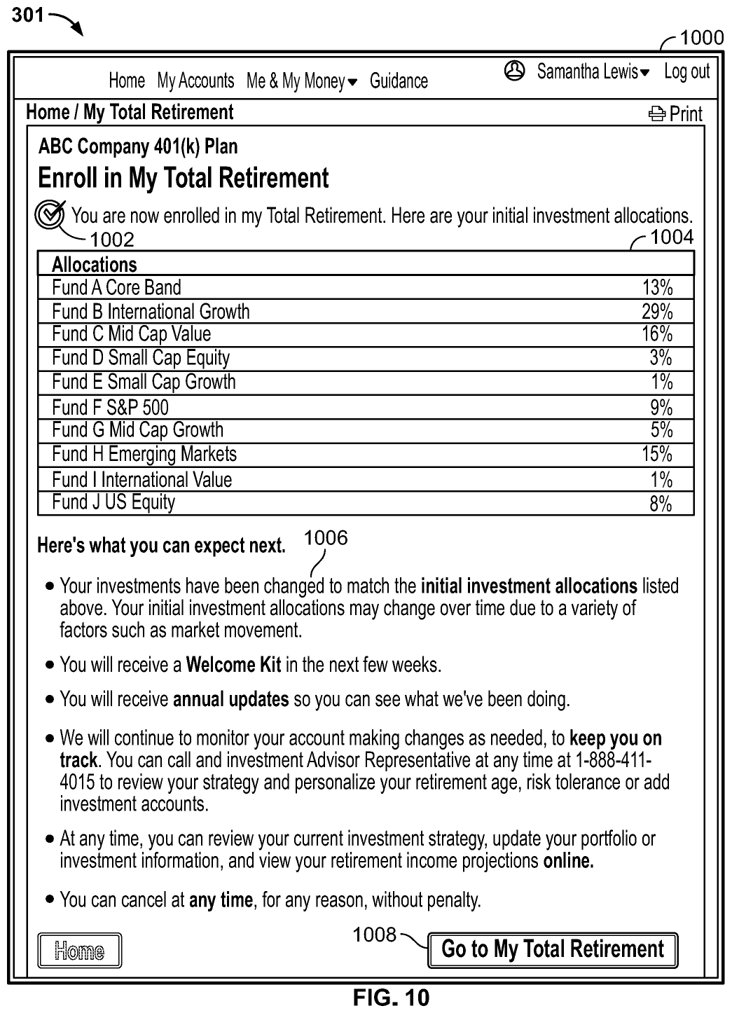

In the example embodiment, the informational page 850 also allows the base-level user to enroll in (e.g., register for) the enhanced level of services by providing an instance of registration link 830 in a “Do It For Me” section 860. The enhanced service level allows enhanced-level users access to additional plan management functionality provided by or through the at least one planning engine 150. FIGS. 9 and 10 describe aspects of user enrollment in the enhanced service level. Aspects of the enhanced service level functionality are described below with respect to FIG. 11A and the succeeding figures.

FIG. 9 depicts registration page 900 of GUI 301. Registration page 900 allows a user to register for the enhanced service level and input relevant personal and financial information. Registration page 900 is caused to be displayed upon reception of a user request to enroll in the financial planning system, such as through enrollment request 430 (shown in FIG. 4) or registration link 830 (shown in FIGS. 8B and 8C).

Registration page 900 is configured to confirm or update existing data, such as data stored in a first set of data fields in database 120 associated with the basic level of service for the user, through registration input fields 902. In the illustrated example, registration page 900 confirms demographic data such as first name 904, last name 906, birthdate 908, state of residence 910, and gender 912. Registration page 900 is further configured to confirm contact data such as phone number 916 and email address 918. Registration page 900 is also configured to confirm income data 914. Registration page 900 is configured to store any updated data in database 120.

Registration page 900 is further configured to display fee table 920. Fee table 920 is generated and transmitted by planning engine 150. In the illustrated embodiment, fee table 920 displays values for amounts of assets under management and associated annual rates for managing the amounts of assets. GUI 301 is configured to retrieve fee structure data, such as amounts of assets under management and associated annual rates, from a database such as database 120 (shown in FIG. 1).

Registration page 900 is also configured to receive an enrollment agreement request for the enhanced services through enrollment confirmation link 922. Enrollment confirmation link 922 receives a user request and causes to be displayed a registration confirmation page such as registration confirmation page 312 (shown in FIG. 3) or enrollment confirmation page 1000 (shown in FIG. 10). Alternatively, a user may select a cancel request 924 and decline to register for the enhanced services.

FIG. 10 depicts enrollment confirmation page 1000 of GUI 301. Enrollment confirmation page 1000 displays confirmation of enrollment 1002 to a user. Enrollment confirmation page 1000 is also configured to display initial asset allocations 1004.

GUI 301 is configured to call the at least one planning engine 150 to generate and transmit initial asset allocations 1004 upon receiving an enrollment agreement request, such as through enrollment confirmation link 922 (shown in FIG. 9). Initial asset allocations 1004 include asset data such as asset identifiers and asset compositions. In some embodiments, initial asset allocations 1004 are determined by return calculation module 204 (shown in FIG. 2A) based on user profile data and account data.

Enrollment confirmation page 1000 is configured to display additional information 1006, which includes more information about the enhanced services, steps for moving forward with the enhanced services, and/or any other information that may be useful to a newly registered user.

Enrollment confirmation page 1000 is also configured to allow the user to proceed to a dashboard page, such as dashboard page 314 (shown in FIG. 3), dashboard 1100 (shown in FIG. 11A), or dashboard 1150 (shown in FIG. 11B) by receiving user input through dashboard request 1008.

The various aspects of GUI 301 illustrated in FIGS. 6-10 may be readily adapted for applications other than those directed to financial/retirement planning. With respect to FIGS. 6 and 7, GUIs in accordance with this disclosure may include functionality for setting, presenting, and modifying user goals regardless of the nature of the goal itself. For example, implementations of this disclosure may include windows, forms, pages, and other similar sections that allow a user to input, review, or change goals. Each such section may include various GUI controls to facilitate input of data including, but not limited to text boxes, drop downs, sliders, and special purpose controls, such as calendar controls.

Similarly, the various options for more direct advice and support presented in FIGS. 8A and 8B may be adapted to other contexts. For example, consistent with the financial planning focus of the example implementation, FIGS. 8A and 8B include information and controls for helping a user contact a personalized financial advisor, access online advice, and enroll in customized personal account management. In a health and wellness context, similar aspects of the GUI may be directed to providing the user with information and registration/enrollment options for personalized nutritional advice, access to a personal trainer, options for developing a personal plan of action related to diet and exercise, and the like. In a skills proficiency context, the GUI may include information and controls for enrolling/registering for advanced training opportunities, webinars and courses, personalized coaching or tutoring, etc. More generally, implementations of GUIs according to this disclosure may include any suitable pages or sections directed to providing information and facilitating enrollment/registration in supplemental services or enhanced functionality.

Returning to the example financial planning implementation, FIG. 11A depicts an example dashboard 1100 of GUI 301, such as dashboard page 314, provided for enhanced-level users. Dashboard 1100 provides links to financial information for detailed retirement planning. In the example embodiment, retirement goal link 1102 and about me link 1108 allow user 102 to edit financial goal data and user profile data stored in database 120. Savings link 1106 and investments link 1104 allow user 102 to review the status of retirement account contributions and currently selected investments and edit related database fields. Activity summary link 1110 provides summaries of recent account activity. Income planning link 1112 enables the user to review and model expected income during retirement, and opportunity link 1114 provides user 102 with prioritized recommendations to incrementally improve the user's ability to meet retirement goals. For example, opportunity link 1114 allows user 102 to provide targeted additional information or make targeted changes to further optimize the account.

Savings link 1106 is, in the example embodiment, adjacent to savings indicator 1116, which visualizes a retirement goal. For example, where investment income module 164 determines that a retirement goal (or any other financial goal) will not be met, savings indicator 1116 may display as red. Activity indicator 1120 is adjacent to activity summary link 1110 and displays a total number of instances of recent user activity. Opportunity indicator 1122 is adjacent to opportunity link 1114 and displays a total number of opportunity recommendations available to user 102. About me indicator 1118 is adjacent to about me link 1108 and may display a number of alerts. For example, a total number of profile alerts may be displayed in the indicator. Additionally, a number of priority alerts may also be displayed in a contrast color, such as red. Opportunity area 1126 displays a message recommending an identified candidate modification to the user profile data in database 120, and an associated jump link to a page of GUI 301 enabling user 102 to execute the identified candidate modification.

Dashboard page 1100 also includes an estimated income widget 1130 that displays a comparison of another estimated retirement income amount generated by the at least one planning engine 150 to a user goal for retirement, as derived from database 120 from user profile data (e.g., an estimated monthly income goal). The estimated income amount included in estimated income widget 1130 differs from the estimated income included in goal summary 402 (shown in FIG. 4 and also identical to goal summaries 502, 602, 702), based on the improved projections associated with the enhanced services. For example, goal summary 402 relies on a relatively less complex projected before-tax income using only values from a first set of data fields in database 120. In contrast, estimated income widget 1130 displays a relatively more complex projected after-tax income based on values for both the first set of data fields and a second set of data fields, wherein the values for the second set of data fields from database 120 are passed to the at least one planning engine 150 solely for users enrolled in the enhanced services. In some embodiments, the at least one planning engine 150 includes a first planning engine that supports basic-level services and operates on values drawn solely from the first set of data fields, and a second planning engine 150 that supports enhanced-level services and operates on values drawn from both the first and second sets of data fields. Estimated income widget 1130 is programmed to update dynamically in response to the user 102 interacting with GUI 301 to make a change to the user profile that impacts the projected income and/or the user goal. Accordingly, for users enrolled in enhanced services, estimated income widget 1130 facilitates an immediate visualization by the user of the impact of each change implemented by the user with respect to the financial account.

In the example embodiment, estimated income widget 1130 also displays a progress indicator 1132 that indicates progress to the user goal. For example, in FIG. 11A, the user's projected retirement income is approximately two-thirds of the user goal, and progress indicator 1132 is a bar that correspondingly extends approximately two-thirds of the displayed width of estimated income widget 1130. Alternatively, if the user's projected retirement income meets or exceeds the user goal, progress indicator 1132 is a bar that fills the entire displayed width of estimated income widget 1130. Further in the example embodiment, progress indicator 1132 is a first color (e.g., green) if the user's projected retirement income meets or exceeds the user goal, and is a second color (e.g., red) if the user's projected retirement income is less than the user goal. In alternative embodiments, progress indicator 1132 is displayed in any suitable fashion.

FIG. 11B depicts an example dashboard 1150, similar to dashboard 1100 of GUI 301, as described above with respect to FIG. 11A. Dashboard 1150 provides to a services representative links to financial information for detailed retirement planning similar to the links provided by dashboard 1100. In addition to the links of dashboard 1100, dashboard 1150 provides an account snapshot widget 1152 including information of a participant, such as name of the participant, a financial account identifier, the type of retirement plan of the participant, the participant's account balance (e.g., current balance), designations of investment strategy risk (e.g., aggressive, moderate, conservative), type asset data (e.g., bond, equity, fixed income), savings rate field including a value, enrollment status of the participants' record keeper (RK) accounts, and alerts (e.g., when the participant is misusing a target date fund (TDF) or asset allocation fund, based on the participant's expected date of retirement). In some embodiments, in addition to the message displayed to the services representative on dashboard 1150, GUI computer system 114 (shown in FIG. 1) is configured to transmit messages to un-enrolled participants in response to the unenrolled participants misusing of funds (e.g., misuse of TDF/asset allocation funds or investment of 100% in a non-target fund (TF)/asset allocation fund).

Dashboard 1150 also includes a current-estimated-income widget 1154 that displays a comparison of a current estimated after tax monthly income amount after retiring generated by the at least one planning engine 150 (shown in FIG. 1) to a user goal for retirement, as derived from database 120 (shown in FIG. 1) from user profile data (e.g., an estimated monthly income goal). For example, current-estimated-income widget 1154 may include a comparison between a current estimated retirement income amount and the participant financial goal value, which may be in included in the participant goal field. GUI 301 is configured to call the at least one planning engine 150 to generate the comparison based on values included the salary field, the expected-time-of-retirement field, the participant goal field, the at least one investment composition field, and the savings-rate field. In the example embodiment, GUI 301 is also configured to update the current-estimated-income widget in response to each of (i) updating of the savings-rate field and (iii) updating of the at least one investment composition field. In the example embodiment, in response to a services representative log-in, GUI 301 is configured to display current-estimated-income widget 1154 in any page where estimated income widget 1130 is displayed to participant-users, as will be described below.

In the example embodiment, current-estimated-income widget 1154 also displays a progress indicator 1156, similar to progress indicator 1132 (shown in FIG. 11A), that indicates progress to the user goal. For example, in FIG. 11B, the user's projected retirement income is approximately two-thirds of the user goal, and progress indicator 1156 is a bar that correspondingly extends approximately two-thirds of the displayed width of current-estimated-income widget 1154. Alternatively, if the user's projected retirement income meets or exceeds the user goal, progress indicator 1156 is a bar that fills the entire displayed width of current-estimated-income widget 1154. Further in the example embodiment, progress indicator 1156 is a first color (e.g., green) if the user's projected retirement income meets or exceeds the user goal, and is a second color (e.g., red) if the user's projected retirement income is less than the user goal. In alternative embodiments, progress indicator 1156 is displayed in any suitable fashion.

In the example embodiment, account snapshot widget 1152 and current-estimated-income widget 1154 are configured to provide to a services representative a convenient brief summary of the participant's account for positioning financial services. Dashboard 1150 also includes an enroll link 1158 configured to enable the services representative to enroll a participant in the enhanced level services. Using this link, the services representative may enroll the participant on the participant's behalf. The enrollment process is similar to the enrollment process described in FIG. 4. Savings link 1106 of dashboard 1150 is configured to be disabled when a participant is unable to contribute to his or her account.

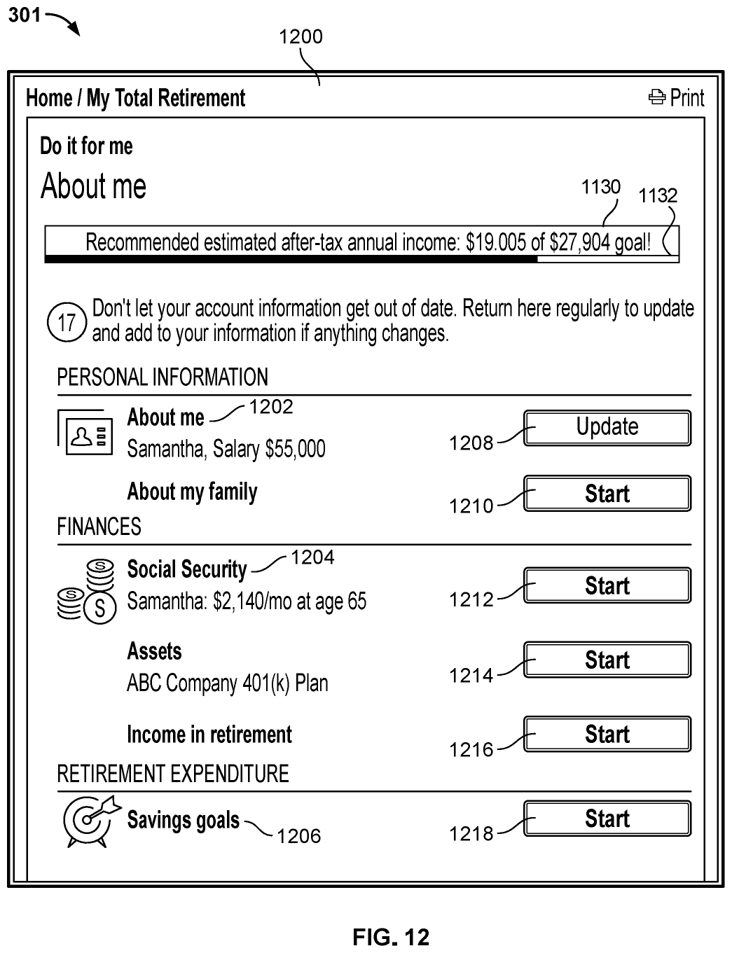

Dashboard 1100 and dashboard 1150 are each also configured to display, in an opportunity area 1126, one or more opportunities for a participant in response to GUI computer system 114 determining that at least one opportunity exists for improving a performance of the participant's account. For example, GUI computer system 114 identifies opportunities for display in opportunity area 1126 using an opportunity rules engine to analyze the user profile in database 120. In the example embodiment, opportunity area 1126 displays a message associated with a first identified opportunity, and an opportunity indicator 1122 displayed on dashboards 1100 and 1150 displays a total number of opportunities identified by GUI computer system 114. In other embodiments, opportunity indicator 1122 is not displayed on dashboard 1150. GUI 301 is further configured to generate a number of priority alerts icon 1128 (e.g., a red badge) displayed in a contrast color, such as red, for which the opportunity may be associated. Priority alerts icon 1128 may also display the number of alerts associated with each indicator. For example, priority alerts icon 1128 is displayed on dashboard 1100 or 1150 in a position overlapping a portion of an indicator, such as about me indicator 1118. Upon selecting the relevant indicator, such as the about me indicator 1118, the message displayed on opportunity area 1126 and the associated priority alerts icon 1128 will be displayed on the corresponding linked page, in this case about me page 1200 (shown in FIG. 12).

In at least certain implementations, the text and link within opportunity area 1126 is dynamically generated based on available information about the current user. The functionality of opportunity area 1126 and the general process of presenting recommendations and opportunities to users is described below in further detail. However, by way of introduction, in at least one implementation, opportunity area 1126 is populated based on a prioritized list of account modifications and, in particular, the highest prioritized account modification not currently implemented in the user's account. Among other things, text within opportunity area 1126 is dynamically updated to a description of the modification and a link within opportunity area 1126 is dynamically updated to take the user to a corresponding portion of GUI 301 for implementing the recommended modification.

FIG. 12 depicts an example about me page (or “user profile page”) 1200 of GUI 301, such as about me page 216, which may be opened using about me link 1108. About me page 1200 displays an overview of data fields including personal profile information 1202, financial information 1204, and retirement expenditures information 1206. User 102 may review about me page 1200 to update information, or determine what information still needs to be provided for null fields (i.e., those fields for which the user has yet to specify a value), to enable all projection and optimization modules 152 to execute fully and accurately, and to update specific sections of information as available. For example, user 102 may update salary data or add a dependent.

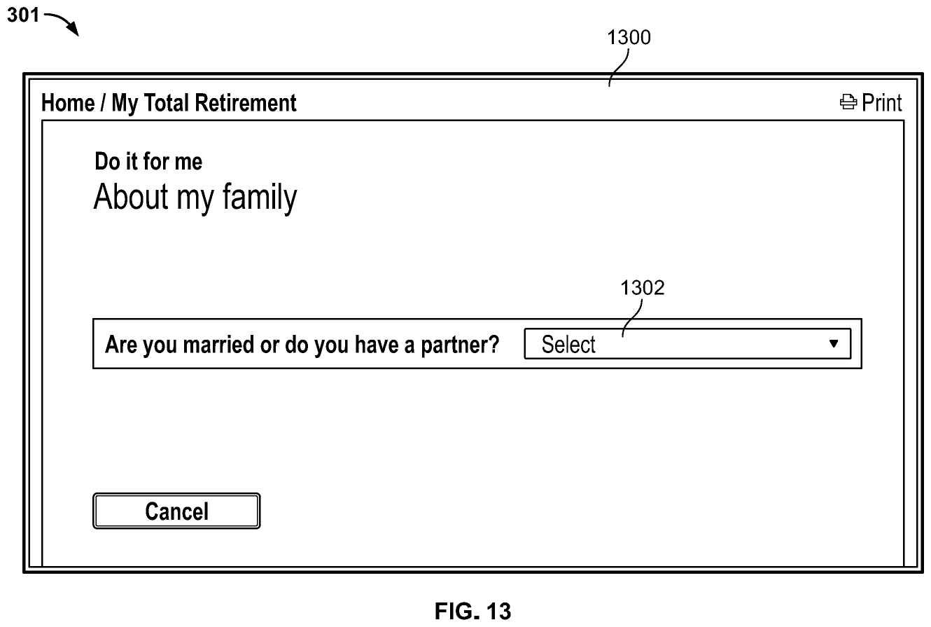

About me update link 1208 facilitates user 102 submitting salary data, demographic data (e.g., age, birthdate), and spouse information. About my family information link 1210 facilitates user 102 submitting dependent data, as shown in FIGS. 13-16, such as the names and birthdates of dependents. Profile information 1202 may summarize previously submitted user profile data, such as a name and salary.

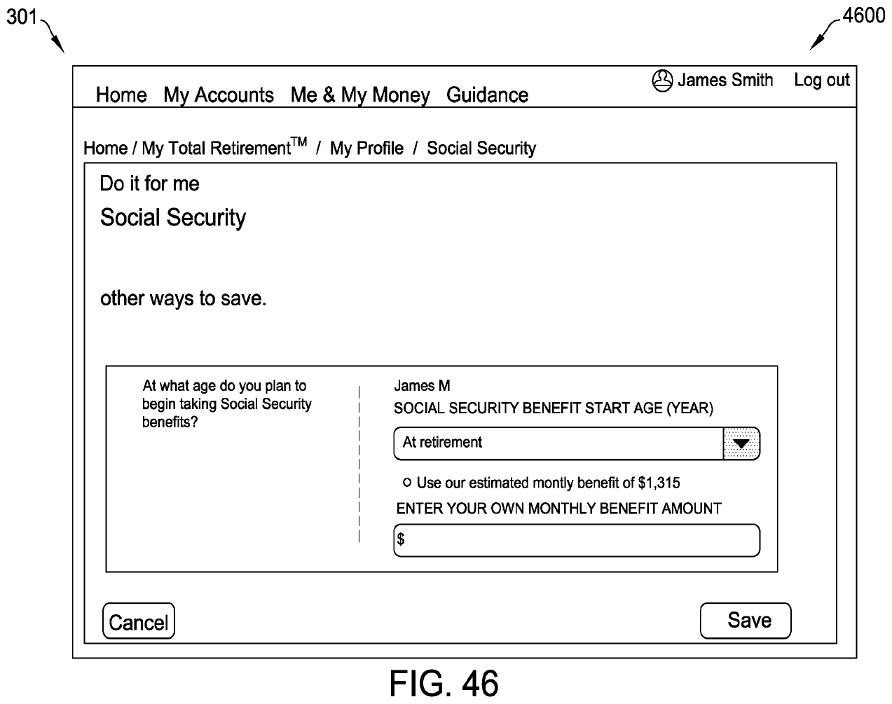

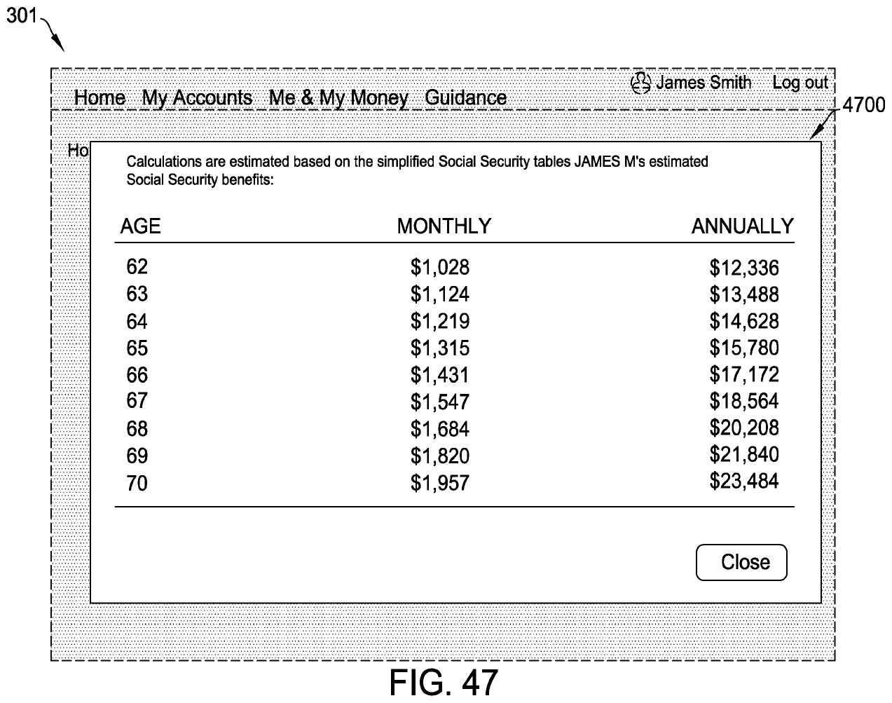

Financial information 1204 includes social security link 1212, assets link 1214, and income in retirement link 1216. Financial information 1204 may include preview data, such as estimated social security benefits and indicators of benefit plans. Social security link 1212 causes to be displayed social security page 4600 (shown in FIG. 46), which enables the user to edit a benefit start age and an expected benefit. Social security page 4600 includes a “Use our estimated monthly benefit” option, which displays a social security benefit table (shown in FIG. 47) if selected. Retirement expenditures information 1206 includes savings goals link 1218, such that user 102 may define a savings goal to meet a discrete, one-time expense expected to arise during retirement, such as a child's wedding or a particular vacation plan.

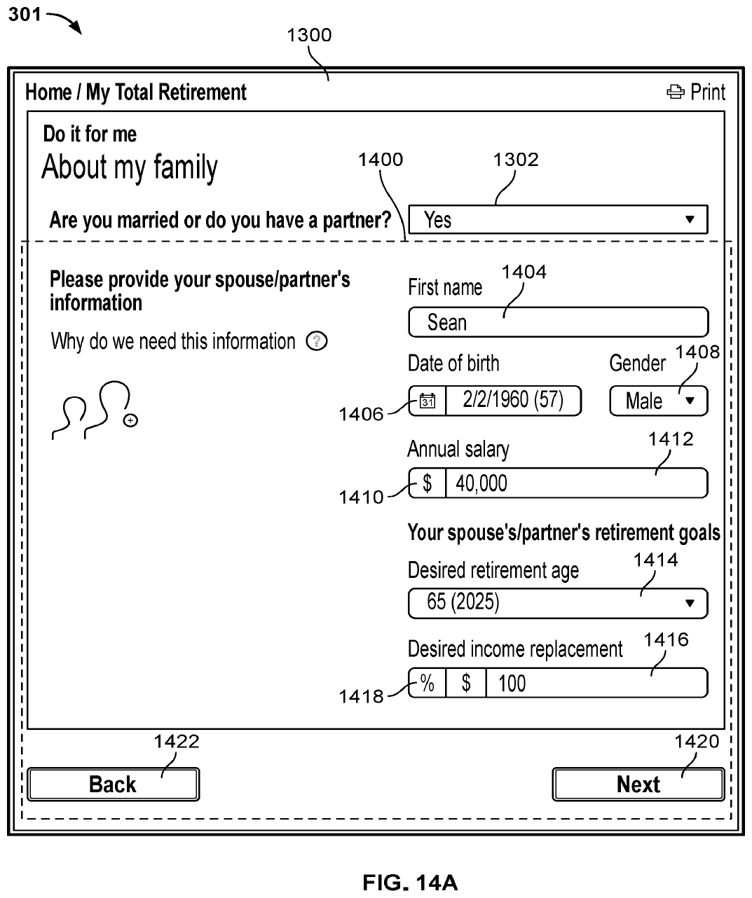

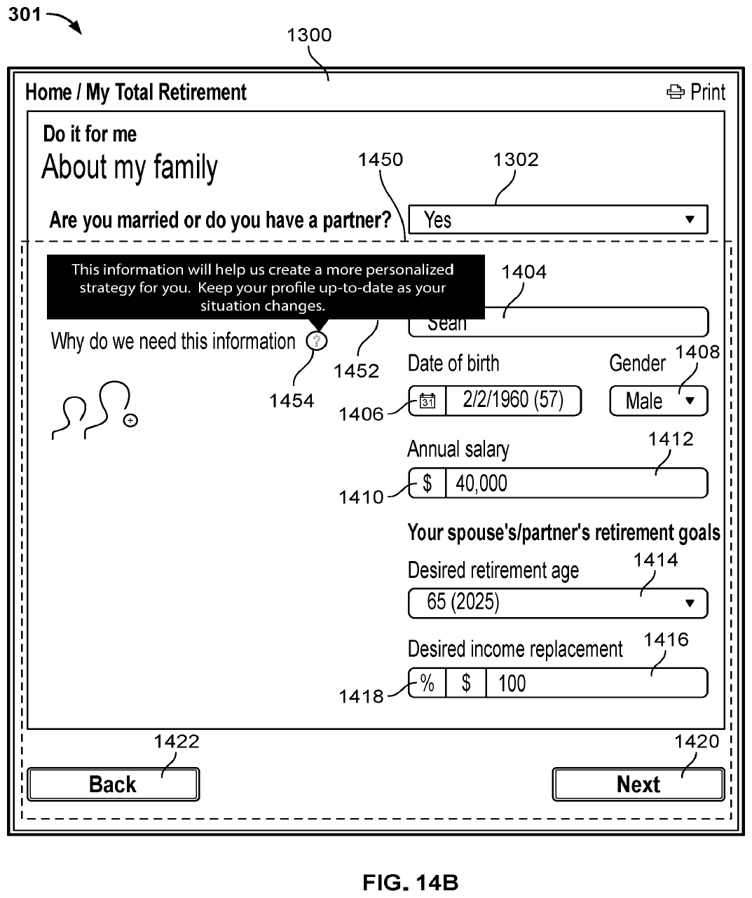

Spouse status page 1300 of GUI 301, which may be opened via about me link 1208, and facilitates user 102 selecting if they have a spouse or partner. More specifically, user 102 may identify a spouse or partner using selector 1302. In response to indicating a spouse/partner, spouse status page 1300 is enlarged to include spouse detail region 1400 to capture spouse data, as shown in FIG. 14A.

Spouse detail region 1400 is configured to capture spouse data from user 102. In the example embodiment, in response to user 102 indicating that he or/she has a partner using selector 1302, and spouse detail region 1400 prompts user 102 for additional spouse data, such as first name 1404, birthdate 1406, gender 1408, salary 1412, desired retirement age (e.g., retirement goal) 1414, and income replacement 1416. Spouse data captured by spouse detail region 1400 may be used by replacement income module 212 and benefits module 210 to calculate income needed in retirement and/or spouse-based social security benefits.

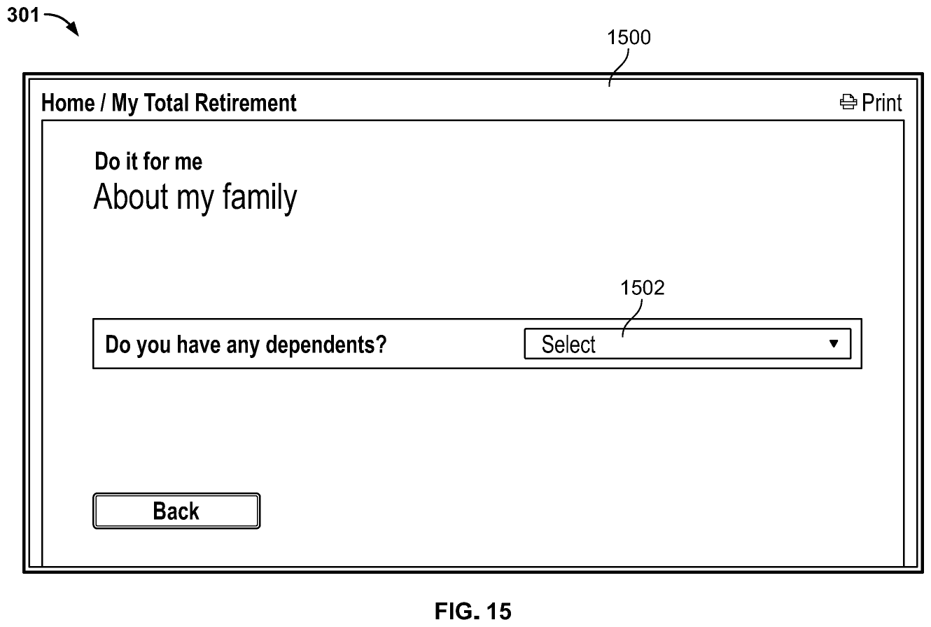

Spouse status page 1300 is configured to facilitate the transmission of spouse data through continuation request 1420. Continuation request 1420 is also configured to facilitate access to another page, such as dependent status page 1500 (shown in FIG. 15). Alternatively, the back button 1422 may be used to discard changes.

FIG. 14B depicts the example spouse status page 1300 with a tool tip 1452 for the services representative displayed. In the example embodiment, tool tip 1452 is displayed in response to user 102 hovering over, for example, a question mark icon 1454 associated with the page in general or, alternatively, with a particular data entry field. In other embodiments, tool tip 1452 may be displayed in response to user 102 clicking on or pressing “enter” on the icon 1454, or by hovering over the data entry field itself, for example. Although tool tip 1452 is illustrated for the spouse status page 1300, it should be understood that any page or data entry field of GUI 301 may contain suitable tool tips that operate as described with respect to tool tip 1452. In particular, tool tips are configured to provide explanatory information for the corresponding page and/or data entry fields, so that the services representative has a ready reference guide for questions that are typically asked by participants with regard to the page or user profile item. For example, tool tip 1452 provides a services representative with a standard answer for a participant who questions why the services representative is asking about spouse data. In some embodiments, tool tips are stored in database 120, and the tool tips associated with each page and/or data entry field may be updated by the enhanced services provider based on new questions received from participants and/or other participant and services representative feedback.

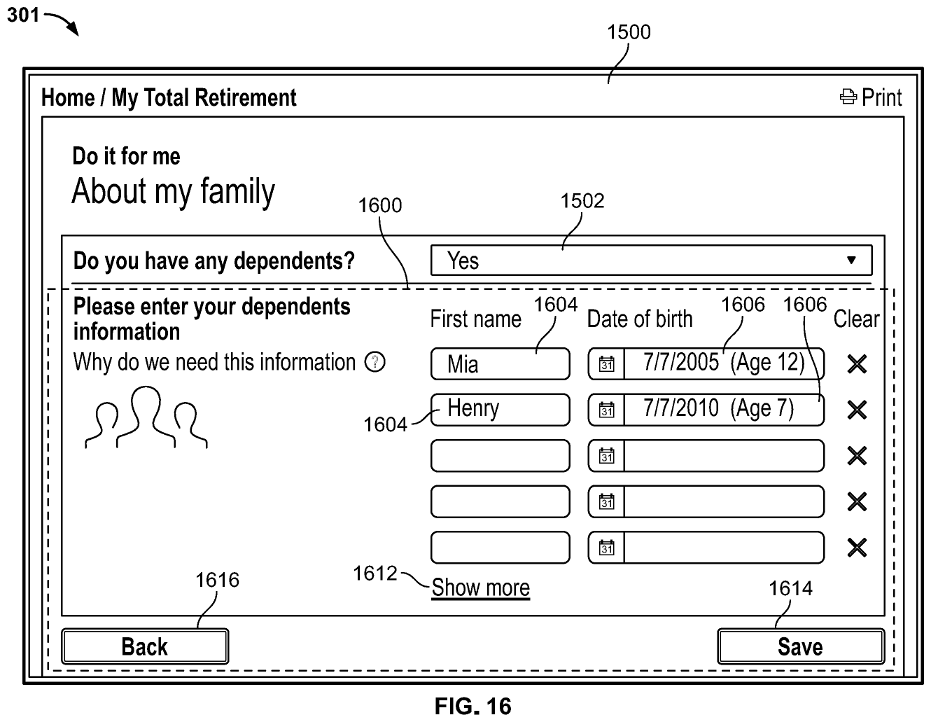

Dependent status page 1500 of GUI 301, shown in FIG. 15, may be opened using about my family information link 1210 and facilitates user 102 identifying if they have dependents, such as young children or special needs relatives. More specifically, user 102 may identify dependents using selector 1502. FIG. 16 depicts the dependent status page 1500 with a dependent detail region 1600. In response to indicating at least one dependent using selector 1502, dependent status page enlarges to include dependent detail region 1600 to capture dependent data, as shown in FIG. 16.

Dependent detail region 1600 is configured to capture dependent data from user 102, such as the name and age of any dependents. In the example embodiment, two dependents are reported, with ages 12 and 7. Dependent detail region 1600 includes first name fields 1604, and adjacent birthdate fields 1606, for a number of potential dependents. Fields for additional dependents may be added with link 1612. Dependent data is transmitted to server computing device 114 in response to save link 1614 being selected. Alternatively, changes may be discarded using back link 1616.

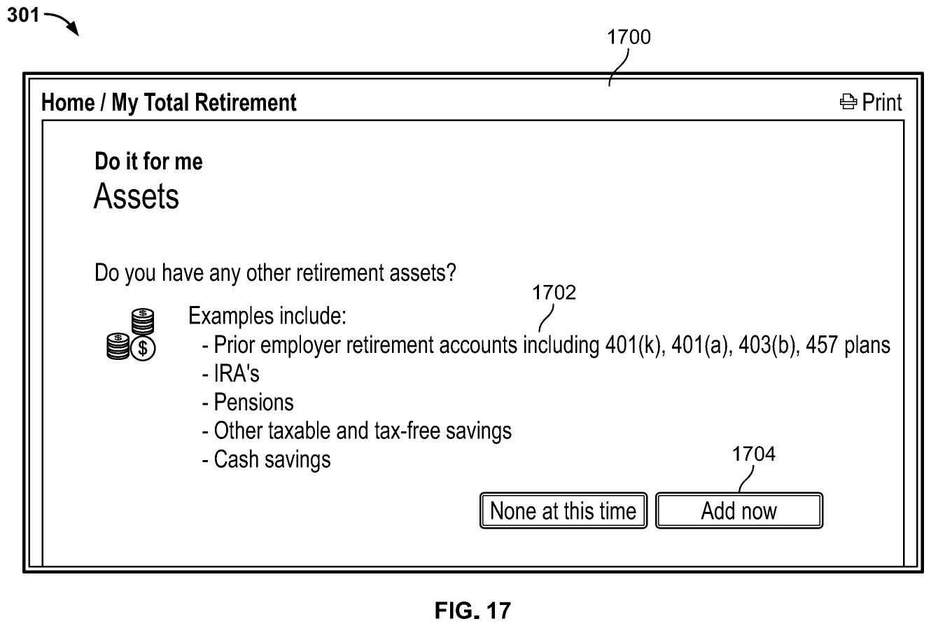

FIG. 17 depicts an example asset status page 1700. Asset status page 1700 of GUI 301 may be opened using assets link 1214 and facilitates user 102 reporting assets, such as other retirement plans, pensions, and the like. For example, user 102 may report an individual retirement account, which may be used to project additional investment income in retirement. Asset status page 1700 displays asset examples 1702 to user 102. Add now link 1704 facilitates user 102 reporting detailed investment assets, which may be used by investment income module 206.

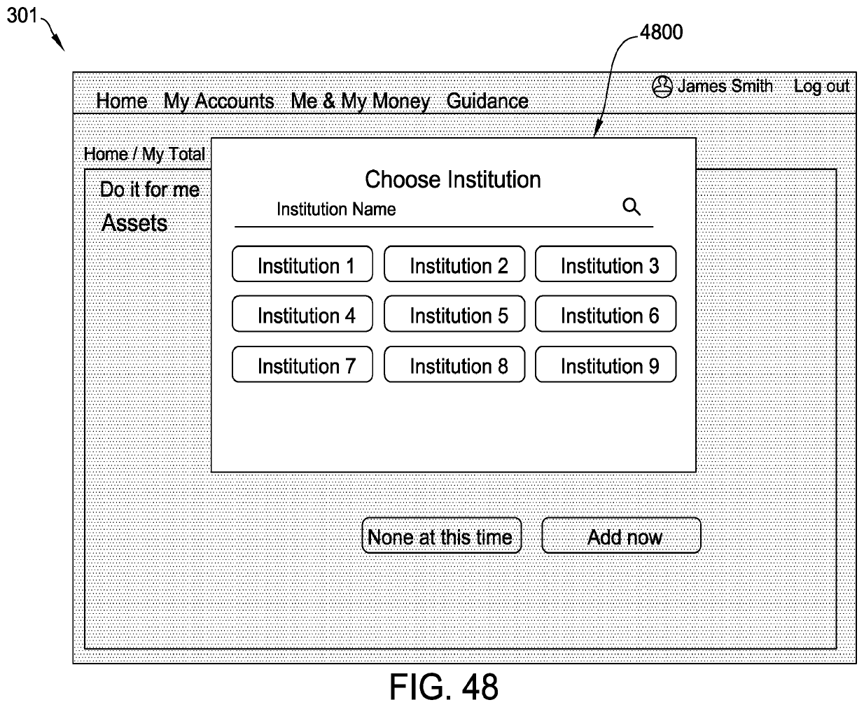

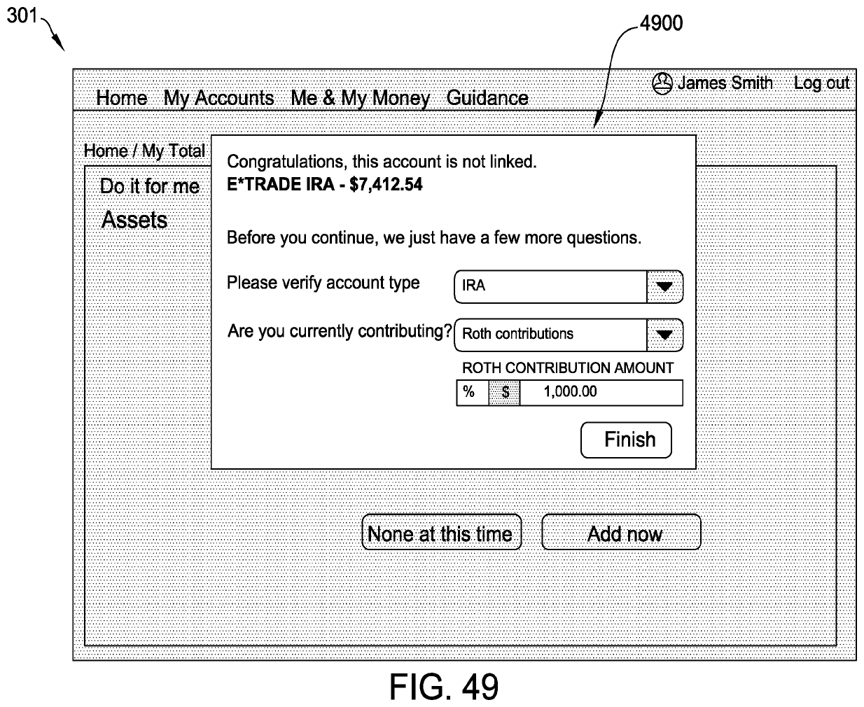

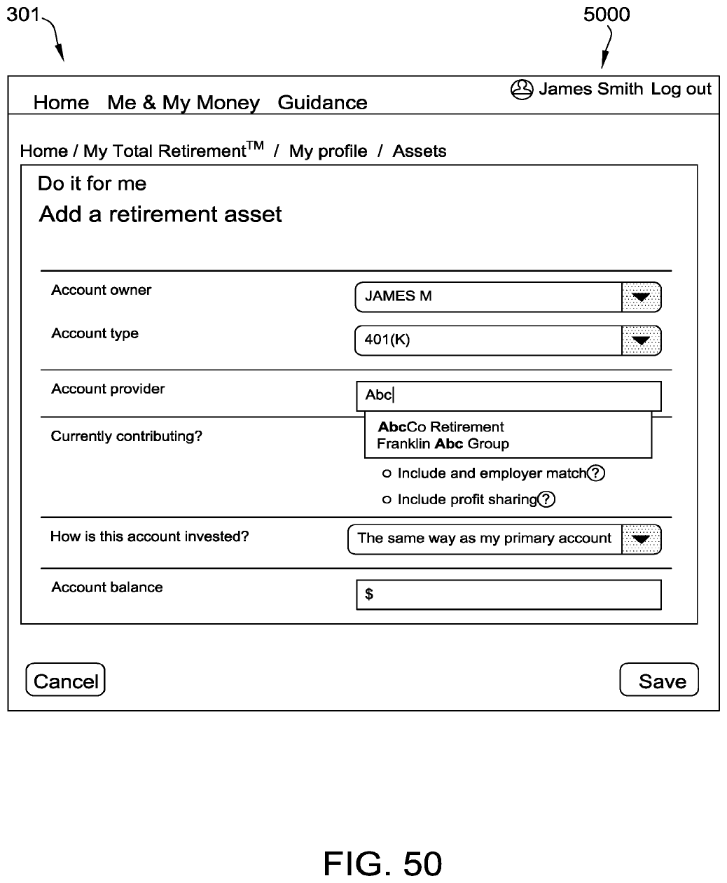

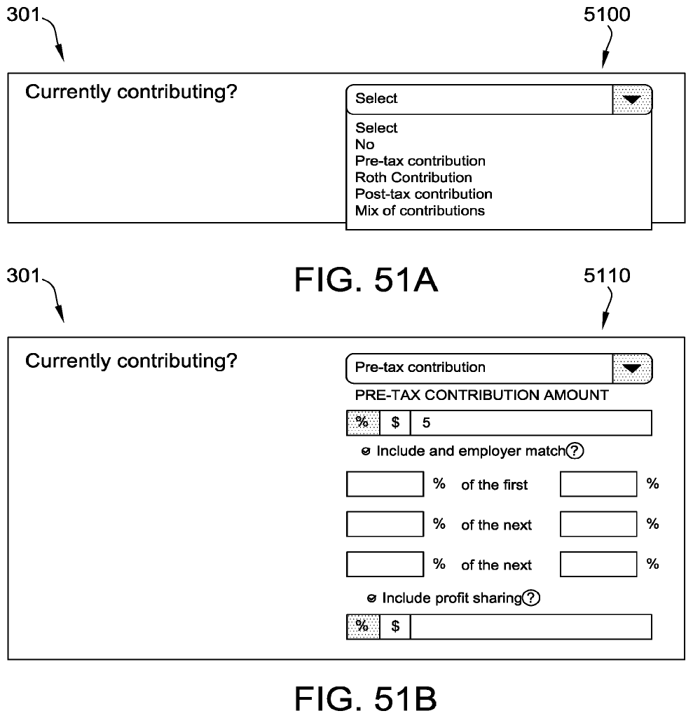

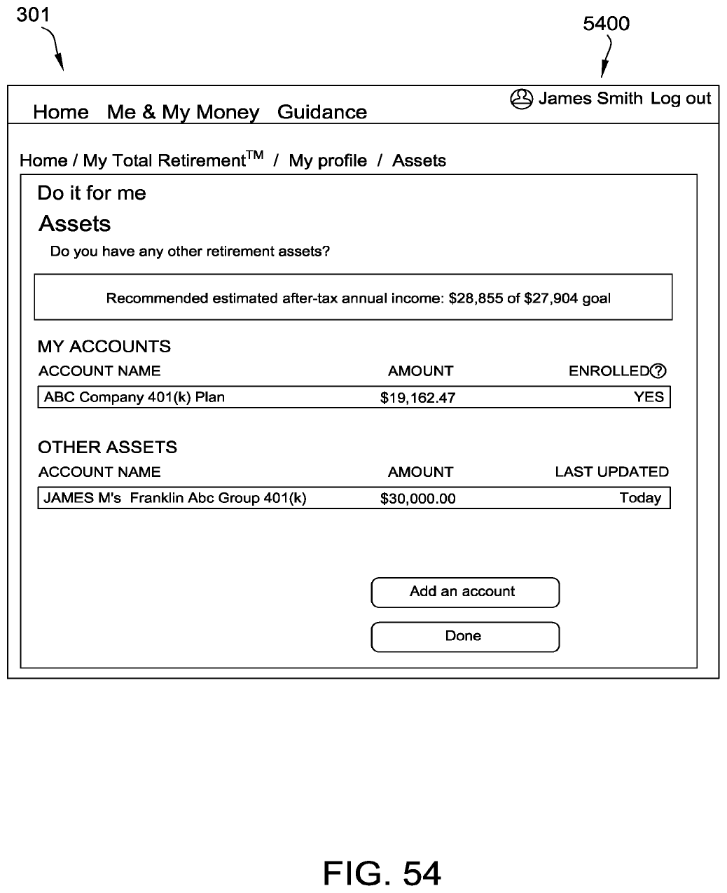

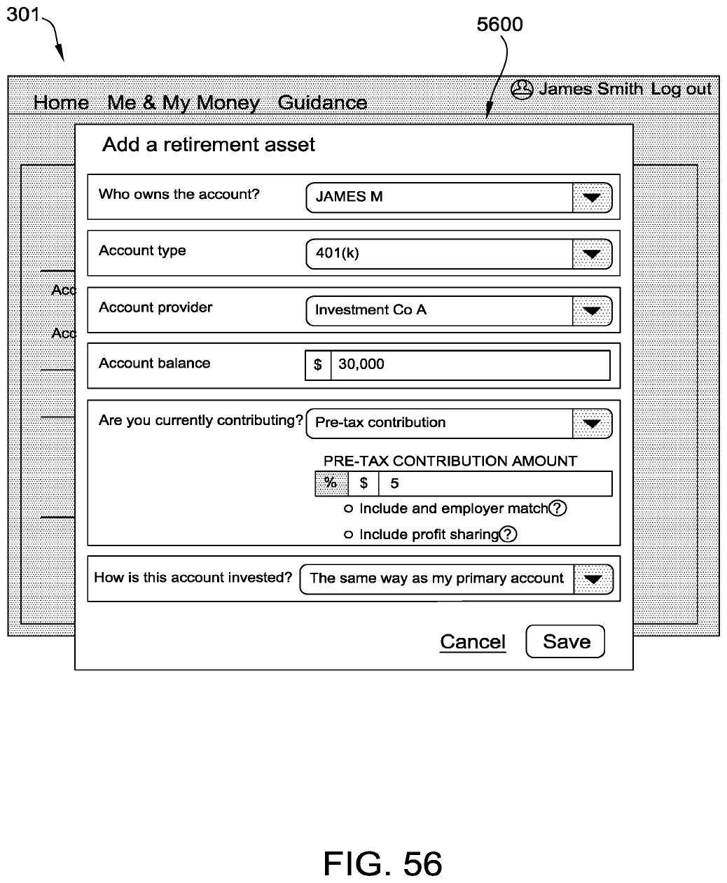

After selecting add now link 1704, user 102 (e.g., a services representative) is directed to an add asset page 5000, a first embodiment of which is shown in FIG. 50 and an alternative “pop-up” embodiment of retirement asset page 5600 of which is shown in FIG. 56, where user 102 has the ability to enter data corresponding to the asset being added. For example, user 102 may enter information corresponding to the following data fields: the account owner, the account type, the account provider, what type of contribution (e.g., pre-tax contribution, Roth contribution, post-tax contribution, mix contribution, and no contributions) participant is currently contributing, the amount of the contribution if there is one, how is the account invested, and the account balance. GUI computer system 114 uses the account provider field to differentiate between multiple accounts that the participant may hold and are stored in database 120. When entering the account provider, GUI 301 is configured to perform an auto complete list on the account provider field, so that user 102 may select from the account provider from a dropdown list. If the account provider is not listed on the auto complete list, user 102 may enter the account provider manually. Other data fields may be configured to display an auto complete list that mitigates incorrect data entry enabling the system to collect and store accurate data. Details of other data entry fields on the add asset page 5000 are shown in FIGS. 51-53. In some embodiments, GUI 301 further enables a user to identify and link existing investment accounts held by the user at third-party institutions, as shown in FIGS. 48 and 49. An other-assets summary page 5400 after data entry is completed is illustrated in FIG. 54.

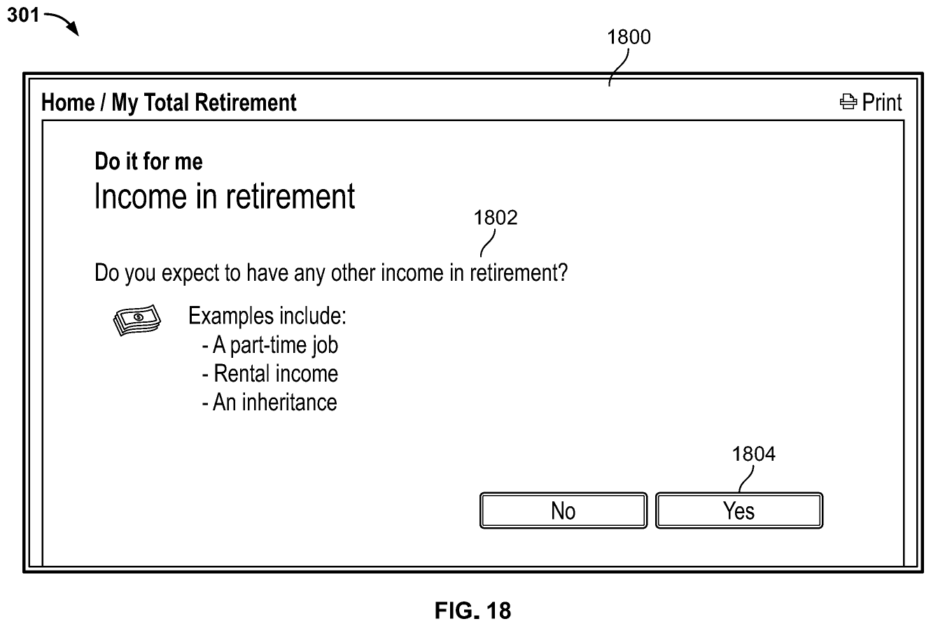

FIG. 18 depicts an example supplemental income page 1800. Supplemental income page 1800 of GUI 301, shown in FIG. 18, may be opened using income in retirement link 1216 and facilitates user 102 identifying supplemental retirement income, such as part time employment or rental income. For example, seasonal rental income may be reported, which may offset the need for investment retirement income. Supplemental income page 1800 includes income examples 1802. Yes link 1804 facilitates user 102 reporting retirement income, which may be used by replacement income module 212.

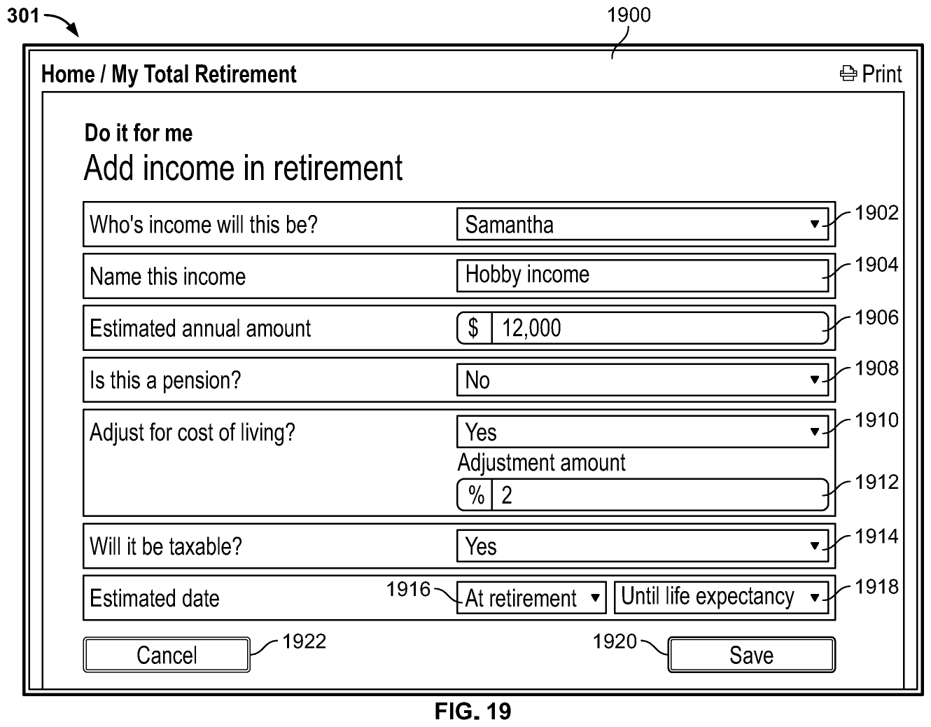

FIG. 19 depicts an example supplemental income detail page 1900. Supplemental income detail page 1900 of GUI 301, shown in FIG. 19, may be opened using yes link 1804, and facilitates user 102 detailing supplemental retirement income. For example, projected hobby income during retirement may be reported, which may offset expenses in retirement. In some embodiments, replacement income module 212 adjusts supplemental income based on inflation. User 102 may identify user 102 or the user's spouse as the income source using earner identifier 1902 and provide income description 1904. User 102 further identifies if the income is a pension, and if the income is taxable. Based on pension identifier 1908 and taxable identifier 1914, estimated annual amount 1906 may be adjusted. More specifically, replacement income module 212 may adjust estimated annual amount 1906 based on cost of living adjustment identifier 1910, and adjustment amount 1912. Estimated dates of retirement 1916 and life expectancy 1918 may also be input for use by projection and optimization modules 152.

Supplemental income detail page 1900 is configured to facilitate the transmission of supplemental income data through save preferences button 1920. Save preferences button 1920 is also configured to facilitate access to another page, such as supplemental income page 1800 (shown in FIG. 18). Alternatively, the cancel button 1922 may be used to discard changes.

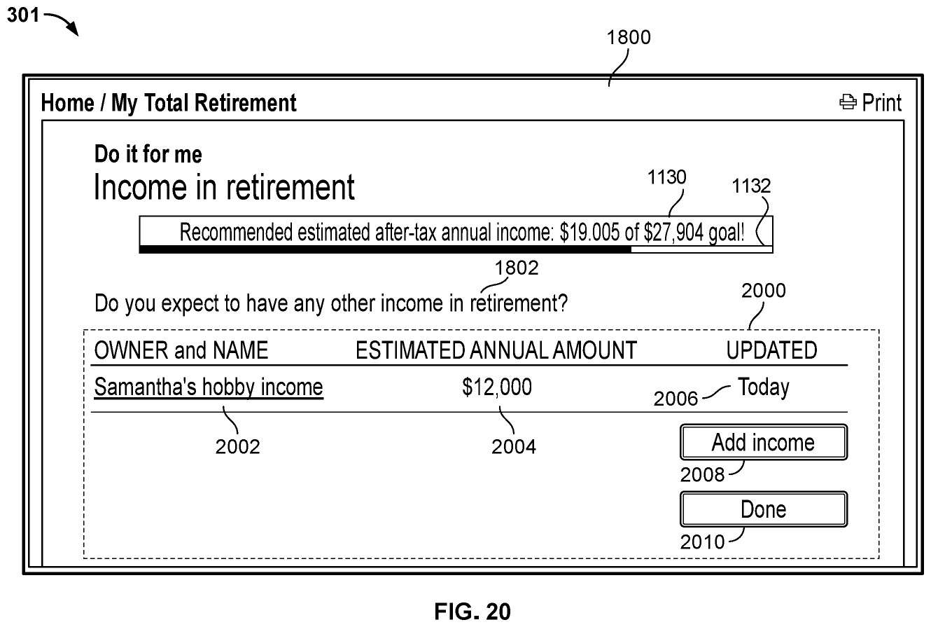

FIG. 20 depicts an example supplemental income summary region 2000 as a part of the supplemental income page 1800. In response to entry of supplemental income using supplemental income detail page 1900, supplemental income page 1800 is updated to include supplemental income summary region 2000, shown in FIG. 20, which is configured to display a summary of supplemental retirement income information submitted by user 102. For example, previously submitted sources of supplemental retirement income may be displayed in a list. In the example embodiment, the display includes a supplemental income identifier 2002, supplemental income amount 2004, and date updated 2006 for each source of supplemental income previously input by the user. For example, supplemental income identifier 2002 includes the name of user 102 received from user identifier 1902 (shown in FIG. 19) and the description of the supplemental income received from income description 1904 (shown in FIG. 19). Supplemental income amount 2004 includes the estimated annual amount of income received from estimated annual amount 1906 (shown in FIG. 19).

Supplemental income summary region 2000 is also configured to allow the user to add more sources of supplemental income through add income request 2008. In some embodiments, add income request 2008 is configured to bring the user to supplemental income detail page 1900 (shown in FIG. 19). Supplemental income summary region 2000 is further configured to allow the user to complete the income in retirement reporting process through completion button 2010. Completion button 2010 allows the user to access another page in the financial advisory system interface, such as savings goals page 324 or savings goals page 2100.

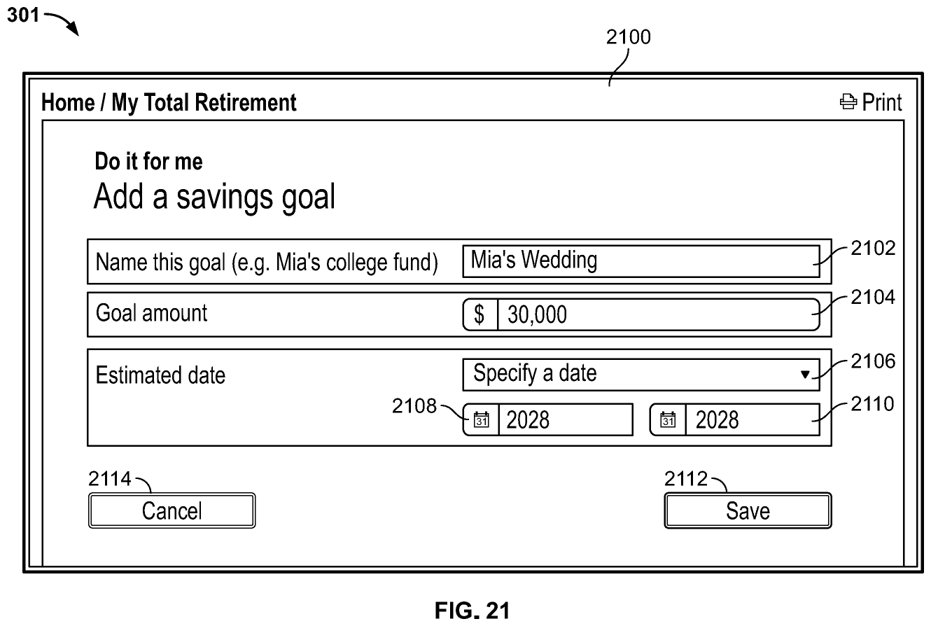

FIG. 21 illustrates savings goals page 2100 of GUI 301, which may be opened using savings goals link 1218 and is configured to allow user 102 to add additional savings goals which may or may not be related to retirement. For example, savings goals page 2100 allows user 102 to add a goal to save a certain amount of money for a dependent's wedding by a certain date in the future. Savings goals page 2100 is configured to capture information from the user, including a name for the goal through goal description input 2102, a goal amount through goal amount input 2104, and a goal date through estimated goal date inputs 2106, 2108, and 2110. Savings goals page 2100 is also configured to allow the user to save the input information through save button 2112, or alternatively discard any changes using cancel button 2114. Save button 2112 is also configured to allow the user to access another page in the financial advisory system interface, such as savings goals summary 2200.

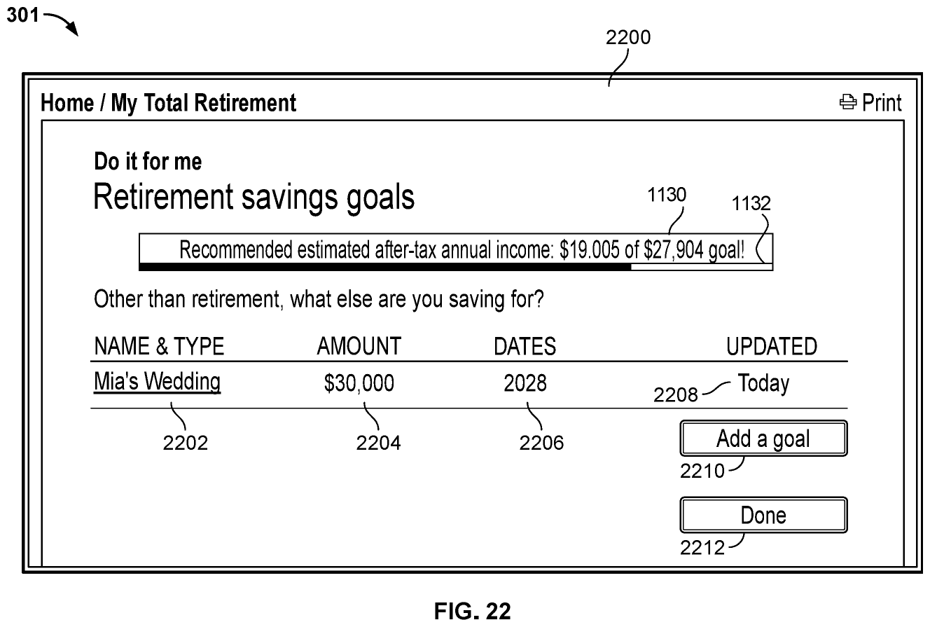

FIG. 22 illustrates savings goals summary page 2200 of GUI 301, which is configured to display a summary of savings goals input by user 102 in response to selection of save button 2112. For example, previously submitted savings goals may be displayed in a list. In the illustrated example, GUI 301 causes to be displayed a savings goal identifier 2202, savings goal amount 2204, savings goal date 2206, and a date updated 2208 for each savings goal previously input by the user. For example, savings goal identifier 2202 includes the name for the goal captured by goal description input 2102 (shown in FIG. 21). Savings goal amount 2204 includes the goal amount captured by goal amount input 2104 (shown in FIG. 21). Savings goal date 2206 includes the goal date captured through estimated goal date inputs 2106, 2108, and 2110 (all shown in FIG. 21).

Savings goals summary page 2200 is also configured to allow the user to add more savings goals through add a goal request 2210. In some embodiments, add a goal request 2210 is configured to bring the user to savings goals page 2100 (shown in FIG. 21). Savings goals summary page 2200 is further configured to allow the user to complete the savings goals reporting process through completion button 2212. Completion button 2212 allows the user to access another page in GUI 301, such as investments page 326 or investments page 2300.

In the example embodiment, each of About me page 1200, supplemental income page 1800, and savings goals summary page 2200 includes estimated income widget 1130, as discussed above. Thus, on each of these pages, the user is provided with an immediate, dynamically updated summary of the impact of each update to database fields related to personal profile information 1202, financial information 1204, and retirement expenditures information 1206, without requiring the user to navigate back to dashboard page 1100 or a different account summary page.

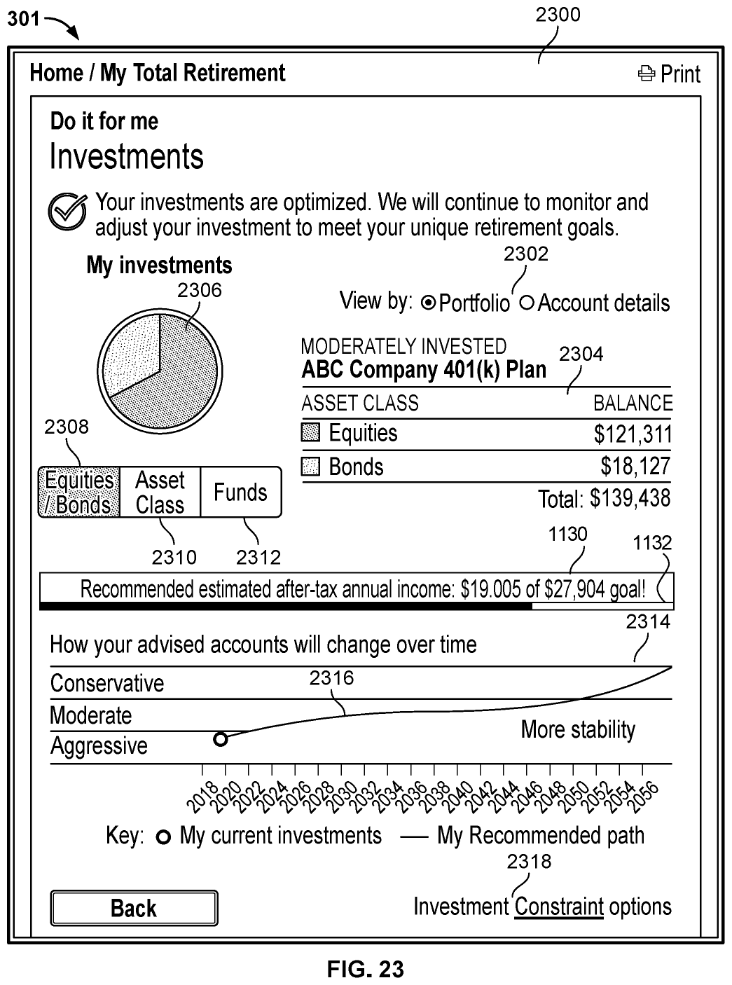

FIG. 23 depicts investments page 2300 of GUI 301, which may be opened using investments link 1104 (shown in FIGS. 11A and 11B) and displays graphical and numeric descriptions of the composition of the user's 102 financial account. The investments page 2300 allows users to view aspects of their current investment strategy. The user can view their investments at the total portfolio level as well as view the details of each of their accounts. The account detail view displays all of the user's accounts that are associated with a group client, as well as any outside accounts that they have entered. The user may also update their outside assets from an account details view. GUI 301 causes to be displayed on investments page 2300 financial information based on user profile data and account data. Specifically, investments page 2300 is configured to display asset data, such as bond and equity composition 2304 of user's 102 assets, and optimized allocation strategy 2316.

In some embodiments, bond and equity composition 2304 is determined by return calculation module 204 (shown in FIG. 2A) based on asset data such as asset identifiers and asset compositions. Planning engine 150, in some embodiments through return calculation module 204, is configured to generate a graphic composition display 2306 which graphically displays the adjacent numerical values.

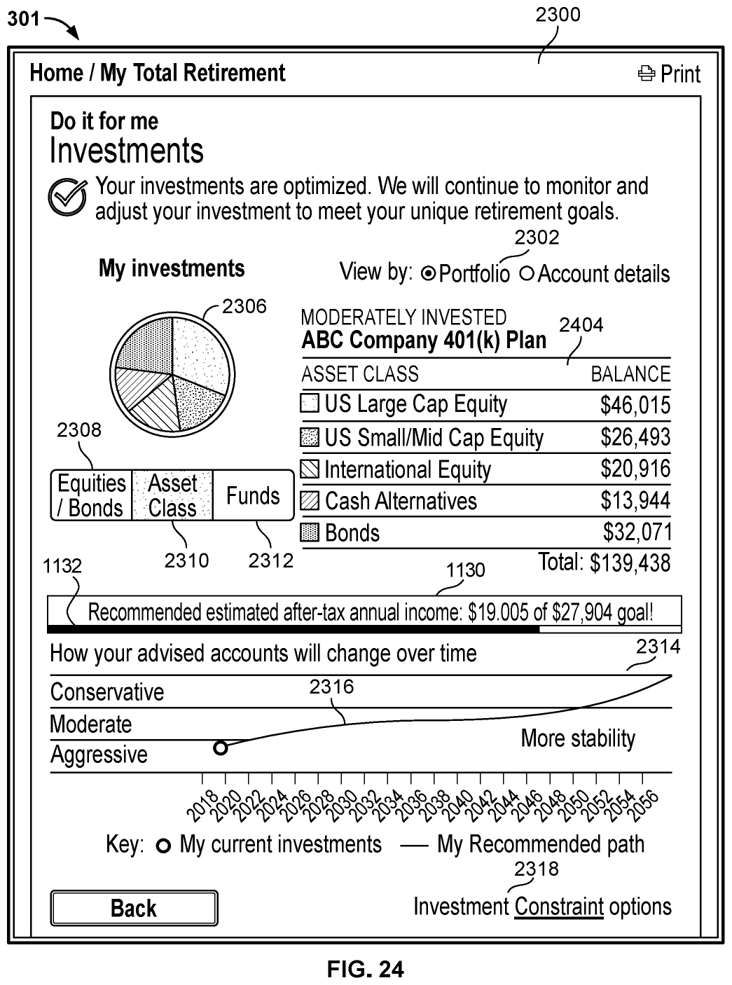

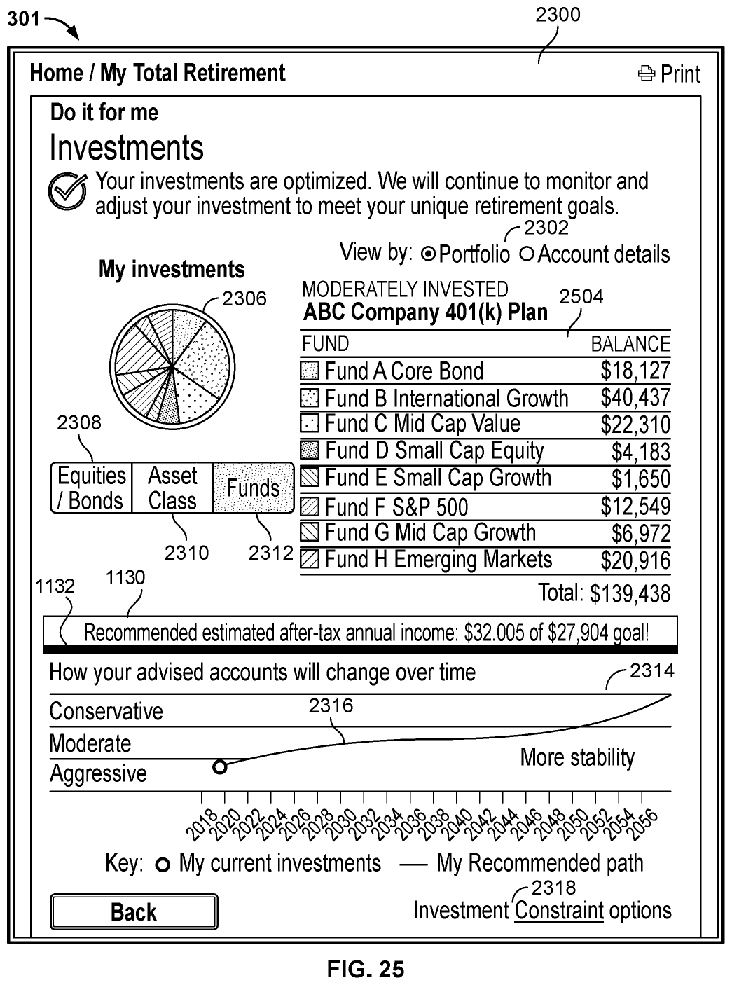

Investments page 2300 is also configured to allow the user to select from a number of ways to display financial information. Specifically, investments page 2300 includes display options 2308, 2310, and 2312. In the illustrated example, display option 2308 is configured to display bond and equity composition 2304 through investments page 2300, as shown in FIG. 23. FIG. 24 depicts an example asset class composition 2404 within the investments page 2300. Display option 2310 is configured to display asset class composition 2404 both numerically and graphically via graphic composition display 2306. FIG. 25 depicts an example fund composition 2504 within the investments page 2300. Display option 2312 is configured to display fund composition 2504 both numerically and graphically via graphic composition display 2306.

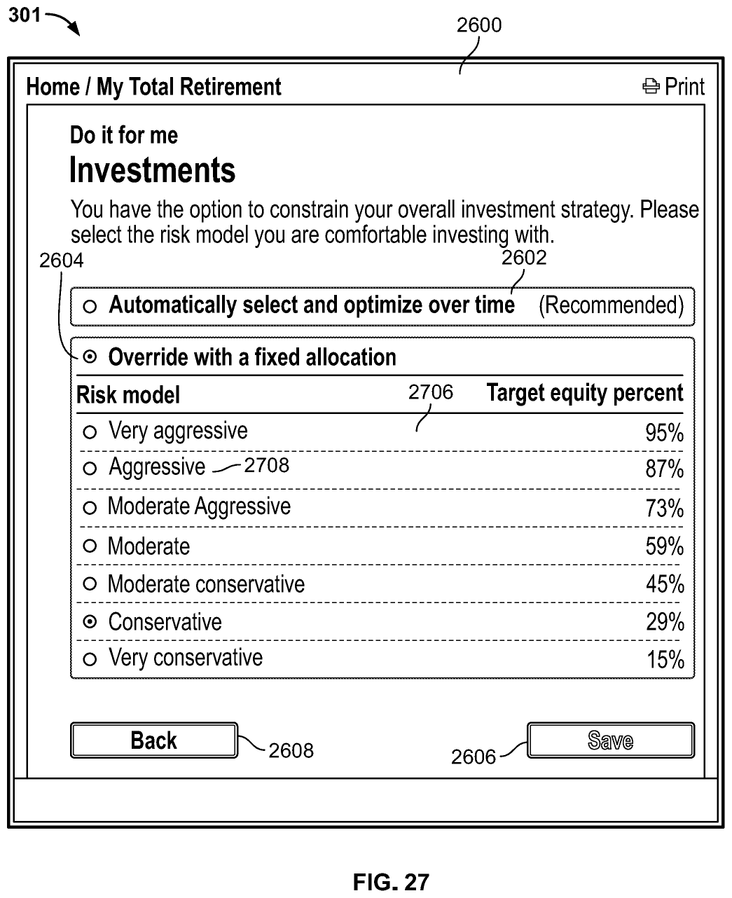

Investments page 2300 is also configured to display a stability graph section illustrating a stability of the selected investment strategy over time in a “glide path” 2314, which displays a graphical representation of asset allocation (e.g., ordinate or Y-axis, in units of risk level) over time (e.g., abscissa or X-axis, in units of time). Optimized allocation strategy 2316 represents the optimal asset allocation over time. Glide path 2314 shows how the asset allocation of their enrolled accounts will be allocated to fixed income from the current year until life expectancy, illustrating investment strategy stability over time for the recommended investment strategy. In some embodiments, glide path 2314 may be modified with an override risk level (e.g., as shown and described below with respect to FIG. 27). Optimized allocation strategy 2316 is determined by planning engine 150, in some embodiments by return calculation module 204, based on user profile data and account data, such as demographic data (e.g., age) and asset data. In the example embodiment, the ordinate includes designations of investment strategy risk graded from most aggressive at the abscissa to most conservative away from the abscissa, which configures glide path 2314 to directly illustrate to the user an increase in stability over time.

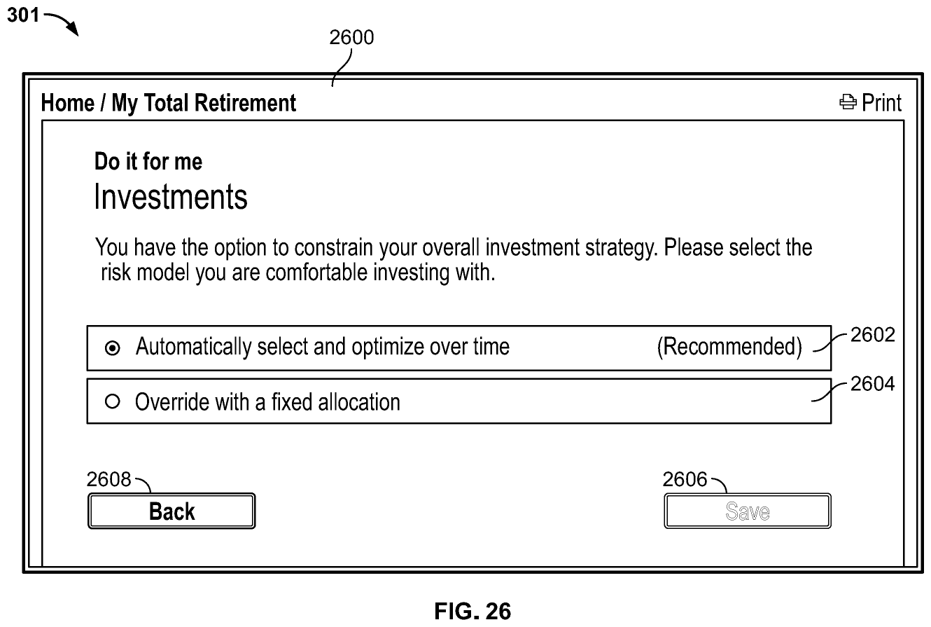

Investments page 2300 is further configured to facilitate user 102 viewing alternative financial information through detail selection 2302. Detail selection 2302 allows the user to select between different options for the type of information displayed on investments page 2300. Investments page 2300 is also configured to facilitate user configuration of settings through constraints option 2318. Constraints option 2318 is configured transmit to another web page, such as investment constraints page 2600 (shown in FIGS. 26 and 27) of GUI 301, to user 102. In some embodiments, asset class composition 2404 is determined by return calculation module 204 (shown in FIG. 2A) based on asset data such as asset identifiers and asset compositions.

Investments page 2300 is also configured to enable user 102 to select, for example, composition display 2306, such as by hovering a pointer over composition display 2306, to view an investment type and corresponding percentage of the total investments depicted in composition display 2306. For example, user 102 may hover over composition display 2306, such as a pie chart, where the color of the region being hovered enhances and/or changes, and a percentage and type of investment of the region being hovered are displayed.

FIG. 26 depicts an example investment constraints page 2600 for updating preferred constraints used by planning engine 150 for determining financial projections. Specifically, investment constraints page 2600 facilitates the user 102 selecting an investment strategy preference and an allocation preference. In the illustrated example, user 102 can select from two investment strategy preferences: optimization option 2602 or manual option 2604. Optimization option 2602 is configured to cause planning engine 150 to determine an optimized allocation strategy based on user profile data and account data, such as age and asset composition. In some embodiments, planning engine 150 determines the optimal asset allocation strategy through return calculation module 204 (shown in FIG. 2A). FIG. 27 depicts example strategy selection options 2706 and strategy selection indicators 2708 within investment constraints page 2600. Selection of manual option 2604 enlarges investment constraints page 2600 to display allocation options, such as strategy selection options 2706 labeled with strategy selection indicators 2708 (shown in FIG. 27) to facilitate the manual selection of a particular investment strategy by user 102. In the illustrated example, strategy selection options 2706 are risk-based investment strategies based on a percentage of user's 102 portfolio which is invested in equities vs bonds. For example, a “very aggressive” strategy indicates a preference for 95% equities, while a “moderate” strategy indicates a preference for 59% equities. Planning engine 150, using return calculation module 204 in some embodiments, determines asset allocations based on the selected strategy option and other user profile data and account data.

In an alternative embodiment, strategy selection options 2706 are investment strategies based on a percentage of a user's profile which is invested in a particular asset class or fund. For example, a “very aggressive” strategy may indicate a preference for 50% of the portfolio to be placed in tech stocks. In another example, a “moderate” strategy may indicate a preference for 50% of the portfolio to be spread out evenly among a variety of funds.

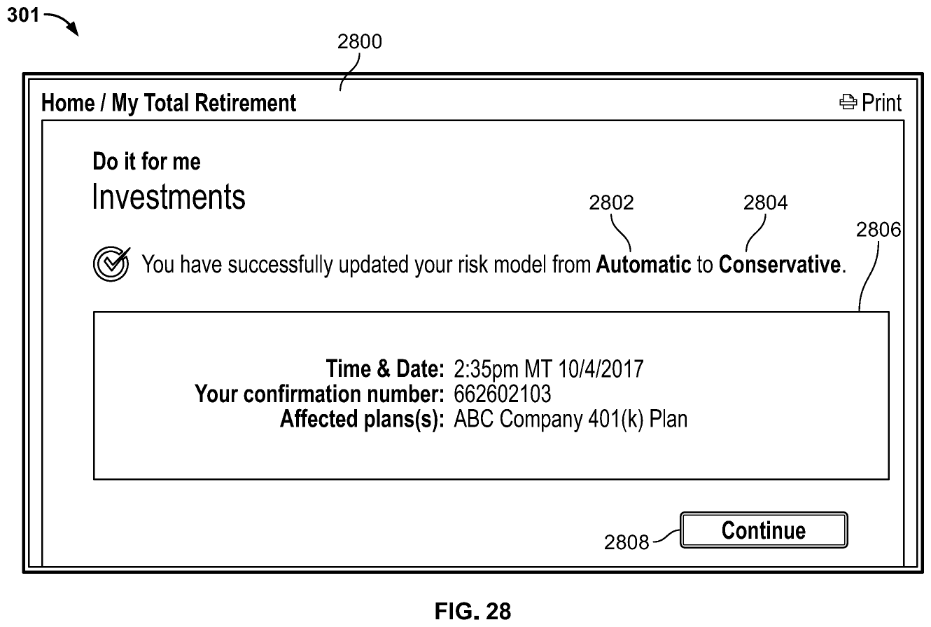

Investment constraints page 2600 is configured to facilitate the transmission of investment strategy preference through save preferences button 2606. Save preferences button 2606 is also configured to facilitate access to another webpage, such as strategy change summary 2800 (shown in FIG. 28). Alternatively, the back button 2608 may be used to discard changes.

FIG. 28 depicts an example strategy change summary page 2800 of GUI 301 for displaying a summary of changes made to a user's 102 investment strategy in response to selection of save preferences button 2606. In the example embodiment, strategy change summary page 2800 displays a summary of changes to constraint preferences, for example, choosing a different optimization option 2602 or 2604 (shown in FIG. 26) or a different strategy selection option 2706 (shown in FIG. 27).

Strategy change summary page 2800 is configured to display a previous strategy indicator 2802 and a current strategy indicator 2804, which are updated based on changes to the investment strategy selected by user 102. Strategy change summary page 2800 is further configured to display change confirmation 2806. Change confirmation 2806 includes confirmation information which may be helpful for facilitating documentation of the change of strategy. In the example embodiment, change confirmation 2806 includes a date and time, a confirmation number, and an affected plan.

Strategy change summary 2800 is also configured to facilitate access to another webpage, such as update 2900 to investments page 2200, through continue request 2808.

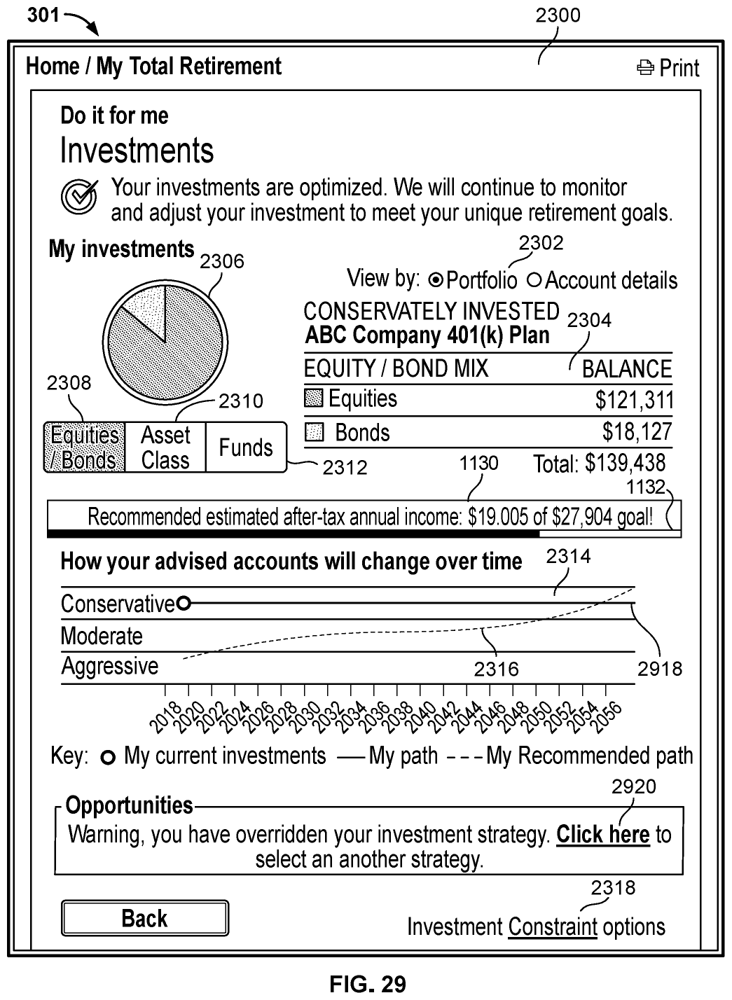

FIG. 29 depicts an example update to investments page 2300 of GUI 301 (shown in FIGS. 23-25) in response to selection of one or more strategy selection options 2706.

The update is configured to display additional information in glide path 2314, which displays a graphical representation of asset allocation over time as described above. More specifically, manual allocation strategy 2918 graphically represents the user defined investment strategy, based on captured asset strategy preference data, and is overlaid on optimized allocation strategy 2316, which represents the optimal asset allocation strategy over time, as described above. Thus, the update enables the user to graphically compare the manually selected option 2706 to the optimized allocation strategy 2316 calculated by planning engine 150. In the example embodiment, the update causes optimized allocation strategy 2316 to appear as a dashed or muted line to indicate it is no longer the active strategy.

The update also causes to be displayed a strategy alert 2920 on investments page 2300 in response to the user-selected investment strategy. In the example embodiment, GUI 301 causes to be displayed strategy alert 2920 upon reception of a strategy selection option 2706 captured from user 102. Specifically, when user 102 elects to manually choose a strategy selection option 2706, strategy alert 2920 is displayed. Strategy alert 2920 provides a link to re-access investment strategy settings, which may include re-transmitting investment constraints page 2600 (shown in FIG. 26), in the event that the user decides to under the manual strategy selection.

FIGS. 11A-29 illustrate aspects of GUI 301 directed to providing access to different sections of GUI 301, collecting user information (including personal information, financial information, information regarding future expectations and goals, and preference information (e.g., risk tolerance)) and presenting summaries of user data, such as the portfolio summaries illustrated in FIGS. 23-25 and 29. More generally, FIGS. 11A-29 illustrate example GUI pages/sections that include various controls and elements for collecting and presenting user data. Such controls and elements may be readily adapted for other contexts and applications of the present disclosure. For example, the illustrated implementation collects information pertinent to financial planning, such as family composition, current investments, retirement income expectations, savings goals, and risk tolerance through a series of windows and pages including various controls (e.g., text boxes, drop downs, sliders, calendar pop-ups, etc.). Similar windows/pop-ups and controls could also be used to collect user date relevant in health and wellness- or education/proficiency-related implementations of this disclosure and to provide corresponding summaries, such as those illustrated in FIGS. 23-25 and 29. In a health and wellness context, for example, GUI 301 may include a series of pages/windows/pop-ups with controls and GUI elements for collecting user data related to current biometrics (e.g., age, height, weight, sex), current fitness level, any injuries or health conditions that may impact the user's progression, user preferences for certain types of exercises, accessibility of certain exercise equipment for the user, scheduling/availability information, goals (e.g., a target weight or a target fitness goal), and the like. Similarly, aspects of GUI 301 may be tailored to collect information relevant to a proficiency-related implementation. Without limitation, such information may include a current proficiency level, user preferences for certain types of learning modalities, information regarding any learning challenges or impairments, scheduling/availability information for the user, goals (e.g., a target proficiency level), etc.

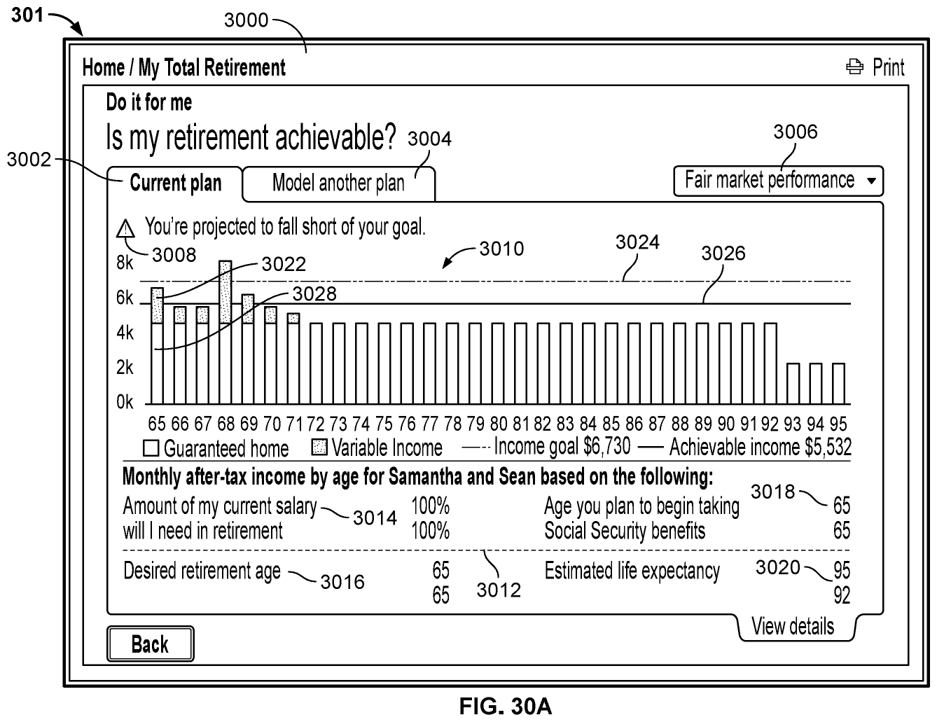

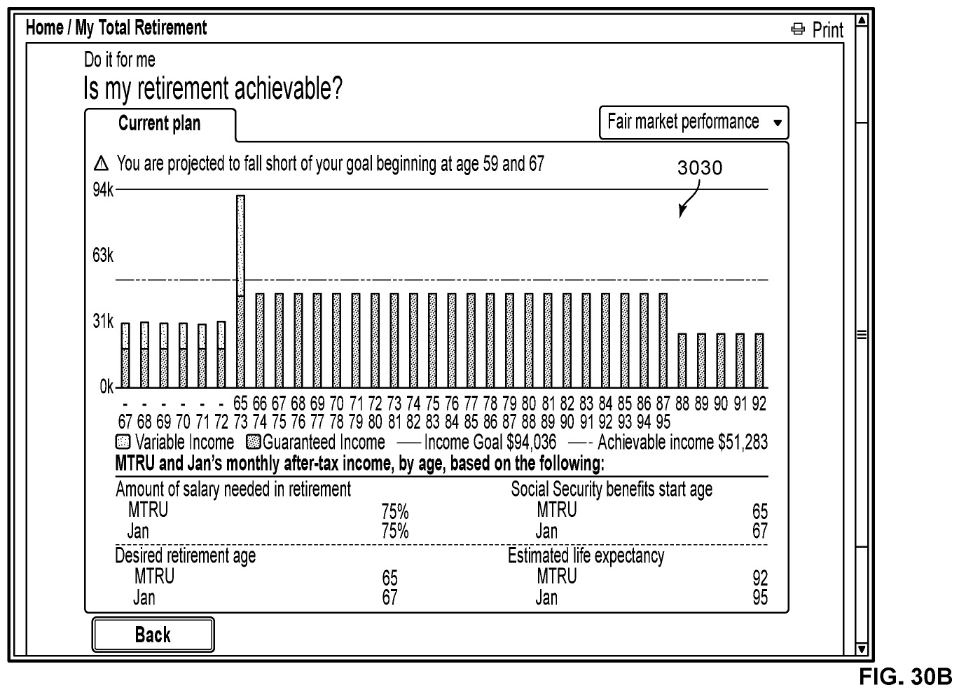

As illustrated in FIG. 30A, the GUI can include a first section (e.g., first tab) and a second section (e.g., second tab). The first section can depict a first graph, which can illustrate projections for user based on current values for parameters of the user profile. The second section can include control and second graph. The control can receive an input of one or more modified values, which can be input by the user, for one or more parameters of the user profile. The second graph can illustrate modified projections for the user. The modified projections can be generated by the predictive engine based on a second set of parameter values. The modified value input can override the current value of the parameter. The second graph can be dynamically updated in response to modified values being input using the control.

Although FIG. 30A pertains to account management for financial planning, the GUI can be used in multiple other applications as previously discussed.

FIG. 30A depicts retirement summary page 3000 of GUI 301, which may be opened using income planning link 1112 and displays projected replacement income compared to a retirement goal. For example, user 102 may review the projected income replacement generated by their current contributions and retirement savings and evaluate the annual projected retirement income.

Retirement summary page 3000 includes a current plan tab 3002 and a plan model tab 3004. In FIG. 30A, current plan tab 3002 is selected and displays data based on current financial data such as salary contributions, and asset allocations. Goal indicator 3008 is displayed in response to replacement income module 212 comparing the retirement goal to the projected retirement income. In the example embodiment, the retirement income is not projected to meet the retirement goal, so goal indicator 3008 indicates as much.

A projected retirement income graph 3010 is generated by advisory rules engine 202, using investment income module 206 and benefits module 210. Guaranteed income 3028 (e.g., annuities, social security, defined-benefit pensions) and variable income 3022 (e.g., investment income) are generated and displayed for each year of retirement in a two-color bar graph. In some embodiments, projected retirement income graph 3010 may further include retirement income goal 3024 and average projected annual income 3026. In the example embodiment, retirement income goal 3024 is generated based on replacement income module 212. For example, retirement income goal 3024 may be projected based on a portion of salary income at retirement. Average projected annual income 3026 (e.g., achievable income) defines an average expected investment income (e.g., average yearly income throughout the life expectancy of the user, from an optimal spend-down strategy based on the income factors of the user).

A current plan tab 3002 of retirement summary page 3000 also includes income factor information 3012 for user 102 and, in some embodiments, the spouse/partner of user 102. Replacement income percentages 3014 define a percentage of the projected salary at retirement needed for expenses in retirement. In the example embodiment, 100% of the salaries of user 102 and user 102's spouse is projected to be needed in retirement. Benefit age 3018 defines a projected age when user 102 and user 102's spouse begin receiving retirement benefits, such as a pension or social security. Similarly, retirement age 3016 defines a desired retirement age for user 102 and user 102's spouse. Additionally, estimated life expectancy 3020 defines a final year for which retirement income will be needed, and a number of years where partial retirement income may be needed, based on a reduced household.

Projected retirement income graph 3010 is configured such that user 102 may select any year to view additional retirement income detail, such as the benefit and/or investment income for each year. In the example embodiment shown in FIG. 30A, the age of the user (e.g., the primary account holder) is displayed as the x-axis of projected retirement income graph 3010. FIG. 30B illustrates another example projected retirement income graph 3030 similar to projected retirement income graph 3010. In the example embodiment, the primary account holder has a spouse, and the spouse's age is illustrated as a second x-axis of retirement income graph 3030, immediately below the age values of the user.

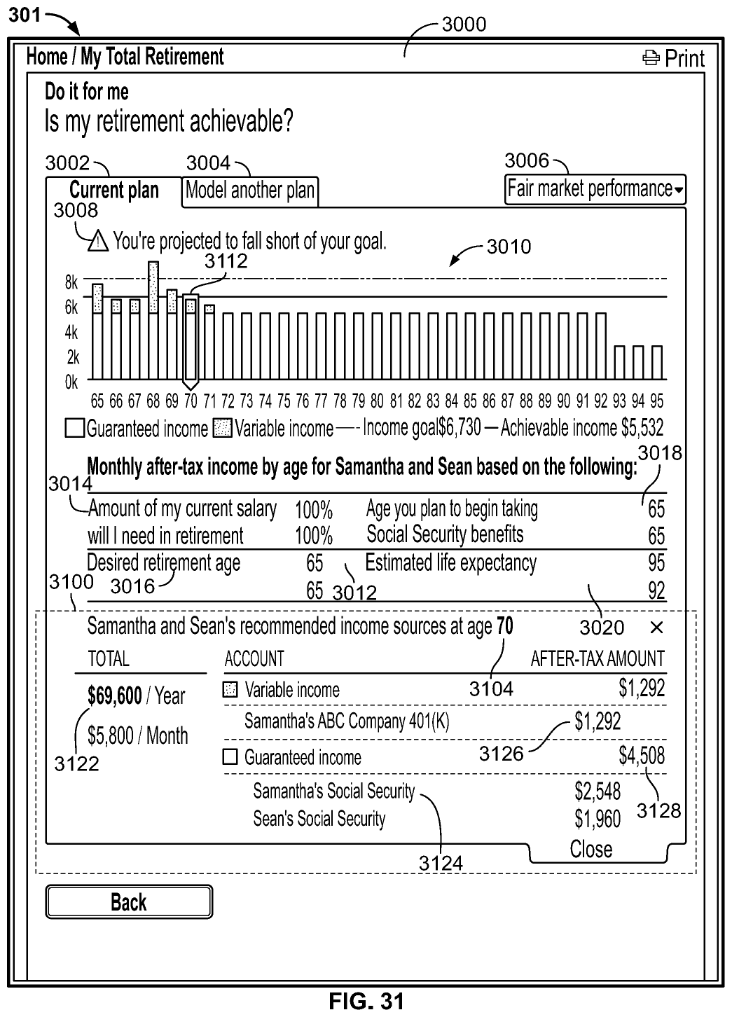

FIG. 31 depicts a current plan tab 3002 of retirement summary page 3000 enlarged to show an income detail region 3100 in response to user 102 selecting the individual bar of the graph corresponding to a retirement year on retirement summary page 3000. For example, user 102 selects the year of interest by hovering a pointer over the corresponding bar. User 102 may review the investment income and/or benefit income projection generated by planning engine 150 in a specific year of retirement. For example, the income from retirement plans and social security may change over time. In the absence of a selection, the alphanumeric display in income detail region 3100 is for a default year, such as the initial year of retirement.

After user 102 selects a retirement year 3112 from projected retirement income graph 3010, income detail region 3100 is generated by GUI 301. Income detail region 3100 includes year identifier 3104, variable income (e.g., investment income) 3126, guaranteed income 3128 (e.g., benefit income), and projected year income 3122. In the example embodiment, projected 401(k) and social security income are aggregated to calculate a projected annual income at age 70. In the absence of a selection, the retirement year 3112 is set to a default year.

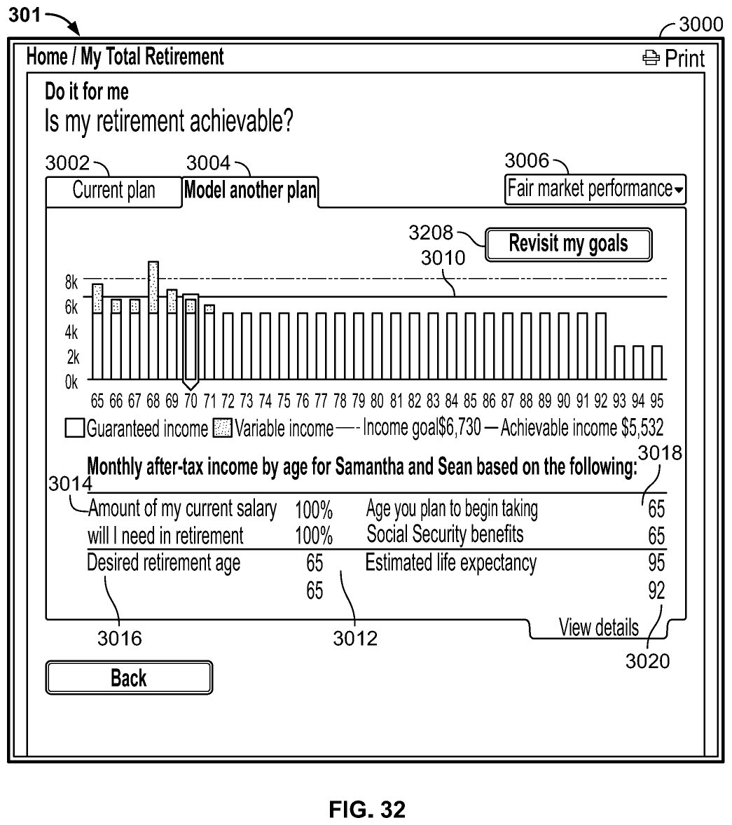

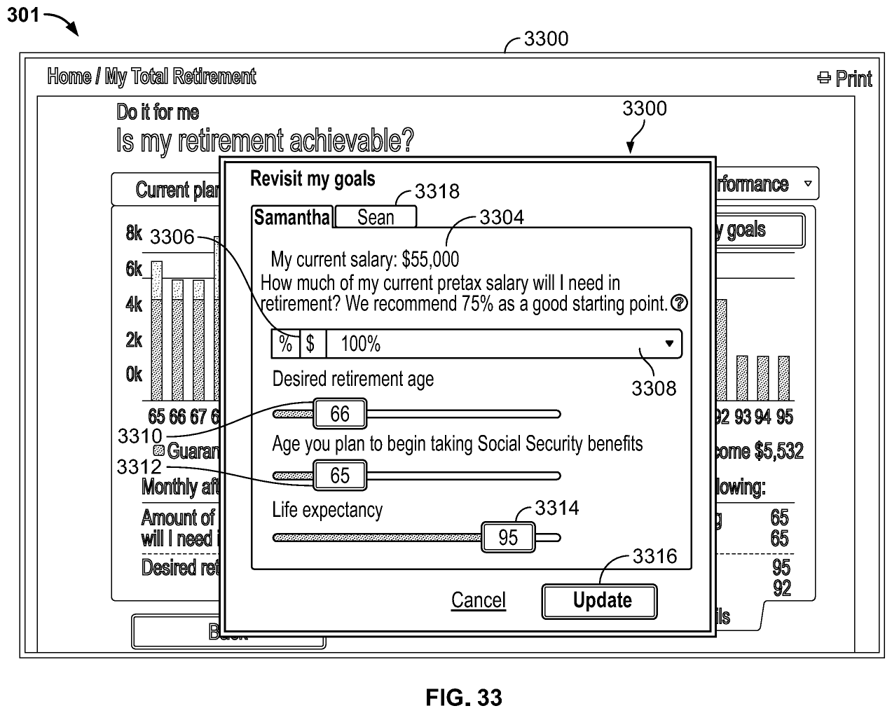

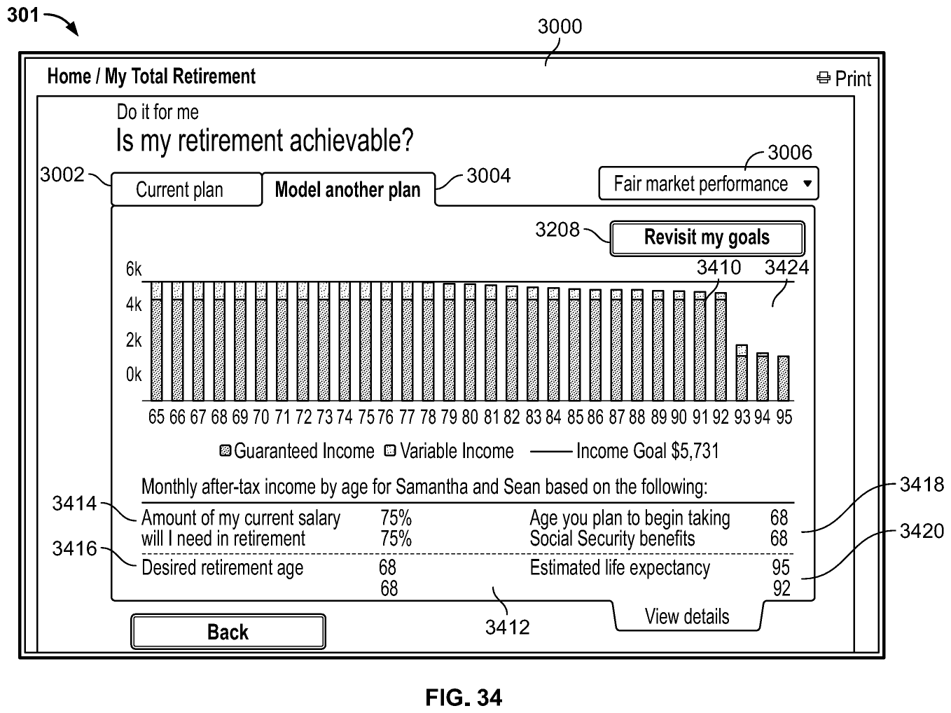

FIG. 32 depicts plan model tab 3004 selected on retirement summary page 3000. A revisit my goals link 3208 allows user 102 to modify financial data such as the retirement year, desired retirement age, and average life expectancy. In response to selection of revisit my goals link 3208, a revisiting goal page 3300 pops up, or overlays, retirement summary page 3000, as discussed with respect to FIG. 33. In other words, revisit my goals link 3208 allows user 102 to override calculated values with customized values for modeling purposes. Any overridden values are substituted for the corresponding income factor when modeling. Plan model tab 3004 initially displays projected retirement income graph 3010 based on current plan data. In response to the user inputting modelling values via revisit my goals link 3208, planning engine 150 generates a model projected retirement income graph 3410 based on the updated financial data (e.g., retirement year, life expectancy), as shown in FIG. 34. Similarly, plan model tab 3004 initially displays income factor information 3012 as described above from current plan tab 3002, and planning engine 150. In the example embodiment, again using the income factors from the database 120 but having the customized model projected income factor from FIG. 33 substituted for the corresponding database factor, the plan model tab 3004 also displays a model income goal line, similar to retirement income goal 3024, and a model average projected annual income, similar to average projected annual income 3026 (e.g., achievable income). In the example embodiment, the database 120 is not updated with the user's modeled values, unless the user takes additional affirmative action to modify the user's profile. Thus, the user is able to graph various scenarios in the plan model tab 3004, and to toggle back to the actual current plan performance on current plan tab 3002 for easy visual comparison against the same type of graph in the same display location, without fear of accidentally changing the actual financial account settings.

More generally, FIGS. 30-32 illustrate an aspect of the present disclosure directed to generating and facilitating comparison of projections generated for a user. FIGS. 30 and 31 illustrate a projection based on currently stored user information. In contrast, FIG. 32 illustrates a projection based on at least a portion of the user information being modified. As noted above, in at least certain implementations, the current and modified projections may be presented on respective tabs, pages, windows, etc., in substantially the same location to facilitate easy comparison.

FIGS. 30-32 also illustrate various aspects of the projections presented in the GUI that may be generalized to other applications and contexts beyond financial planning. Each of the current and modified projections are shown as bar graphs with each bar indicating a projected outcome for a given time period. In the specific example of FIGS. 30-32, the projected outcome is retirement income and is illustrated on a yearly basis. In at least certain implementations, each bar may also be subdivided to show different contributing factors to the projected outcome. For example, the bars in projected retirement income graph 3010 include a first segment corresponding to guaranteed income and a second segment corresponding to variable income.

FIGS. 30-32 also illustrate interactivity of the graphical projections. Specifically, FIG. 31 illustrates how, in certain implementations, individual bars of projected retirement income graph 3010 are selectable to obtain details related to a specific projection time period. As shown in FIG. 31, for example, selecting retirement age 70 provides a breakdown of variable and guaranteed income sources and amounts. Bars in the modified projection of FIG. 32 may be similarly selected to obtain further details for a specific time period.

The foregoing concepts may be readily adapted for use in GUIs outside of financial planning. For example, in the context of health and wellness, GUIs according to this disclosure may provide projections for a health-related outcome, such as weight. The GUI can present projections for a user's weight over time and in subdivisions more relevant to weight loss (e.g., weekly) with each subdivision represented by a suitable graphical element (e.g., a bar). Like the financial planning example, the GUI can provide a first projection based on current user information and a second projection (e.g., on a second tab or window) based on modified user information with the two projections displayed in similar locations for ready comparison.

Also like the financial planning example, each graphical element (e.g., each bar) may be selectable to obtain additional information regarding the corresponding time period. For example, in the context of a weight loss projection, the information presented may include a starting weight, an ending weight, total and/or average caloric intake, total and/or average caloric burn from base metabolism, and total and/or average caloric burn from exercise. Stated differently, each graphical element representing a subdivision of the projection functions as a control to trigger updating of the GUI to present corresponding projection data. In certain implementations, selecting a graphical element may cause the GUI to transmit a call to the planning engine that generated the projection (e.g., via an API for the planning engine), the call including a parameter indicating the projection subdivision of interest (e.g., the retirement year in the context of a financial planning-based implementation). The planning engine may then retrieve or generate the detailed projection data for the subdivision and transmit the data to the GUI for presentation. In another implementation, when the various projections are generated, the planning engine may transmit all underlying data for the projections to the GUI. In response to selection of a specific graphical element, the GUI may retrieve and display the corresponding projection details.

FIG. 33 depicts revisiting goals page 3300, which facilitates user 102 defining a model retirement goal for comparison purposes, by providing financial data such as model replacement income percentage 3308, model retirement age, model social security age, and model life expectancy. User 102 selects what percentage of their current salary 3304 will be needed in retirement using model replacement income percentage 3308. The desired model retirement age and model social security age may be adjusted using sliders 3310 and 3312. For example, user 102 may desire to model the effects of postponing retirement or an early retirement for comparison purposes. Model life expectancy may be adjusted for user 102 with slider 3314. For example, user 102 may reduce their life expectancy to model new health concerns. In certain embodiments, user 102 may define separate model values for their spouse/partner using tab 3318. More specifically, tab 3318 may include the same fields described above, but associated with the spouse of user 102. Update link 3316 is configured to save the updated model financial data, and trigger planning engine 150 to regenerate the model projected retirement income graph 3410 and model projected income factor information 3412 (shown in FIG. 34).

FIG. 34 depicts updated plan model tab 3004. In the example embodiment, updated plan model tab 3004 is generated in response to user 102 providing updated model financial data, such as a model retirement age and estimated life expectancy. Model projected retirement income graph 3410 is regenerated by planning engine 150. In the example embodiment, for modelling purposes, user 102 reduced their retirement income percentage to 75%, indicating they would need only 75% of their current salary. Updated plan model tab 3004 includes the updated model projected income factor information 3412, including the replacement income percentage 3414, and model projected retirement income graph 3410 displays the adjusted retirement goal 3424.

User 102 may also customize the market prediction used to generate values on retirement summary page 3000. For example, user 102 may expect above or below average market growth. Market performance selector 3006 is configured to cause planning engine 150 to regenerate model projected retirement income graph 3410 based on the customized market performance prediction selected by the user. More specifically, market performance selector 3006 may adjust the return rates used by return calculation module 204. For example, user 102 may select poor market performance from market performance selector 3006 to evaluate their ability to retire in poor market conditions. As another example, user 102 may select excellent market performance from market performance selector 3006 to determine if above-average market performance would allow them to meet their retirement goals.

In some embodiments, retirement summary page 3000 including both current plan tab 3002 and plan model tab 3004, with identical formats for projected retirement income graph 3010 and model projected retirement income graph 3410 and identical formats for income factor information 3012 and model projected income factor information 3412, facilitates GUI 301 providing improved functionality for each of comparison of multiple alternate account options to current account settings across a range of potential market conditions.

FIGS. 33 and 34 illustrated the general process by which parameters may be modified to dynamically generate alternative projections for a given user. More specifically, in the illustrated financial planning example, a user is able to model retirement income, retirement age, age at which social security will be taken and life expectancy and the projection illustrated by model projected retirement income graph 3410 is dynamically updated in response. In non-financial planning implementations, similar functionality may be implemented to generate projections based on modifications to current user parameters. For example, in the context of a health and wellness application, a user profile may include actual or current target values for variables such as caloric intake (or other diet-related metrics), exercise frequency, exercise intensity, and sleep. GUI 301 may then present a first graph or similar visualization for a projection of a health-related outcome, such as weight. The user may then modify one or more of the variables such that GUI 301 generates a second graph or visualization including a projection based on the modified variable. The user can then readily compare the two projections to understand the potential impact of the modeled change.

In at least certain implementations, theoretical projections for modeled changes may be generated in real time or near real time. For example, a user may input modified values for one or more parameters and activate a control, such as update link 3316. In response to activating the control, GUI 301 transmits the modified variables to a planning engine which then generates a corresponding projection as described herein albeit with the modified values being used for the relevant fields of any user data relied on by the planning engine to generate the projection. In other implementations, GUI 301 may periodically transmit the modified values to the planning engine or may transmit the modified values in response to triggering events, such as a change in the modified values. In either case, the planning engine may generate and return a corresponding projection for presentation via GUI 301.

Communication between GUI 301 and the planning engine for purposes of generating model projections may occur through an API of the planning engine. For example, when GUI 301 requires an updated projection, GUI 301 may make a call to the API associated with the planning engine including any of the modified variables and their respective values as parameters.

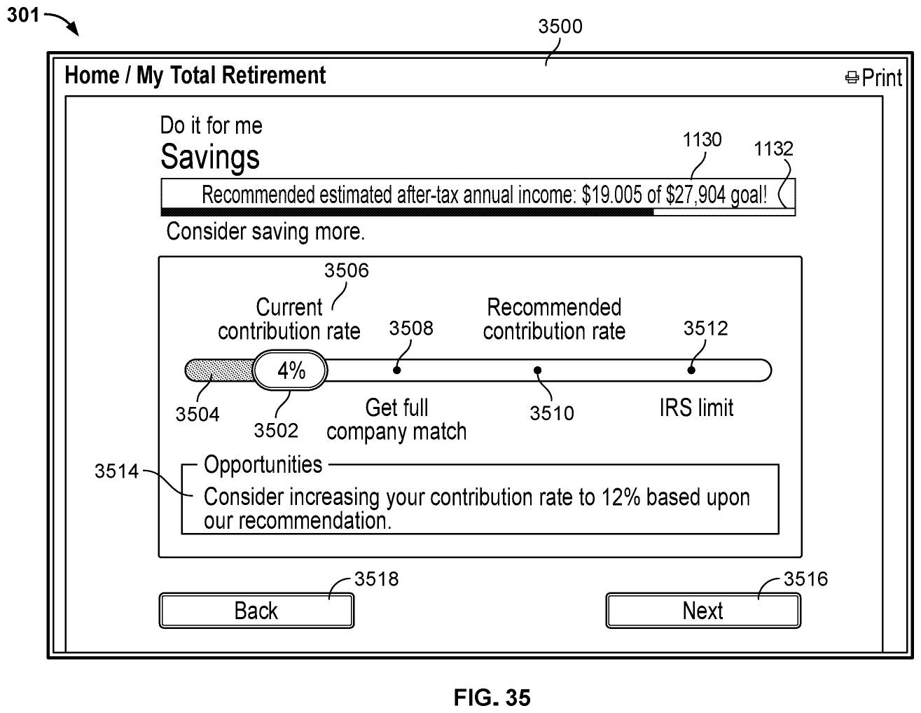

FIGS. 35-41 illustrate an example process for modifying one or more parameters of a current user plan. More specifically, FIGS. 35-40 illustrate modifying a savings rate for a financial/retirement plan while FIG. 31 illustrate modifying retirement goals. The processes illustrated in FIGS. 35-41 may be readily adapted for modifying other financial/retirement plan parameters as well as for modifying parameters for non-financial plans, such as those related to health and wellness or proficiency/skill development.

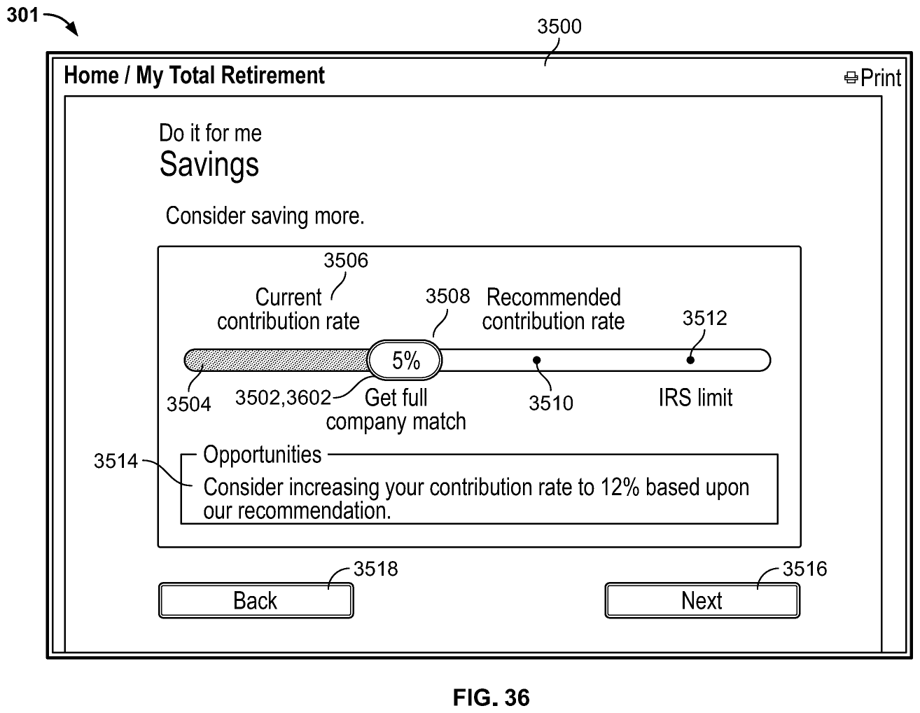

FIG. 35 depicts an example savings rate page 3500 of GUI 301, which may be opened using savings link 1106, and facilitates user input of account data, such as a desired contribution rate, and displays a plurality of contribution rate levels. In the illustrated example, savings rate page 3500 includes a contribution scale 3504 which includes a plurality of contribution rate levels such as a current contribution rate 3506, a company match rate 3508, a recommended contribution rate 3510, and an IRS limit rate 3512. Contribution scale 3504 is a component of a widget which also includes contribution slider 3502. Contribution slider 3502 facilitates interactive input of a desired contribution rate by user 102. Specifically, a user is able to change the location of contribution slider 3502 along contribution scale 3504, wherein a given contribution rate is determined by the position of contribution slider 3502 along contribution scale 3504. Contribution slider 3502 is also configured to display a numeric value (e.g., 4%) corresponding to the contribution rate determined by contribution slider 3502. FIG. 36 illustrates slider 3502 moved to a new location 3602, which, in the example embodiment, increases the contribution rate to 5%.

The plurality of contribution rate levels is dynamically generated and transmitted by planning engine 150 based on the user profile data in database 120. In some embodiments, contributions module 208 (shown in FIG. 2A) generates and transmits the plurality of contribution rate levels. In some embodiments, planning engine 150 and/or contributions module 208 retrieve financial data from a database such as database 120 (shown in FIG. 1) and use the financial data to generate at least one of the plurality of contribution rate levels. Current contribution rate 3506 is based on contribution data collected from user 102 or from the employer as a financial data source. Company match rate 3508 is based on contribution and or benefits data collected from user 102. Recommended contribution rate 3510 is generated by planning engine 150, in some cases by contributions module 208, based on user profile data and account data, such as age, salary, asset data, and financial goals. IRS limit rate 3512 is based on user profile data, account data, and financial data retrieved from database 120 or financial data sources 116 (shown in FIG. 1).

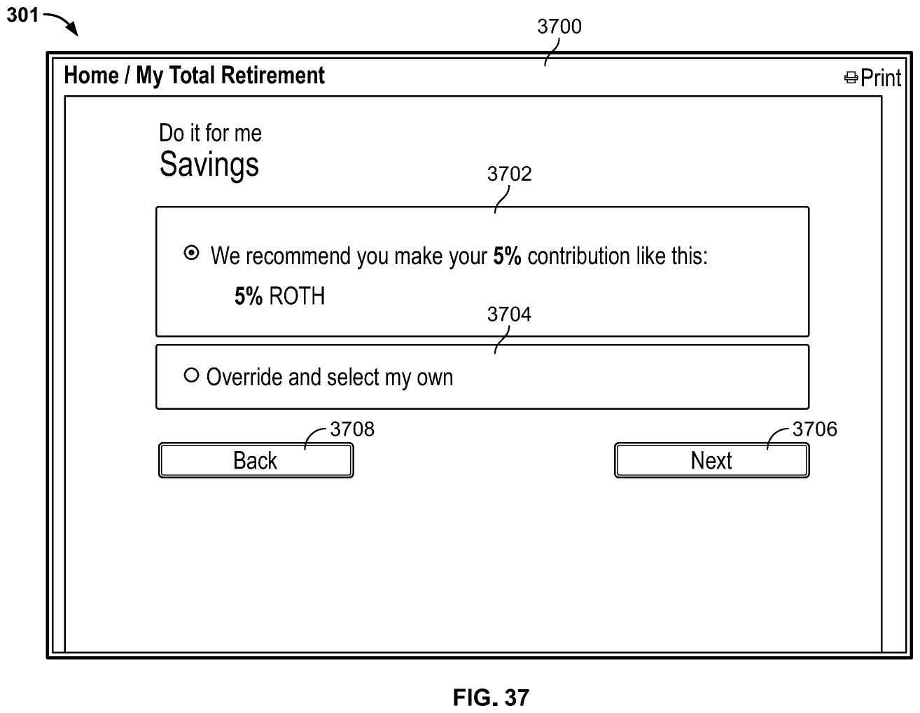

Savings rate page 3500 is also configured to display an opportunities alert 3514, which is generated by planning engine 150 based on user profile data and account data, such as financial goals and contribution data. In some embodiments, opportunities alert 3514 is generated by contributions module 208. Savings rate page 3500 is also configured to facilitate the transmission of a desired contribution rate through continuation request 3516. Continuation request 3516 is also configured to facilitate user access to another webpage, such as savings type page 3700 (shown in FIG. 37). Alternatively, the changes on savings rate page 3500 may be discarded using back request 3518.

FIG. 37 depicts an example savings type page 3700 of GUI 2001, which may open automatically in response to selecting a savings contribution using savings rate page 3500. In the example embodiment, savings type page 3700 facilitates user selection of the type of account(s) (e.g., savings type) to which the user's savings contributions will be divided. The options include a recommended contribution type 3702, which is generated and transmitted by planning engine 150 based on user profile data, account data, and financial data, such as age, financial goals, assets, and contribution data. For example, based on user 102's age, financial goals, and desired contribution rate, planning engine 150 may determine that an entire desired contribution rate (e.g., savings rate) of 5% should be contributed to a Roth IRA. In some embodiments, contributions module 208 (shown in FIG.) generates the recommended contribution account type. The options also include a manual contribution type 3704, which facilitates the manual selection by user 102 of specific account types for the savings contribution.

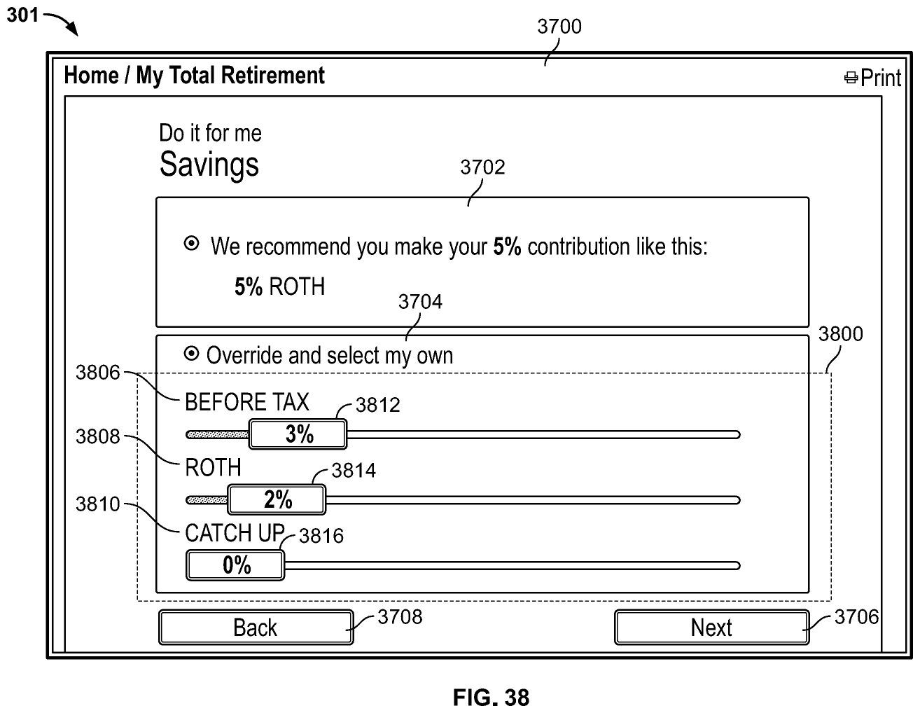

FIG. 38 depicts savings type page 3700 enlarged to include an example manual selection region 3800 in response to selection of manual contribution type 3704. In the example embodiment, manual selection region 3800 facilitates the manual selection of specific account types for the user's savings contribution. More specifically, manual selection region 3800 is configured to display a plurality of account types, such as account types 3806, 3808, and 3810. For example, account type 3806 may represent a “Before Tax” account, account type 3808 may represent a “Roth” account, and account type 3810 may represent a “Catch Up” account. Manual selection region 3800 is also configured to display contribution sliders 3812, 3814, and 3816 to facilitate receiving contribution rates from user 102 for the respective account types.

Savings type page 3700 is also configured to facilitate the transmission of contribution preferences and selected contribution account types through continuation request 3706. Continuation request 3706 is further configured to facilitate access to another webpage, such as contribution review page 3900. Alternatively, back button 3708 may be selected to discard changes.

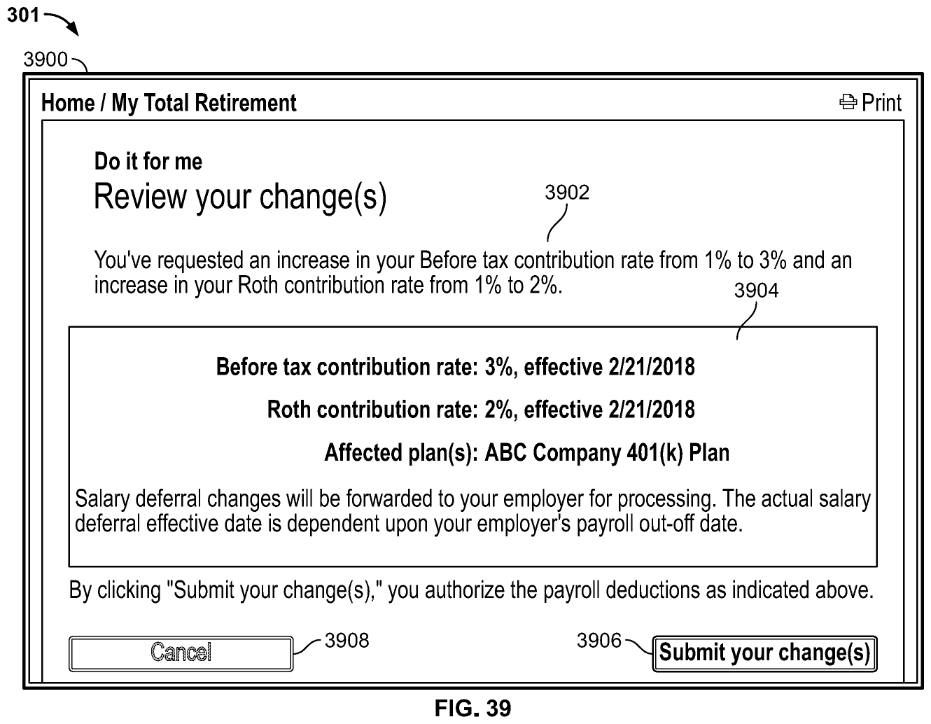

FIG. 39 depicts an example contribution review page 3900 of GUI 301, which displays a summary of changes made to a user's 102 contribution preferences via pages 3500 and 3700 and receives user input confirming the changes from a submit changes button 3906.

Contribution review page 3900 is configured to display a requested change summary 3902, which contains indications for previous contribution preferences and updated contribution preferences, based on changes made by user 102. Contribution review page 3900 is further configured to display change detail 3904. Change detail 3904 includes information detailing the updated contribution preferences which will be applied to a given account.

Contribution review page 3900 is also configured to facilitate access to another webpage, such as contribution confirmation page 4000, through submit changes button 3906. Alternatively, the changes may be discarded using cancel button 3908.

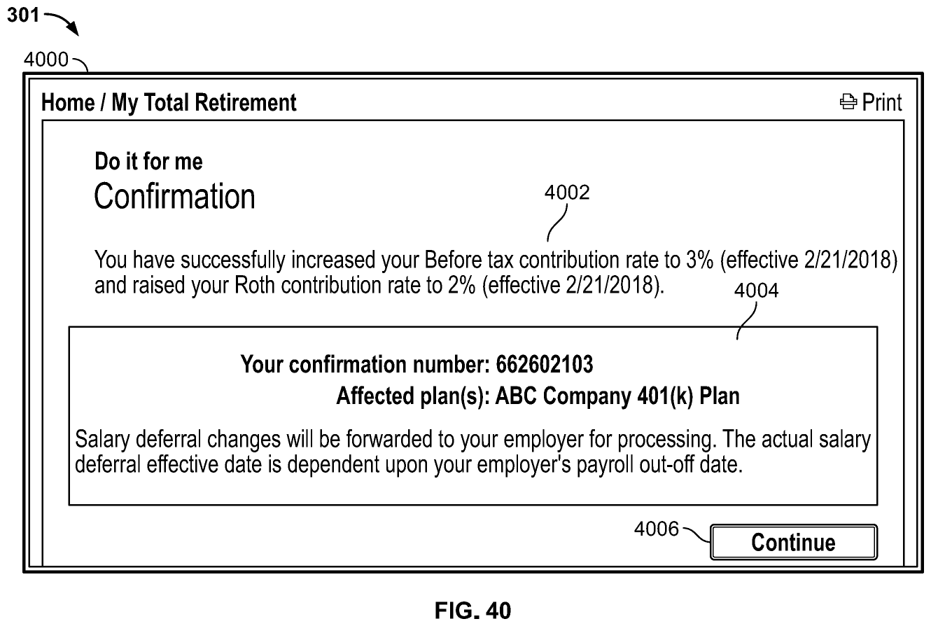

FIG. 40 depicts an example contribution confirmation page 4000 of GUI 301, which displays a confirmation notice of changes made to a user's 102 contribution preferences in response to selection of submit changes button 3906.

Contribution confirmation page 4000 is configured to display confirmed change 4002, which contains indications for previous contribution preferences and updated contribution preferences, based on changes made by user 102. Contribution confirmation page 4000 is further configured to display confirmation summary 4004. In the illustrated example, confirmation summary 4004 includes a confirmation number and an account which is affected by the changes to contribution preferences.

Contribution confirmation page 4000 is also configured to facilitate access to another webpage, such as savings goal page 4100, through continue request 4006.

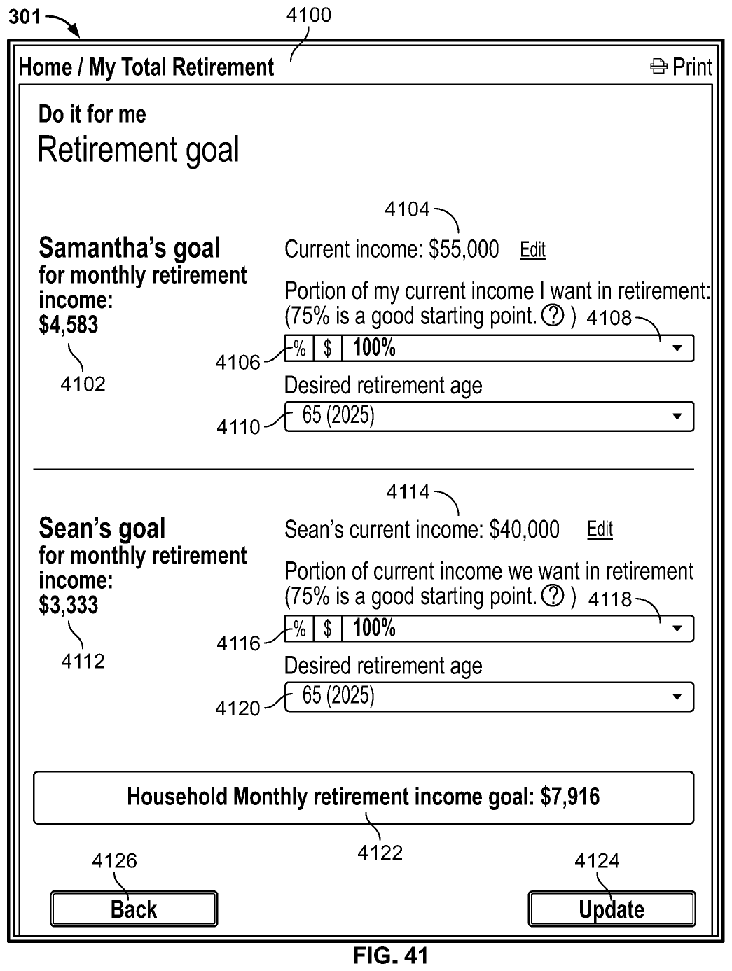

FIG. 41 depicts an example savings goal page 4100 of GUI 301, which may be opened using retirement goal link 1102, and which displays financial information related to a user 102's financial goals. In the illustrated example, savings goal page displays financial information related to user 102's retirement goals and facilitates the input of user profile data and account data, such as financial goals and retirement age.

Savings goal page 4100 is configured to display user goal 4102 and spouse goal 4112. User goal 4102 and spouse goal 4112 are generated by planning engine 150 based on user profile data and account data such as current income, such as user current income 4104 and spouse current income 4114, and retirement income goals, such as desired user retirement income amount 4108 and desired spouse retirement income amount 4118. In the illustrated example, based on user current income 4104, spouse current income 4114, and desired retirement income amounts 4108 and 4118, planning engine 150 calculates a monthly retirement income, displayed as user goal 4102 and spouse goal 4112. Savings goal page 4100 is also configured to accept user input defining retirement income format for the user and spouse via format inputs 4106 and 4116. In the example embodiment, format inputs 4106 and 4116 are set to “%”, such that the desired retirement income amounts 4108 and 4118 are entered as a percentage of respective current incomes 4104 and 4114. In an alternative embodiment, format inputs 4106 and 4116 are set to “$”, such that the desired retirement income amounts 4108 and 4118 are entered as an absolute dollar amount. Savings goal page 4100 is also configured to display a household income goal 4122, based on user goal 4102 and spouse goal 4112.

Savings goal page 4100 is configured to facilitate the transmission of updated savings goals by accepting user changes using an update request 4124. Update request 4124 is also configured to facilitate access to another webpage, such as dashboard 1100 (shown in FIG. 11A). Alternatively, changes may be discarded using back button 4126.

In certain implementations, systems according to this disclosure may be configured to provide online advice services to users. For example, in the context of the example financial planning system, users may register for online advice through an enrollment page (not shown) (e.g., via online advice link 812 of FIG. 8A), or may otherwise access the online advice through the “Help Me Do It” link 864 on informational page 850 (shown in FIG. 8C). The user may enter or edit profile data via the about me page 1200 (shown in FIG. 12).

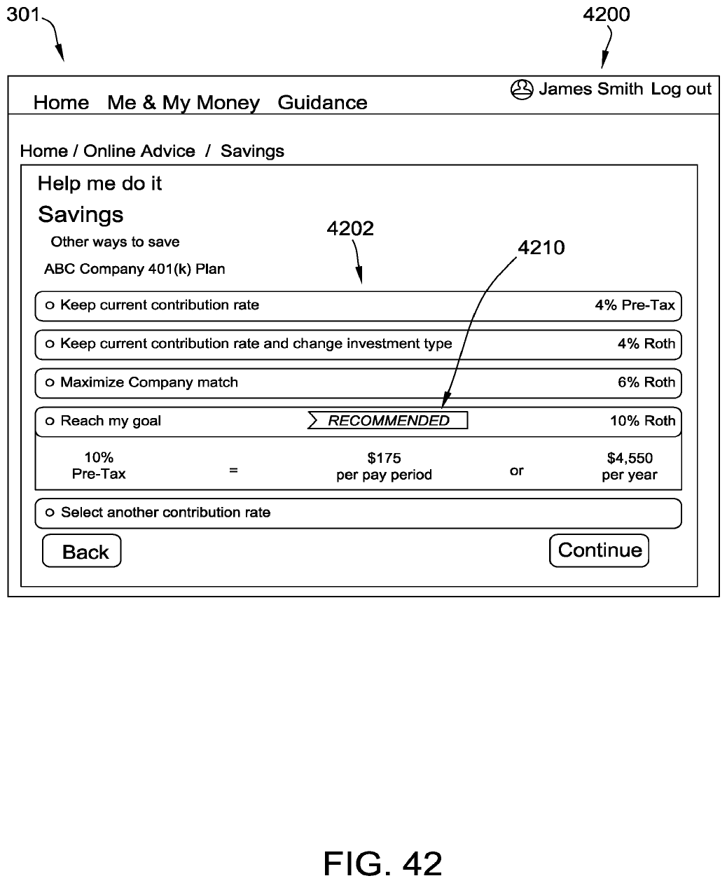

In addition to or as an alternative to registering for online advice, the system may be configured to present recommendations to users. By way of example, FIG. 42 depicts an alternative illustrated example of savings rate page 3500, here designated savings rate page 4200. In some embodiments, savings rate page 4200, rather than savings rate page 3500 (shown in FIG. 35), is caused to be displayed by selection of savings link 1106 (shown on the dashboard 1100 of FIG. 11A or the dashboard 1150 of FIG. 11B) or by selection of a jump link in opportunity area 1126. Savings rate page 4200 presents a series of savings rate and savings type (e.g., tax-deferred or non-tax-deferred contributions to a 401(k) plan) options similar to savings rate page 3500, but in an alternative user-friendly format.

In some embodiments, GUI computer system 114 identifies a 401(k) plan of the user and analyzes the plan data against the user's current profile in database 120 to identify any of four savings options 4202 that may be applicable for the user: (A) maintaining a current contribution rate; (B) maintaining a current savings rate but changing a current savings type (i.e., change investment type) (e.g., to Roth IRA), (C) maintaining a current savings type but changing a current savings rate to equal a company match rate (e.g., increase the current savings rate to “maximize” the user's benefit from the company match policy if the user is currently not taking advantage of company match rate), or (D) changing the current savings rate to reach a user goal. The GUI computer system 114 dynamically determines which of these options are relevant to the user and causes to be displayed on savings rate page 4200 (or, alternatively, savings rate page 3500) the relevant savings options as options from which the user may select. For example, if the user's current savings type (i.e., pre-tax versus Roth contributions) is already optimal for the user's situation, the “change investment type” option is not displayed. For another example, if the user's contribution rate already meets or exceeds the company match rate, the “maximize company match” option is not displayed. For another example, if the user's contribution rate and type already enable the user's projected income in retirement to meet the user's goal, the “reach my goal” option is not displayed. The option for the user to manually enter a user-selected savings rate and type is also provided and is presented as the final option in the dynamically generated list. The savings functionality allows participants to view their current savings strategy and view savings recommendations for all accounts that are enrolled in enhanced services.

More generally and regardless of whether a given application is related to financial planning or some other field (e.g., health and wellness planning, education/proficiency/skill development planning), implementations of this disclosure may include functionality for dynamic presentation of opportunities and recommendations to users. As noted above, the process for presenting a list of opportunities or recommendations may include accessing a predetermined and ordered list of recommendations or modifications and determining what, if any of the items in the predetermined list have already been implemented by the user. The GUI may be subsequently updated to display only recommendations or opportunities that have not already been implemented by the user. In certain implementations, the items presented may be limited in various ways. For example, only a top recommendation/opportunity or top three recommendations/opportunities may be presented in the GUI. As another example, only recommendations that fall within a certain change threshold (e.g., changes that are not too extreme) may be presented. Each recommendation/opportunity may be presented in conjunction with a corresponding control for opening/accessing a portion of the GUI for implementing the recommendation/opportunity.

As shown in FIG. 42, non-limiting examples of recommendations/opportunities may include modifying a contribution rate and modifying an investment type. Other non-limiting examples may include changing an account type (e.g., changing from a conventional 401(k) to a Roth 401(k) or vice versa) or changing an investment strategy (e.g., conservative v. aggressive).

Notably, systems according to this disclosure may have multiple predetermined lists of recommendations/opportunities, each of which may correspond to specific aspects of the user's plan. The system may include a single overarching list of recommendations/opportunities but may also include lists specifically directed to certain aspects of a user's plan. For example, in a GUI directed to a health and wellness plan, the system may have a list of general recommendations such as increasing exercise, decreasing caloric intake, and increasing sleep. The system may also have recommendations specific to a given area. For example, regarding exercise, the system may have a list of recommendations related to frequency of exercise, intensity of exercise, type of exercise, and the like. Notably, in at least certain implementations the GUI and/or planning engine are configured to access and present recommendations and opportunities contextually. For example, when a user is in an overview or summary page, the GUI and/or planning engine may cause recommendations generated from a list of general recommendations to be presented; however, if the user accesses a portion of the GUI directed to a more specific aspect of a plan, the GUI and/or planning engine may cause recommendations generated from a more specific list to be presented.

One problem with conventional recommendation systems is the generation of too many recommendations that overwhelm the user, recommendations that are too complex for the user to grasp, or recommendations that result in changes that appear extreme to the user. Accordingly, certain aspects of the present disclosure are directed to identifying and presenting dynamically tailored lists of recommendations and opportunities to users. By way of example, the dynamic generation and display of relevant savings options on savings rate page 4200 provides the user with incremental, easily understood options for improving the user's income in retirement.

As discussed above with respect to dashboard 1100 or 1150, in some embodiments, GUI computer system 114 includes an opportunity rules engine configured to analyze the profile data of the user and identify recommendations for the user based on the user profile data, and without calling the at least one planning engine 150 to directly evaluate the candidate modifications. In some embodiments, the opportunity rules engine operates on a predetermined ordered list of candidate modifications that have been proved to be incremental, easily accepted ways to improve users' ability to meet retirement goals. The opportunity rules engine is programmed to identify, based on the respective user profile and without calling the at least one planning engine 150 to directly evaluate the candidate modifications, one of the candidate modifications that is not considered to be an “extreme” change from the value currently in the user profile and is likely to benefit the user, and to display in opportunity area 1126 a message recommending the identified candidate modification, and an associated jump link to a page of GUI 301 enabling the respective user to execute the identified candidate modification. In some embodiments, by identifying and displaying only a single, incremental modification, GUI 301 increases a likelihood the that the user will consider and adopt the recommendation. Additionally, or alternatively, by providing a jump-link directly to a page of GUI 301 that enables the user to execute the recommendation, GUI 301 further increases a likelihood the that the user will adopt the recommendation.

Examples that may be included in the ordered list of candidate modifications include changes to the savings rate and savings type of the user's contributions to the financial account (which may include options similar to the dynamically generated options listed above), as well as addition of profile data for fields which the user has not yet entered data (e.g., replacing null values for the user in the “other assets” or “family information” fields of database 120). It should be noted that whether or not the user is currently reaching the user's goal is known from an initial call to planning engine 150 to obtain the numbers needed for estimated income widget 1130, but the other potential candidate modifications to savings rate and type are evaluated by the opportunities rules engine without calling planning engine 150. The opportunity rules engine may identify the candidate from the ordered list by selecting a first candidate modification in the ordered list and determining whether the selected candidate modification has been implemented in the user profile. If the selected candidate modification has been implemented, the opportunity rules engine skips that candidate modification and selects the next candidate modification from the ordered list. In some embodiments, if the selected candidate modification has not been implemented, the opportunity rules engine identifies the candidate modification for display in the opportunity area 1126. In other embodiments, if the selected candidate modification has not been implemented, the opportunity rules engine compares the candidate modification to a current value of at least one associated data field in the user profile, and evaluates (e.g., based on a look-up table in database 120) whether the candidate modification would be classified as an “extreme” change relative to the current value. If the candidate modification is not extreme, the opportunity rules engine identifies the selected candidate modification for display. If the candidate modification is determined to qualify as “extreme,” the opportunity rules engine skips that candidate modification, selects the next candidate modification from the ordered list, and repeats the process.

For example, in the context of savings rate page 4200, the opportunity rules engine is configured to analyze the profile data of the user and identify one of the savings options as a savings recommendation 4210. The list of savings options may be sorted into an ordered list of candidate modifications for the user based on the user profile data and without calling the planning engine 150. In the example embodiment, the savings recommendation 4210 is further identified on the savings rate page 4200 with a “RECOMMENDED” flag. In some embodiments, the savings recommendation 4210 may be presented on the dashboard 1100 in opportunity area 1126. When the user selects the opportunity area 1126 from the dashboard 1100, or in some cases a highlighted portion of the message displayed in opportunity area 1126, the opportunity area 1126 acts as a jump link, causing the savings rate page 4200 to be displayed to the user along with the savings recommendation 4210 flagged as shown in FIG. 42.

As discussed above, in some embodiments, the user profile includes family information fields for the user (e.g., spousal data, dependents data) and the ordered list of candidate modifications includes replacing null values for the respective user in the family information field. Further, the opportunity rules engine may provide a jump link associated with the candidate modification that allows the user to bypass the user profile summary page and go directly to the family information fields to replace the family information fields.

In some embodiments, the ordered list of candidate modifications includes a sequence of candidate savings modifications including maintaining a current savings rate and changing a savings type, changing the current savings rate to equal a company match rate, and changing the current savings rate to meet the user goal. Each candidate modification may include a jump link that links to savings rate page 3500, allowing the user to change the savings rate directly. The savings rate page 3500 may include the opportunity area, wherein after activation of the jump link, the message is propagated to the opportunity area of the savings rate page 3500.

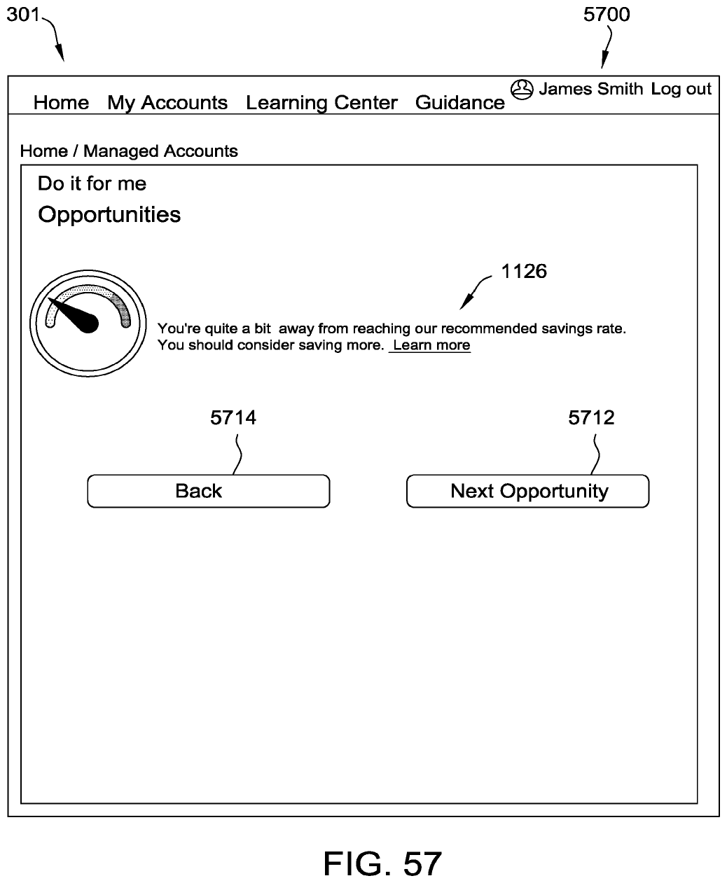

In some embodiments, the opportunity link 1114 causes the opportunity rules engine to execute an opportunities flow process. FIG. 57 depicts an example opportunities page 5700 that allows the user to step through an ordered list of opportunities identified by the opportunity rule engine. The opportunities page 5700 displays one of the identified opportunities of the list within the opportunity area 1126 and provides a back link 5714 and a next-opportunity link 5712 that allows the user to step through the sequence. In the illustrated example, the opportunities flow includes the following steps in sequence: (i) selecting the first candidate modification in the ordered list; (ii) determining whether the selected candidate modification has been implemented in the user profile; (iii) if the selected candidate modification has been implemented, selecting the next candidate modification from the ordered list and returning to step (ii); (iv) if the selected candidate modification has not been implemented, displaying (a) the message recommending the identified candidate modification (e.g., in opportunity area 1126), (b) the associated jump link (e.g., “Learn more”, as shown in FIG. 57), and (c) a next-opportunity link 5712; (v) in response to activation of the next-opportunity link 5712, selecting the next candidate modification from the ordered list and returning to step (ii); and (vi) in response to activation of the jump link, exiting the opportunities flow process.

In some embodiments, the planning engine 150 determines a projected retirement income based on a savings rate and an assumed savings type being tax-deferred. The planning engine 150 may re-determine the projected retirement income based on the savings rate and a non-tax-deferred savings type. The GUI 301 may include in the list of savings options 4202 a “change type” selector enabling the user to maintain the savings rate value and update the savings type to tax-deferred or non-tax-deferred in response to the savings type being the other of tax-deferred and non-tax-deferred. The planning engine 150 may further determine a goal-based savings rate and a goal-based savings type, where the goal-based savings rate and the goal-based savings type are determined based on a minimum savings rate that enables the respective user to meet the user's goal.

In some embodiments, the GUI 301 may include in the list of savings options 4202 a goal-based selector enabling the user to update the savings rate to a goal-based savings rate and the savings type to the goal-based savings type. In some embodiments, the GUI may compare the savings rate to a maximum company-match value associated with the financial plan and, in response to determining that the savings rate is less than the company-match value, include a company-match selector enabling the user to update the savings rate to the maximum company-match value. In some embodiments, the GUI 301 may include a user-choice selector in the list of savings options 4202 that enables the user to input a new value for the savings rate. In some embodiments, in response to receiving the updated savings rate, the planning engine 150 determines a projected updated retirement income based on the updated savings rate and the assumed savings type being non-tax-deferred and re-determines the projected updated retirement income based on the new savings rate and the assumed savings type being non-tax-deferred. In response to the savings type being one of tax-deferred or non-tax-deferred and the projected updated retirement income being higher for the assumed savings type being the other of tax-deferred and non-tax-deferred, the GUI 301 displays to the user a recommendation to update the savings type field to the other of the tax-deferred and non-tax-deferred type. In some embodiments, displaying the list of savings options 4202 (and associated selectors) includes displaying the savings options 4202 in a hierarchical order corresponding to a degree of change of the savings rate, and wherein the company-match selector appears after the change-type selector, the goal-based selector appears after the company-match selector, and the user-choice selector appears after the goal-based selector. In some embodiments, the savings options 4202 include a no-change selector that allows the user to maintain the current savings rate and savings type. The no-change selector may appear before the change-type selector. In some embodiments, displaying the list of savings options 4202 includes displaying the goal-based selector as a default selection. In some embodiments, the GUI 301 displays a review screen in response to the user selecting one of the savings options 4202. The review screen may include a submit-changes link operable to execute the selected updates in the user profile and a cancel-changes link operable to maintain the savings rate and savings type.

While the foregoing discussion focuses on a financial planning implementation, the general concepts regarding dynamic and intelligent presentation of recommendations and opportunities to users may be readily adapted to other applications and other GUIs. In general, systems according to the present disclosure may include one or more opportunity rules engines configured to identify opportunities for presentation to users. A given opportunity rules engine is configured to receive user profile data or other data related to a user's plan and based on the received data, determine potential areas for improvement for the user's plan.

As discussed above, systems according to this disclosure may include planning engines that provide projected outcomes for a given plan. In short, the planning engines receive user-related data and output predicted outcomes over a future time span. The scope and complexity of such projections may vary; however, the process of generating a given projected outcome can be computationally intensive, particularly when generating projected outcomes involves executing one or more simulations. While the system could rely on planning engines to test various modifications to a user's plan and provide recommendations based on the corresponding predicted outcomes, doing so may be prohibitively costly in terms of computing resources and time.

The opportunity rules engine provides an effective yet less computationally intensive alternative to simulating outcomes of plan modifications for providing recommendations to users. More specifically, opportunity rules engines according to this disclosure traverse through lists of predetermined and prioritized plan modifications without simulating the outcomes of each modification and determine which, if any, of the list items have not been implemented by the user. For example, the opportunity rules engine may compare a value in a field of user profile data with a corresponding value for a recommendation in the prioritized list. If the value in the user profile data meets or exceeds the recommended value, the opportunity rules engine analyzes the next item in the list. If, on the other hand, the value is below that of the recommended value, the opportunity rule flags or otherwise identifies the recommendation for presentation to the user.

In certain implementations, the opportunity rules engine may be configured to identify a certain number of recommendations (including only one recommendation) for presentation to the user and may stop after reaching that threshold.

The opportunity rules engine can be configured to identify and exclude any recommendations that may be considered too extreme for the user. Whether a given change is considered extreme may be determined, for example, by a relative or absolute change between a current field value in the user profile data and a recommended value. For example, a recommendation in the financial planning context may be to have a contribution rate of 10%; however, the user profile data may indicate that the user's current rate is only be 3%. Given that increasing the contribution rate would more than triple the user's current contributions and substantially impact the user's income, the opportunity rules engine may consider such a change to be too extreme. As another example, a recommendation may be considered too extreme when taking other data in the user profile data into account. In the health and wellness context, for example, user profile data may indicate that a user exercises three times a week. Even though the opportunity rules engine may determine that exercising five times a week would be beneficial to the user, other user profile data may indicate that the user has a full-time job and a family with young children, strongly implying that the user's time is limited and increasing to five workouts a week may not be feasible.

When the opportunity rules engine determines a recommendation is too extreme for a user, it may exclude the recommendation for presentation to the user or present it to the user within the GUI indicating the extremity of the change and its potential impacts. Alternatively, a given recommendation may have multiple tiers or levels and the opportunity rules engine may opt to present a lower tier/level to the user. Referring back to the contribution rate example, a 10% contribution rate may be a preferred contribution rate; however, the contribution rate recommendation may include alternative tiers or levels of 7.5% or 5%. Accordingly, if the opportunity rules engine determines a 10% contribution rate would exceed the threshold for being an extreme change for the user, the opportunity rules engine may evaluate whether a 7.5% contribution rate would fall within the corresponding threshold. In certain implementations, a recommendation may have a minimum value. If a 7.5% contribution rate is still considered too extreme, the opportunity rules engine may evaluate a 5% contribution rate. The 5% contribution rate may be a floor value below which the opportunity rules engine excludes the particular recommendation for presentation to the user. Alternatively, the 5% contribution rate may correspond to a default value that is presented to the user even if it is considered to be an extreme change from current user profile data based on the corresponding threshold.

As previously discussed herein, implementations of the present disclosure may present one or more suitable recommendations identified by the opportunities rules engine to a user via the GUI. In certain implementations, multiple recommendations may be presented simultaneously simultaneously with a highest ranked recommendation indicated by a corresponding visual element (e.g., a banner indicating “recommended”, a star or similar icon, etc.). A recommendation may also be accompanied by corresponding text describing the recommendation or explaining the recommendation in further detail. A recommendation may also be accompanied by a dynamic control that, when activated, causes the GUI to open a page or similar portion of the GUI for implementing the recommendation. For example, in certain implementations, recommendations are presented as interactive list items that can be selected to open a corresponding portion of the GUI for implementing the recommendation.

Referring specifically to FIGS. 11A and 11B, in at least certain implementations portions of the GUI include a dynamic “opportunities” or “recommendations”, such as opportunity area 1126. As shown in FIGS. 11A and 11B, opportunity area 1126 includes dynamically generated text that includes a jump link or similar control for directing a user to different portion of the GUI. Accordingly, in response to a page including opportunity area 1126 being loaded, the GUI may update each of the text and the jump link based on a top recommendation identified by the opportunity rules engine. In the specific example of FIGS. 11A and 11B, the text in opportunity area 1126 is updated to indicate that the user has not provided all information regarding external accounts. The term “other accounts” is also presented as a jump link that, when clicked or selected by the user, opens a corresponding page of the GUI for the user to provide additional details regarding other (e.g., external) accounts of the user relevant to financial/retirement planning.

The following disclosure provides additional details regarding other elements and portions of GUI 301. As previously discussed, the illustrative example of the present disclosure is directed to financial planning and, as a result, the following discussion focuses on aspects of a GUI intended to facilitate financial planning. Nevertheless, aspects of the GUI described below and included in the remaining figures may be readily adapted to other contexts and applications, such as those related to health and wellness and proficiency/skill development.

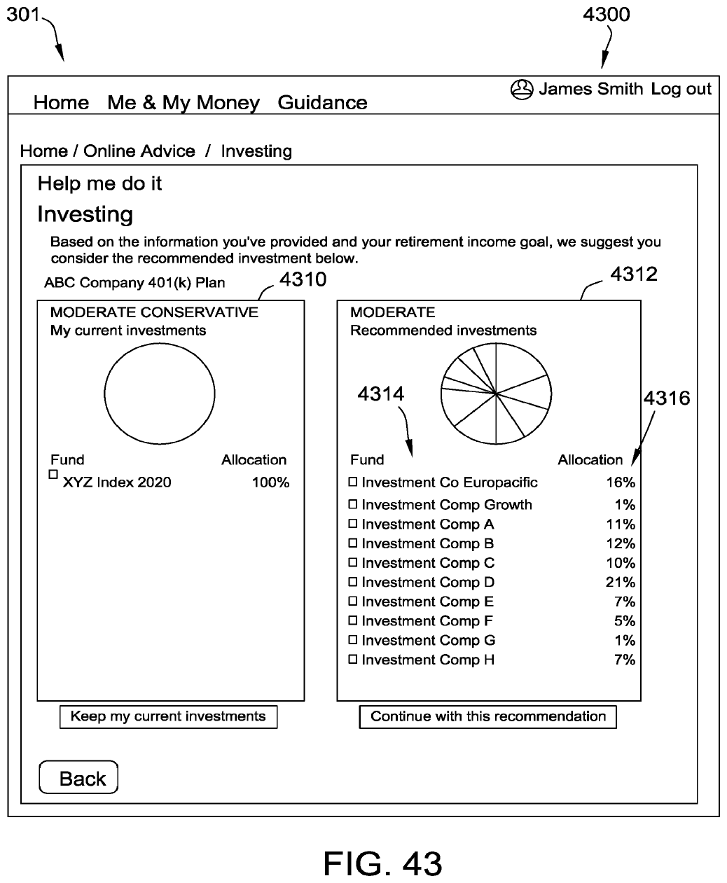

FIG. 43 depicts an illustrative investment advice page 4300 that may be provide as a part of online advice services to a user. Once the user has completed the savings rate page 4200, either by selecting a new option or continuing with their existing savings rate, the user is next presented with the investment advice page 4300. The investment advice page 4300, in the example embodiment, analyzes the user profile data to generate investment recommendations. The investment advice page 4300 includes a current investment section 4310 illustrating funds in which the user is currently invested, as well as a current investment risk level (e.g., “moderate conservative”). The investment advice page 4300 also includes an investment recommendations section 4312 that illustrates a recommended risk level (e.g., a change to “moderate”) as well as a list of recommended investments 4314 and recommended allocations 4316 (e.g., shown here as percentages). In some embodiments, the recommended allocations 4316 are provided by the planning engine 150 or a third-party service similar to the planning engine 150 configured to analyze user profile data and generate such recommendations.

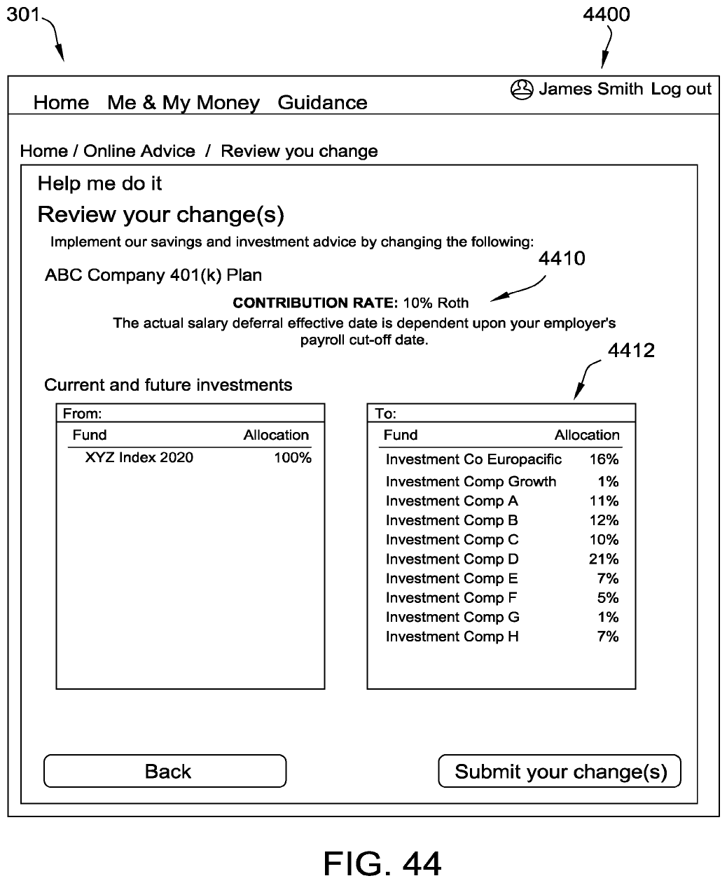

FIG. 44 depicts a change review page 4400. If the user chooses to continue with the recommended allocations 4316, the opportunity rules engine displays the change review page 4400 to the user. The change review page 4400, in the example embodiment, includes a savings change summary 4410 and an investment change summary 4412 for review by the user. The savings change summary 4410 displays any change to savings selected by the user on the savings rate page 4200. The investment change summary 4412 displays any change to investments selected by the user on the investment advice page 4300.

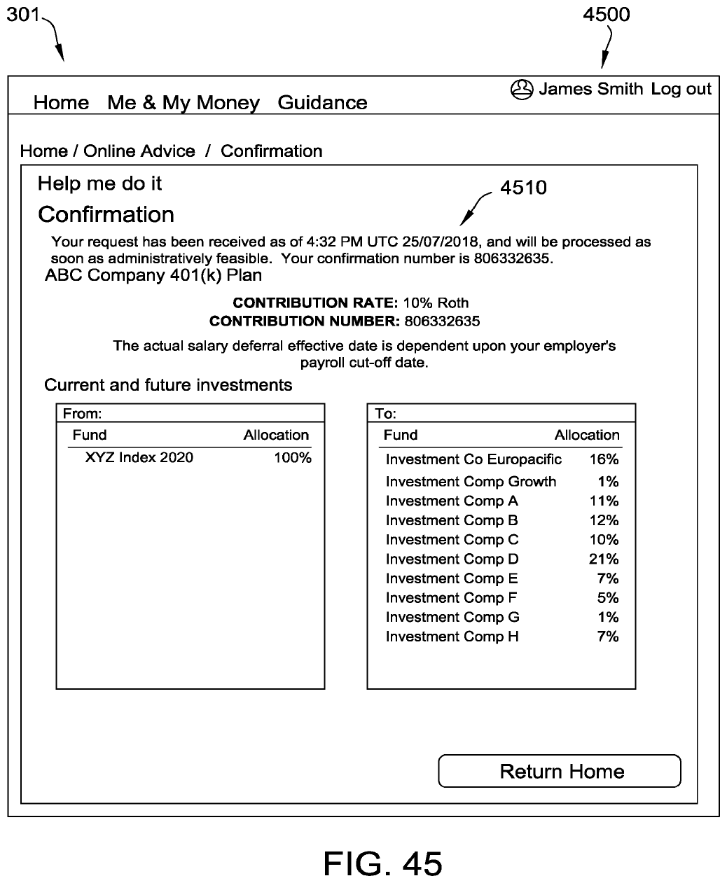

FIG. 45 depicts a confirmation page 4500. After the user submits the changes from the change review page 4400, the opportunity rules engine submits the portfolio changes and displays confirmation information 4510 to the user for summary and record keeping purposes.

FIG. 46 depicts a social security page 4600 that allows the user to identify at what age they intend to begin taking Social Security benefit.

FIG. 47 depicts a social security benefits page 4700 that illustrates social security benefits calculations for the user based on retirement age.

FIG. 48 depicts an institution selection page 4800 that allows the user to identify a third-party institution which may manage other investments of the user, and for which auto-linking of the user's third-party account information is available.

FIG. 49 depicts an account link page 4900 that allows the user to identify information about a linked account identified via the institution selection page 4800.

FIG. 50 depicts an add asset page 5000 that allows the user to add a retirement asset to their portfolio.

FIGS. 51A and 51B depict asset configuration pages 5100, 5110 that allows the user to configure assets.

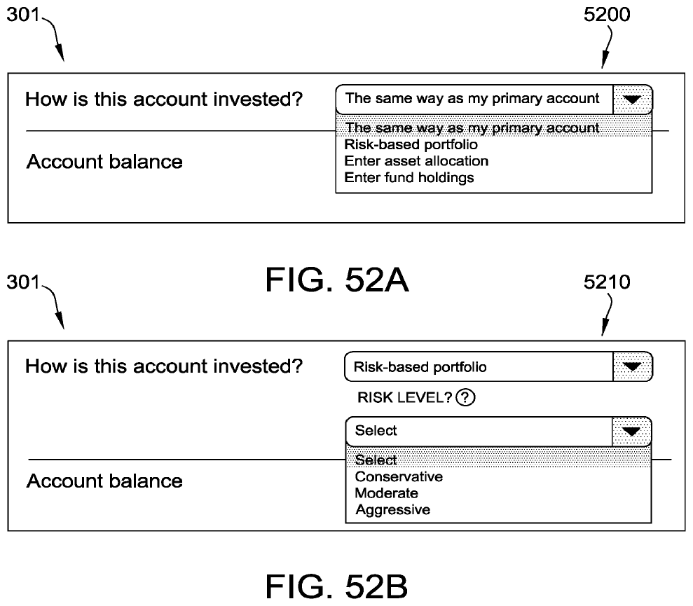

FIGS. 52A and 52B depict account configuration pages 5200, 5210 that allows the user to configure accounts.

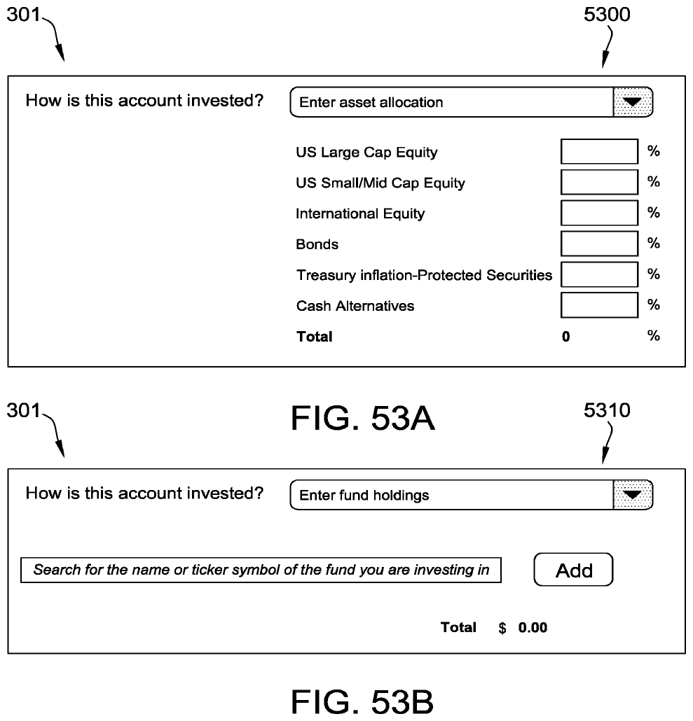

FIGS. 53A and 53B depict account configuration pages 5300, 5310 that allows the user to configure accounts.

FIG. 54 is an other-assets summary page 5400 that allows the user to add and view their accounts.

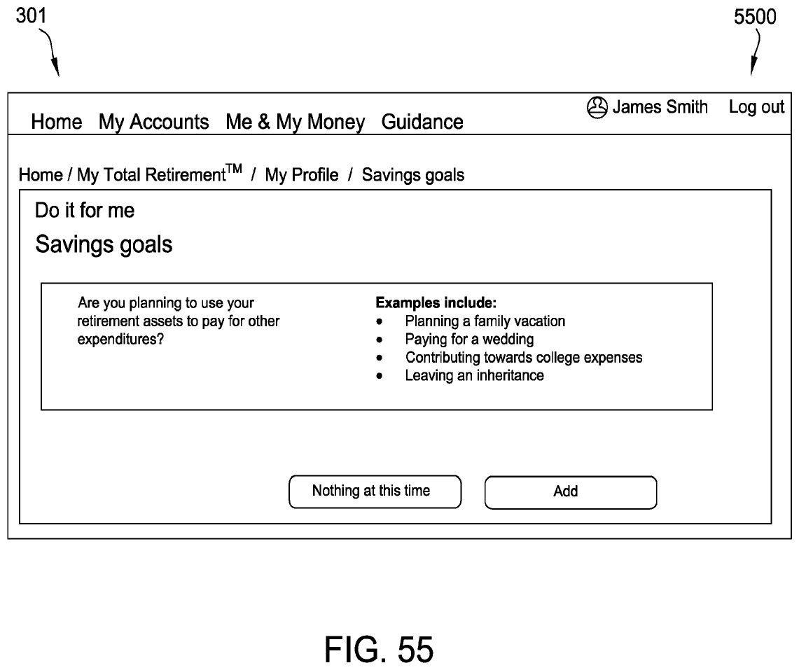

FIG. 55 is a savings goals page 5500 that allows the user to add savings goals.

FIG. 56 is another add retirement asset page 5600 in “pop up” form that allows the user to add a retirement asset.

FIG. 57 is an opportunities page 5700 that allows the user to view and step through opportunities, as discussed above.

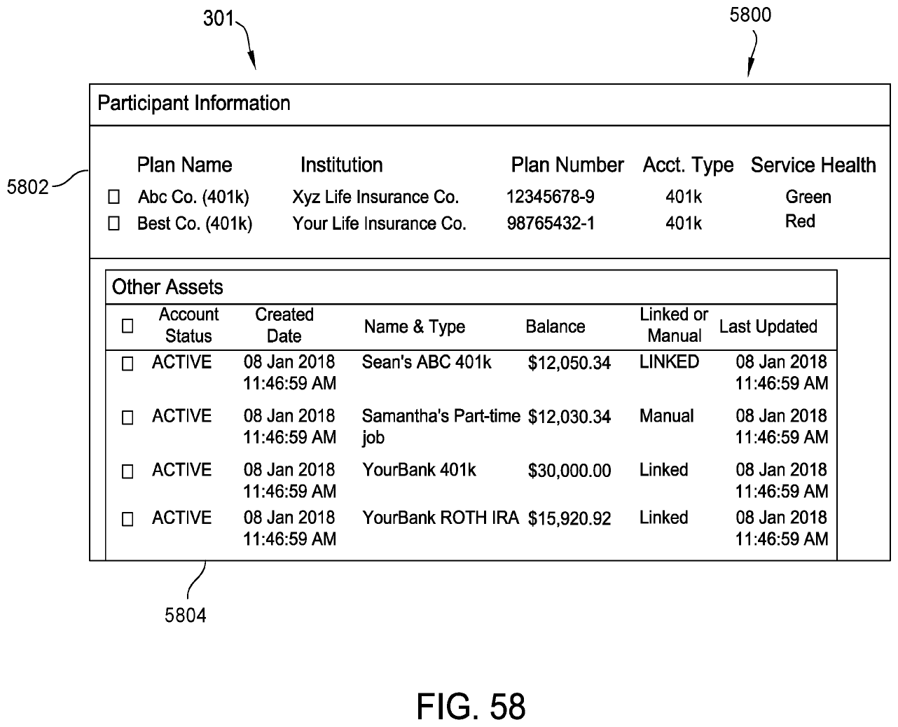

FIG. 58 is a participant information page 5800 of GUI 301 that is available solely to user 102 logged in as a services representative. Participant information page 5800 enables the services representative to view a summary of a participant's account information. Participant information page 5800 includes a first table 5802 listing information corresponding to a participant's retirement plan, such as plan name, institution, plan number, account type, and service health. Participant information page 5800 also includes a second table 5804 listing information regarding other known assets associated with the participant, such as assets entered via add asset page 5000 or add asset page 5600. The other assets information includes account status, created date of account, name and type of account, balance of the account, whether the account is automatically linked with GUI computer system 114, and date and time corresponding to the last update of the account within GUI computer system 114. Participant information page 5800 is configured to automatically update the information displayed corresponding to linked accounts as new information becomes available in database 120. By automatically updating the information, participant information page 5800 dynamically displays information to a services representative who may make decisions based on the participant's information provided in real-time.

As will be appreciated based on the foregoing specification, the above-described embodiments of the disclosure may be implemented using computer programming or engineering techniques including computer software, firmware, hardware or any combination or subset thereof, wherein the technical effect is to provide virtualization and fraud security around fundraising and redemption in an online payment transaction environment. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method, comprising:
presenting a graphical user interface (GUI), the GUI including a visual representation of projections over time for a user;
calling a planning engine through an application programming interface (API), wherein, calling the planning engine causes the planning engine to:
retrieve user profile data of the user;
generate a predicted outcome for the user based on the user profile data; and
return the predicted outcome to the GUI;
receiving the predicted outcome from the planning engine; and
updating the visual representation based on the predicted outcome.

2. The computer-implemented method of claim 1, wherein the planning engine is one of a plurality of planning engines and each planning engine of the plurality of planning engines is callable through a respective API.

3. The computer-implemented method of claim 1, wherein the planning engine is dynamically reconfigurable by providing different sets of initialization parameters to the planning engine.

4. The computer-implemented method of claim 1, wherein calling the planning engine includes providing an initialization parameter to the planning engine and wherein, calling the planning engine and providing the initialization parameter causes the planning engine to be reconfigured using the initialization parameter.

5. The computer-implemented method of claim 1, wherein calling the planning engine includes providing a modified value of a field in the user profile data and wherein, when called, the planning engine substitutes a current value in the field in the user profile data for the modified value when generating the predicted outcome.

6. The computer-implemented method of claim 1, wherein calling the planning engine causes the planning engine to execute a simulation using a graphics processing unit (GPU).

7. The computer-implemented method of claim 1, further comprising:
receiving a recommendation from an opportunity rules engine executable independent of the planning engine, wherein the opportunity rules engine generates the recommendation by:
traversing a predefined and ordered list of candidate modifications to the user profile data of the user; and
identifying a highest ordered candidate modification of the predefined and ordered list of candidate modifications not implemented by the user; and
updating the GUI based on the recommendation, wherein updating the GUI includes each of updating a dynamic text field to include a description of the recommendation and updating functionality of a control within the GUI to direct the user to a portion of the GUI for implementing the recommendation.

8. The computer-implemented method of claim 1, wherein the user profile data includes financial data and the predicted outcome is at least a portion of retirement income for a specific retirement year.

9. The computer-implemented method of claim 1, wherein the planning engine is a first planning engine and the predicted outcome is a first predicted outcome, the computer-implemented method further comprising:
calling a second planning engine through a second API;
receiving a second predicted outcome from a second planning engine; and
updating the visual representation based on the second predicted outcome.

10. The computer-implemented method of claim 1, wherein the GUI includes an interactive control configured to be manipulated by the user to provide modified values for the user profile and the GUI is configured to transmit the modified values through a corresponding API to update the user profile.

11. A computer system comprising:
one or more processors; and
memory storing thereon instructions that, as a result of being executed by the one or more processors, cause the one or more processors to execute a process including:
presenting a graphical user interface (GUI), the GUI including a visual representation of projections over time for a user;
calling a planning engine through an application programming interface (API), wherein, calling the planning engine causes the planning engine to:
retrieve user profile data of the user;
generate a predicted outcome for the user based on the user profile data; and
return the predicted outcome to the GUI;
receiving the predicted outcome from the planning engine; and
updating the visual representation based on the predicted outcome.

12. The computer system of claim 11, wherein the planning engine is dynamically reconfigurable by providing different sets of initialization parameters to the planning engine.

13. The computer system of claim 11, wherein calling the planning engine includes providing an initialization parameter to the planning engine and wherein, calling the planning engine and providing the initialization parameter causes the planning engine to be reconfigured using the initialization parameter.

14. The computer system of claim 11, wherein calling the planning engine includes providing a modified value of a field in the user profile data and wherein, when called, the planning engine substitutes a current value in the field in the user profile data for the modified value when generating the predicted outcome.

15. The computer system of claim 11, wherein calling the planning engine causes the planning engine to execute a simulation using a graphics processing unit (GPU).

16. The computer system of claim 11, wherein the process further includes:
receiving a recommendation from an opportunity rules engine executable independent of the planning engine, wherein the opportunity rules engine generates the recommendation by:
traversing a predefined and ordered list of candidate modifications to the user profile data of the user; and
identifying a highest ordered candidate modification of the predefined and ordered list of candidate modifications not implemented by the user; and
updating the GUI based on the recommendation, wherein updating the GUI includes each of updating a dynamic text field to include a description of the recommendation and updating functionality of a control within the GUI to direct the user to a portion of the GUI for implementing the recommendation.

17. At least one non-transitory computer-readable storage media that includes computer-executable instructions that, when executed by at least one processor, cause the at least one processor to execute a process including:
presenting a graphical user interface (GUI), the GUI including a visual representation of projections over time for a user;
calling a planning engine through an application programming interface (API), wherein, calling the planning engine causes the planning engine to:
retrieve user profile data of the user;
generate a predicted outcome for the user based on the user profile data; and
return the predicted outcome to the GUI;
receiving the predicted outcome from the planning engine; and
updating the visual representation based on the predicted outcome.

18. The at least one non-transitory computer-readable storage media of claim 18, wherein calling the planning engine includes providing an initialization parameter to the planning engine and wherein, calling the planning engine and providing the initialization parameter causes the planning engine to be reconfigured using the initialization parameter.

19. The at least one non-transitory computer-readable storage media of claim 18, wherein calling the planning engine includes providing a modified value of a field in the user profile data and wherein, when called, the planning engine substitutes a current value in the field in the user profile data for the modified value when generating the predicted outcome.

20. The at least one non-transitory computer-readable storage media of claim 18, wherein the process further includes:
receiving a recommendation from an opportunity rules engine executable independent of the planning engine, wherein the opportunity rules engine generates the recommendation by:
traversing a predefined and ordered list of candidate modifications to the user profile data of the user; and
identifying a highest ordered candidate modification of the predefined and ordered list of candidate modifications not implemented by the user; and
updating the GUI based on the recommendation, wherein updating the GUI includes each of updating a dynamic text field to include a description of the recommendation and updating functionality of a control within the GUI to direct the user to a portion of the GUI for implementing the recommendation.
